(19) United States
(12) Patent Application Publication
(10) Pub. No.: US 2026/0347516 A1
(43) Pub. Date: Nov. 5, 2026

(54) METHOD FOR PRODUCING NON MELT-PROCESSIBLE POLYTETRAFLUOROETHYLENE POWDER AND NON MELT-PROCESSIBLE POLYTETRAFLUOROETHYLENE POWDER

(71) Applicant: DAIKIN INDUSTRIES, LTD., Osaka (JP)

(72) Inventors: Kenta NISHIMURA, Osaka (JP); Takahiro TAIRA, Osaka (JP); Reina INOUE, Osaka (JP); Kenta NAKANISHI, Osaka (JP); Masayoshi MIYAMOTO, Osaka (JP); Taketo KATO, Osaka (JP); Kohei YASUDA, Osaka (JP)

(73) Assignee: DAIKIN INDUSTRIES, LTD., Osaka (JP)

(21) Appl. No.: 19/692,376

(22) Filed: May 29, 2026

Related U.S. Application Data
(63) Continuation of application No. PCT/JP2024/042583, filed on Dec. 2, 2024.

(30) Foreign Application Priority Data
Dec. 1, 2023 (JP) 2023-204182

(51) Int. Cl. C08F 6/22; C08F 2/24; C08F 6/00; C08F 114/26

(52) U.S. Cl. CPC C08F 6/22; C08F 2/24; C08F 6/008; C08F 114/26

(57) ABSTRACT

Provided is a method for producing a non melt-processible polytetrafluoroethylene powder, the production method comprising: polymerizing tetrafluoroethylene in the presence of an aqueous medium and a hydrocarbon surfactant to obtain an aqueous dispersion containing non melt-processible polytetrafluoroethylene; coagulating the non melt-processible polytetrafluoroethylene in the aqueous dispersion to obtain a wet powder; cleaning the wet powder; and heat-treating the wet powder to obtain a non melt-processible polytetrafluoroethylene powder.

### CROSS-REFERENCE TO RELATED APPLICATIONS

This application is a Rule 53(b) Continuation of International Application No. PCT/JP2024/042583 filed Dec. 2, 2024, which claims priority based on Japanese Patent Application No. 2023-204182 filed Dec. 1, 2023, the respective disclosures of which are incorporated herein by reference in their entirety.

### TECHNICAL FIELD

The present disclosure relates to a method for producing a non melt-processible polytetrafluoroethylene powder and a melt-fabricable polytetrafluoroethylene.

### BACKGROUND ART

Patent Document 1 describes a method for producing a fluoropolymer powder, comprising the steps of: (A1) adding an acid to a fluoropolymer aqueous dispersion obtained by polymerization using a carboxylic acid-type hydrocarbon surfactant to adjust pH to 4.0 or lower, followed by coagulation to obtain a wet fluoropolymer powder containing a fluorine-containing compound represented by the following general formula (1A); and (B1) heat-treating the wet fluoropolymer powder at higher than 150 °C and lower than 240 °C:

H—(CF₂)ₘ—COOH general formula (1A):
wherein m is 3 to 19.

### RELATED ART

### Patent Document

Patent Document 1: International Publication No. WO 2020/213691

### SUMMARY

The present disclosure provides a method for producing a non melt-processible polytetrafluoroethylene powder, the production method comprising: polymerizing tetrafluoroethylene in the presence of an aqueous medium and a hydrocarbon surfactant to obtain an aqueous dispersion containing non melt-processible polytetrafluoroethylene; coagulating the non melt-processible polytetrafluoroethylene in the aqueous dispersion to obtain a wet powder; cleaning the wet powder; and heat-treating the wet powder to obtain a non melt-processible polytetrafluoroethylene powder.

### Effects

The present disclosure can provide a method for producing a non melt-processible polytetrafluoroethylene powder.

### DESCRIPTION OF EMBODIMENTS

Some terms used in the present disclosure will be defined and described before specific description of the present disclosure.

In the present disclosure, polytetrafluoroethylene [PTFE] is preferably a fluoropolymer having tetrafluoroethylene unit at a content of 99% by mol or more based on all polymerization units.

In the present disclosure, the content of each monomer constituting a fluoropolymer can be calculated by appropriately combining NMR, FT-IR, elemental analysis, and X-ray fluorescence analysis depending on the type of the monomer.

In the present disclosure, the term “organic group” means a group containing 1 or more carbon atoms, or a group formed by removing one hydrogen atom from an organic compound. The organic group is preferably an alkyl group optionally having one or more substituents.

In the present disclosure, a range indicated by end points includes all numeric values included in the range (e.g., 1 to 10 includes 1.4, 1.9, 2.33, 5.75, 9.98, and the like).

In the present disclosure, the term “at least one” includes all numeric values of 1 or more (e.g., at least 2, at least 4, at least 6, at least 8, at least 10, at least 25, at least 50, and at least 100).

Hereinafter, specific embodiments of the present disclosure will be described in detail. However, the present disclosure is not limited by the following embodiments.

Patent Document 1 states that a fluoropolymer powder with a reduced content of a specific fluorine-containing compound can be produced by using the production method described above.

However, if a non melt-processible polytetrafluoroethylene powder is produced as the fluoropolymer powder by the production method described above and the obtained powder is subjected to forming by paste extrusion forming, the following problems are found: a high extrusion pressure is required; the extrusion pressure increases without reaching equilibrium during one operation of extrusion forming; and the extrusion pressure is elevated by repeating extrusion forming. Such a high extrusion pressure or an unstable extrusion pressure largely reduces the productivity of a formed article and reduces the homogeneity of physical properties of the obtained formed article.

The production method of the present disclosure is a production method capable of producing non melt-processible polytetrafluoroethylene that has a reduced content of a fluorine-containing compound having a hydrophilic group and can be subjected to extrusion forming at a low extrusion pressure and a stable extrusion pressure. Hereinafter, the configurations of the production method and the melt-fabricable polytetrafluoroethylene of the present disclosure will be described in detail.

### 1. Production Method

The production method of the present disclosure involves polymerizing tetrafluoroethylene (TFE) in the presence of an aqueous medium and a hydrocarbon surfactant to obtain an aqueous dispersion containing non melt-processible polytetrafluoroethylene (PTFE); coagulating the non melt-processible PTFE in the aqueous dispersion to obtain a wet powder; cleaning the wet powder; and heat-treating the wet powder to obtain a non melt-processible PTFE powder.

### (Hydrocarbon Surfactant)

The hydrocarbon emulsifier is a non-fluorine hydrocarbon emulsifier containing no fluorine. The hydrocarbon surfactant may be, for example, any of those described in Japanese Translation of PCT International Application Publication Nos. 2013-542308, 2013-542309, and 2013-542310.

The hydrocarbon surfactant can be a surfactant having a hydrophilic moiety and a hydrophobic moiety in the same molecule. Such a surfactant can be cationic, nonionic, or anionic.

The cationic hydrocarbon surfactant usually has a positively charged hydrophilic moiety such as alkylated ammonium halide, for example, alkyl ammonium bromide, and a hydrophobic moiety such as a long-chain fatty acid.

The anionic hydrocarbon surfactant usually has a hydrophilic moiety such as carboxylate, sulfonate, or sulfate, and a hydrophobic moiety which is a long-chain hydrocarbon moiety such as alkyl.

The nonionic hydrocarbon surfactant usually contains no charged group and has a hydrophobic moiety which is long-chain hydrocarbon. The hydrophilic moiety of the nonionic surfactant contains a water-soluble functional group such as an ethylene ether chain derived from polymerization with ethylene oxide.

### Examples of the Nonionic Hydrocarbon Surfactant

Polyoxyethylene alkyl ether, polyoxyethylene alkyl phenyl ether, polyoxyethylene alkyl ester, sorbitan alkyl ester, polyoxyethylene sorbitan alkyl ester, glycerol ester, and their derivatives.

Specific examples of the polyoxyethylene alkyl ether: polyoxyethylene lauryl ether, polyoxyethylene cetyl ether, polyoxyethylene stearyl ether, polyoxyethylene oleyl ether, and polyoxyethylene behenyl ether.

Specific examples of the polyoxyethylene alkyl phenyl ether: polyoxyethylene nonyl phenyl ether and polyoxyethylene octyl phenyl ether.

Specific examples of the polyoxyethylene alkyl ester: polyethylene glycol monolaurate, polyethylene glycol monooleate, and polyethylene glycol monostearate.

Specific examples of the sorbitan alkyl ester: polyoxyethylene sorbitan monolaurate, polyoxyethylene sorbitan monopalmitate, polyoxyethylene sorbitan monostearate, and polyoxyethylene sorbitan monooleate.

Specific examples of the polyoxyethylene sorbitan alkyl ester: polyoxyethylene sorbitan monolaurate, polyoxyethylene sorbitan monopalmitate, and polyoxyethylene sorbitan monostearate.

Specific examples of the glycerol ester: glycerol monomyristate, glycerol monostearate, and glycerol monooleate.

Specific examples of the derivative: polyoxyethylenealkylamine, polyoxyethylenealkylphenyl-formaldehyde condensates, and polyoxyethylene alkyl ether phosphate.

The ether and the ester can have an HLB value of 10 to 18.

Examples of the nonionic hydrocarbon surfactant include Triton® X series (X15, X45, X100, etc.), Tergitol® 15-S series, Tergitol® TMN series (TMN-6, TMN-10, TMN-100, etc.), and Tergitol® L series manufactured by The Dow Chemical Company, and Pluronic® R series (31R1, 17R2, 10R5, 25R4 (m to 22, n to 23) and Iconol® TDA series (TDA-6, TDA-9, and TDA-10) manufactured by BASF SE.

Examples of the anionic hydrocarbon surfactant include Versatic® 10 of Resolution Performance Products LLC, and Avanel S series (5-70, S-74, etc.) manufactured by BASF SE.

Examples of the anionic hydrocarbon surfactant include an anionic surfactant represented by R^{Z}-(L-M)ₓ wherein R^{Z} is a hydrophobic hydrocarbon moiety containing 1 or more carbon atoms; L may be the same or different at each occurrence and represents an ionic hydrophilic moiety; M may be the same or different at each occurrence and represents one or more counterions of the ionic hydrophilic moiety; and x represents the number of groups represented by -L-M bonded to R^{z}, and is an integer of 1 to 3.
R^{Z} is preferably a hydrocarbon group having 1 to 100 carbon atoms and optionally containing a heteroatom. The heteroatom may be intercalated between a carbon atom and a carbon atom or may be contained in a substituent bonded to a carbon atom.
L is preferably —ArSO₃⁻, —SO₃⁻, —SO₄⁻, —PO₃⁻, or —COO⁻. —ArSO₃⁻ is aryl sulfonate.
M is preferably H, a metal atom, NR^{5Z}₄, imidazolium optionally having a substituent, pyridinium optionally having a substituent, or phosphonium optionally having a substituent. R^{5Z} is preferably H or an organic group (preferably an alkyl group having 1 to 3 carbon atoms).

More specific examples thereof include anionic surfactants described below.

Examples of the hydrocarbon surfactant also include an anionic surfactant represented by R^{Z}-L-M wherein R^{Z} is a linear or branched alkyl group having 1 or more carbon atoms and optionally having a substituent, or a cyclic alkyl group having 3 or more carbon atoms and optionally having a substituent, and when the number of carbon atoms is 3 or more, a monovalent or divalent heterocyclic ring may be contained, or a ring may be formed; L is —ArSO₃⁻, —SO₃⁻, —SO₄⁻, —PO₃⁻, or —COO⁻; M is H, a metal atom, NR^{5Z}₄, imidazolium optionally having a substituent, pyridinium optionally having a substituent, or phosphonium optionally having a substituent; R^{5Z} is H or an organic group; and —ArSO₃⁻ is aryl sulfonate.

Specific examples thereof include those represented by CH₃—(CH₂)ₙ-L-M wherein n is an integer of 6 to 17; and L and M are as defined above, which are typified by lauric acid, lauryl sulfate (dodecyl sulfate), and the like.
R^{Z} is preferably an alkyl group having 3 to 18 carbon atoms.

A mixture of surfactants in which R^{Z} is an alkyl group having 12 to 16 carbon atoms, and L-M is sulfate may be used.

Examples of other compounds having surface activity include an anionic surfactant represented by R^{6Z}(-L-M)₂ wherein R^{6Z} is a linear or branched alkylene group having 1 or more carbon atoms and optionally having a substituent, or a cyclic alkylene group having 3 or more carbon atoms and optionally having a substituent, and when the number of carbon atoms is 3 or more, a monovalent or divalent heterocyclic ring may be contained, or a ring may be formed; L is —ArSO₃⁻, —SO₃⁻, —SO₄⁻, —PO₃⁻ or —COO⁻; M is H, a metal atom, NR^{5Z}₄, imidazolium optionally having a substituent, pyridinium optionally having a substituent, or phosphonium optionally having a substituent; R^{5Z} is H or an organic group; and —ArSO₃⁻ is aryl sulfonate.

Examples of the hydrocarbon surfactant also include an anionic surfactant represented by R^{7Z}(-L-M)₃ wherein R^{7Z} is a linear or branched alkylidyne group having 1 or more carbon atoms and optionally having a substituent, or a cyclic alkylidyne group having 3 or more carbon atoms and optionally having a substituent, and when the number of carbon atoms is 3 or more, a monovalent or divalent heterocyclic ring may be contained, or a ring may be formed; L is —ArSO₃⁻, —SO₃⁻, —SO₄⁻, —PO₃⁻, or —COO⁻; M is H, a metal atom, NR^{5Z}₄, imidazolium optionally having a substituent, pyridinium optionally having a substituent, or phosphonium optionally having a substituent; R^{5Z} is H or an organic group; and —ArSO₃⁻ is aryl sulfonate.

R^{5Z} described above is preferably H or an alkyl group, more preferably H or an alkyl group having 1 to 10 carbon atoms, further preferably H or an alkyl group having 1 to 4 carbon atoms.

In the present disclosure, the term “substituent” means a group capable of substitution, unless otherwise specified. Examples of the “substituent” include an aliphatic group, an aromatic group, a heterocyclic group, an acyl group, an acyloxy group, an acylamino group, an aliphatic oxy group, an aromatic oxy group, a heterocyclic oxy group, an aliphatic oxycarbonyl group, an aromatic oxycarbonyl group, a heterocyclic oxycarbonyl group, a carbamoyl group, an aliphatic sulfonyl group, an aromatic sulfonyl group, a heterocyclic sulfonyl group, an aliphatic sulfonyloxy group, an aromatic sulfonyloxy group, a heterocyclic sulfonyloxy group, a sulfamoyl group, an aliphatic sulfonamide group, an aromatic sulfonamide group, a heterocyclic sulfonamide group, an amino group, an aliphatic amino group, an aromatic amino group, a heterocyclic amino group, an aliphatic oxycarbonylamino group, an aromatic oxycarbonylamino group, a heterocyclic oxycarbonylamino group, an aliphatic sulfinyl group, an aromatic sulfinyl group, an aliphatic thio group, an aromatic thio group, a hydroxy group, a cyano group, a sulfo group, a carboxy group, an aliphatic oxyamino group, an aromatic oxyamino group, a carbamoylamino group, a sulfamoylamino group, a halogen atom, a sulfamoylcarbamoyl group, a carbamoylsulfamoyl group, a dialiphatic oxyphosphinyl group, and a diaromatic oxyphosphinyl group.

Examples of the hydrocarbon surfactant also include siloxane hydrocarbon surfactants. Examples of the siloxane hydrocarbon surfactant include those described in Silicone Surfactants, R. M. Hill, Marcel Dekker, Inc., ISBN: 0-8247-00104. The siloxane hydrocarbon surfactant structurally contains an evident hydrophobic moiety and hydrophilic moiety. The hydrophobic moiety contains one or more dihydrocarbyl siloxane units, wherein a substituent on a silicone atom is completely hydrocarbon.

When carbon atoms of the hydrocarbyl group are replaceable with halogen such as fluorine, such a siloxane hydrocarbon surfactant can also be regarded as a hydrocarbon surfactant in the sense that the resulting atoms are completely replaced with hydrogen atoms. In short, a monovalent substituent on a carbon atom of the hydrocarbyl group is hydrogen.

The hydrophilic moiety of the siloxane hydrocarbon surfactant may contain one or more polar moieties including sulfate, sulfonate, phosphonate, phosphoric acid ester, carboxylate, carbonate, sulfosuccinate, taurate (as free acid, salt, or ester), phosphine oxide, betaine, betaine copolyol, and an ionic group such as quaternary ammonium salt. The ionic hydrophobic moiety may also contain an ionically functionalized siloxane graft.

Examples of such a siloxane hydrocarbon surfactant include polydimethylsiloxane-graft-(meth)acrylate, polydimethylsiloxane-graft-polyacrylate, and polydimethylsiloxane-grafted quaternary amine.

The polar moiety of the hydrophilic moiety of the siloxane hydrocarbon surfactant may contain polyether such as polyethylene oxide (PEO) and mixed polyethylene oxide/propylene oxide polyether (PEO/PPO); monosaccharides and disaccharides; and nonionic groups formed from a water-soluble heterocyclic ring such as pyrrolidinone. The ethylene oxide:propylene oxide (EO/PO) ratio may vary in the mixed polyethylene oxide/propylene oxide polyether.

The hydrophilic moiety of the siloxane hydrocarbon surfactant may also contain a combination of an ionic moiety and a nonionic moiety. Examples of such moieties include ionically terminally functionalized or randomly functionalized polyethers or polyols. Siloxane having a nonionic moiety, i.e., a nonionic siloxane surfactant is preferred for the implementation of the present disclosure.

The arrangement of the hydrophobic and hydrophilic moieties in the structure of the siloxane hydrocarbon surfactant may take the form of a diblock polymer (AB), a triblock polymer (ABA) wherein “B” represents the siloxane moiety of the molecule), or a multiblock polymer. Alternatively, the siloxane surfactant may contain a graft polymer.

The siloxane hydrocarbon surfactant is also disclosed in the specification of U.S. Pat. No. 6,841,616.

Examples of the siloxane-based anionic hydrocarbon surfactant include SilSense™ PE-100 silicone and SilSense™ CA-1 silicone available from Noveon® Consumer Specialties of Lubrizol Advanced Materials, Inc.

Examples of the anionic hydrocarbon surfactant also include a sulfosuccinate surfactant Lankropol® K8300 from Akzo Nobel Surface Chemistry LLC.

Examples of the sulfosuccinate surfactant include sulfosuccinic acid diisodecyl sodium salt (Emulsogen® SB10 from Clariant AG), and sulfosuccinic acid diisotridecyl sodium salt (Polirol® TR/LNA from Cesapinia Chemicals SpA).

Examples of the hydrocarbon surfactant also include PolyFox® surfactants from Omnova Solutions, Inc. (PolyFox™ PF-156A, PolyFox™ PF-136A, etc.).

The hydrocarbon surfactant is preferably an anionic hydrocarbon surfactant. Any of the anionic hydrocarbon surfactants mentioned above can be adopted, and the following anionic hydrocarbon surfactant, for example, can be suitably adopted.

Examples of the anionic hydrocarbon surfactant include a compound (α) represented by the following formula (α):

R¹⁰⁰—COOM (α)
wherein R¹⁰⁰ is a monovalent organic group containing 1 or more carbon atoms; M is H, a metal atom, NR¹⁰¹₄, imidazolium optionally having a substituent, pyridinium optionally having a substituent, or phosphonium optionally having a substituent;
wherein R¹⁰¹ is H or an organic group, and the R¹⁰¹ moieties may be the same or different. The organic group for R¹⁰¹ is preferably an alkyl group. R¹⁰¹ is preferably H or an organic group having 1 to 10 carbon atoms, more preferably H or an organic group having 1 to 4 carbon atoms, further preferably H or an alkyl group having 1 to 4 carbon atoms.

From the viewpoint of surface activity, the number of carbon atoms in R¹⁰⁰ is preferably 2 or more, more preferably 3 or more. From the viewpoint of water solubility, the number of carbon atoms in R¹⁰⁰ is preferably 29 or less, more preferably 23 or less.

Examples of the metal atom for M include alkali metals of group 1 and alkaline earth metals of group 2, with Na, K, or Li being preferable. M is preferably H, a metal atom, or NR¹⁰¹₄, more preferably H, an alkali metal of group 1, an alkaline earth metal of group 2, or NR¹⁰¹₄, further preferably H, Na, K, Li, or NH₄, still more preferably Na, K, or NH₄, particularly preferably Na or NH₄, most preferably NH₄.

Examples of the compound (α) also include an anionic surfactant represented by R¹⁰²—COOM wherein i¹⁰² is a linear or branched alkyl group, alkenyl group, alkylene group, or alkenylene group having 1 or more carbon atoms and optionally having a substituent, or a cyclic alkyl group, alkenyl group, alkylene group, or alkenylene group having 3 or more carbon atoms and optionally having a substituent, each of which may contain an ether bond, and when the number of carbon atoms is 3 or more, a monovalent or divalent heterocyclic ring may be contained, or a ring may be formed; and M is as defined above. Specific examples thereof include those represented by CH₃—(CH₂)ₙ—COOM wherein n is an integer of 2 to 28; and M is as defined above.

The compound (α) may be free of, for example, a carbonyl group which is not in a carboxyl group, from the viewpoint of emulsion stability.

Examples of the hydrocarbon-containing surfactant free of the carbonyl group preferably include a compound of the following formula (A):

R¹⁰³—COO-M (A)
wherein R¹⁰³ is an alkyl group, an alkenyl group, an alkylene group, or an alkenylene group, each of which may contain an ether bond; M is H, a metal atom, NR¹⁰¹₄, imidazolium optionally having a substituent, pyridinium optionally having a substituent, or phosphonium optionally having a substituent;
and R¹⁰¹ is the same or different and is H or an organic group.

In the formula (A), R¹⁰³ is preferably an alkyl group or an alkenyl group, each of which may contain an ether group. The alkyl group or the alkenyl group for R¹⁰³ may be linear or branched. The number of carbon atoms in R¹⁰³ described above is not limited and is, for example, 2 to 29.

When the alkyl group is linear, the number of carbon atoms in R¹⁰³ is preferably 3 to 29, more preferably 5 to 23. When the alkyl group is branched, the number of carbon atoms in R¹⁰³ is preferably 5 to 35, more preferably 11 to 23.

When the alkenyl group is linear, the number of carbon atoms in R¹⁰³ is preferably 2 to 29, more preferably 9 to 23. When the alkenyl group is branched, the number of carbon atoms in R¹⁰³ is preferably 4 to 29, more preferably 9 to 23.

Examples of the alkyl group and the alkenyl group include a methyl group, an ethyl group, an isobutyl group, a t-butyl group, and a vinyl group.

Examples of the compound (α) (carboxylic acid-type hydrocarbon surfactant) include butylic acid, valeric acid, caproic acid, enanthic acid, caprylic acid, pelargonic acid, capric acid, lauric acid, myristic acid, pentadecylic acid, palmitic acid, palmitoleic acid, margaric acid, stearic acid, oleic acid, vaccenic acid, linoleic acid, (9,12,15)-linolenic acid, (6,9,12)-linolenic acid, eleostearic acid, arachidic acid, 8,11-eicosadienoic acid, mead acid, arachidonic acid, behenic acid, lignoceric acid, nervonic acid, cerotic acid, montanic acid, melissic acid, crotonic acid, myristoleic acid, palmitoleic acid, sapienic acid, oleic acid, elaidic acid, vaccenic acid, gadoleic acid, eicosenoic acid, erucic acid, nervonic acid, linoleic acid, eicosadienoic acid, docosadienoic acid, linolenic acid, pinolenic acid, α-eleostearic acid, β-eleostearic acid, mead acid, di-homo-γ-linolenic acid, eicosatrienoic acid, stearidonic acid, arachidonic acid, eicosatetraenoic acid, adrenic acid, boseopentaenoic acid, eicosapentaenoic acid, osbond acid, clupanodonic acid, tetracosapentaenoic acid, docosahexaenoic acid, nisinic acid, and their salts.

Particularly, at least one member selected from the group consisting of lauric acid, capric acid, myristic acid, pentadecylic acid, palmitic acid, and their salts is preferred.

Examples of the salt include, but are not limited to, salts in which hydrogen of a carboxyl group is a metal atom, NR¹⁰¹₄, imidazolium optionally having a substituent, pyridinium optionally having a substituent, or phosphonium optionally having a substituent for the above formula M.

The surfactant (α) (carboxylic acid-type hydrocarbon surfactant) is preferably at least one member selected from the group consisting of lauric acid, capric acid, myristic acid, pentadecylic acid, palmitic acid, and their salts, further preferably lauric acid or a salt thereof, particularly preferably a salt of lauric acid, most preferably sodium laurate or ammonium laurate, because particles having a small average primary particle size can be obtained by polymerization and PTFE can be efficiently produced owing to a large number of particles generated during polymerization.

Examples of the hydrocarbon surfactant preferably include a surfactant represented by the general formula (1) (hereinafter, also referred to as a surfactant (1)):

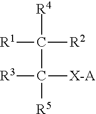

wherein R¹ to R⁵ each represent H or a monovalent substituent, on the proviso that at least one of R¹ and R³ represents a group represented by the general formula: —Y—R⁶, and at least one of R² and R⁵ represents a group represented by the general formula: —X-A, or a group represented by the general formula:

—Y—R⁶;
X is the same or different at each occurrence and represents a divalent linking group or a bond;
A is the same or different at each occurrence and represents —COOM, —SO₃M, or —OSO₃M, wherein M is H, a metal atom, NR⁷₄, imidazolium optionally having a substituent, pyridinium optionally having a substituent, or phosphonium optionally having a substituent, wherein R⁷ is H or an organic group;
Y is the same or different at each occurrence and represents a divalent linking group selected from the group consisting of —S(═O)₂—, —O—, —COO—, —OCO—, —CONR⁸—, and —NR⁸CO—, or a bond, wherein R⁸ is H or an organic group;
R⁶ is the same or different at each occurrence and represents an alkyl group having 1 or more carbon atoms and optionally containing at least one member selected from the group consisting of a carbonyl group, an ester group, an amide group, and a sulfonyl group between carbon-carbon atoms; and
any two of R¹ to R⁵ may be bonded to each other to form a ring.

The surfactant (1) will be described.

In the formula, R¹ to R⁵ each represent H or a monovalent substituent, on the proviso that at least one of R¹ and R³ represents a group represented by the general formula: —Y—R⁶, and at least one of R² and R⁵ represents a group represented by the general formula: —X-A, or a group represented by the general formula: —Y—R⁶. Any two of R¹ to R⁵ may be bonded to each other to form a ring.

The substituent that may be carried by the alkyl group as R¹ is preferably a halogen atom, a linear or branched alkyl group having 1 to 10 carbon atoms, a cyclic alkyl group having 3 to 10 carbon atoms, or a hydroxy group, particularly preferably a methyl group or an ethyl group.

The alkyl group as R¹ preferably contains no carbonyl group.

In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

The alkyl group preferably does not have any substituent.

R¹ is preferably a linear or branched alkyl group having 1 to 10 carbon atoms and optionally having a substituent, or a cyclic alkyl group having 3 to 10 carbon atoms and optionally having a substituent, more preferably a linear or branched alkyl group having 1 to 10 carbon atoms and containing no carbonyl group, or a cyclic alkyl group having 3 to 10 carbon atoms and containing no carbonyl group, further preferably a linear or branched alkyl group having 1 to 10 carbon atoms and having no substituent, still more preferably a linear or branched alkyl group having 1 to 3 carbon atoms and having no substituent, particularly preferably a methyl group (—CH₃) or an ethyl group (—C₂H₅), most preferably a methyl group (—CH₃).

The monovalent substituent is preferably a group represented by the general formula: —Y—R⁶, a group represented by the general formula: —X-A, —H, a C₁₋₂₀ alkyl group optionally having a substituent, —NH₂, —NHR⁹ wherein R⁹ is an organic group, —OH, —COOR⁹ wherein R⁹ is an organic group, or —OR⁹ wherein R⁹ is an organic group. The number of carbon atoms in the alkyl group is preferably 1 to 10.

R⁹ is preferably a C₁₋₁₀ alkyl group or a C₁₋₁₀ alkylcarbonyl group, more preferably a C₁₋₄ alkyl group or a C₁₋₄ alkylcarbonyl group.

In the formula, X is the same or different at each occurrence and represents a divalent linking group or a bond. When R⁶ contains none of a carbonyl group, an ester group, an amide group, and a sulfonyl group, X is preferably a divalent linking group containing at least one member selected from the group consisting of a carbonyl group, an ester group, an amide group, and a sulfonyl group.

X is preferably a divalent linking group containing at least one bond selected from the group consisting of —CO—, —S(═O)₂—, —O—, —COO—, —OCO—, —S(═O)₂—O—, —O—S(═O)₂—, —CONR⁸—, and —NR⁸CO—, a C₁₋₁₀ alkylene group, or a bond. R⁸ represents H or an organic group.

The organic group for R⁸ is preferably an alkyl group. R⁸ is preferably H or a C₁₋₁₀ organic group, more preferably H or a C₁₋₄ organic group, further preferably H or a C₁₋₄ alkyl group, still more preferably H.

In the formula, A is the same or different at each occurrence and represents —COOM, —SO₃M, or —OSO₃M, wherein M is H, a metal atom, NR⁷₄, imidazolium optionally having a substituent, pyridinium optionally having a substituent, or phosphonium optionally having a substituent; and R⁷ is H or an organic group, and four R⁷ moieties may be the same or different. In the general formula (1), A is —COOM in a preferred embodiment.

The organic group for R⁷ is preferably an alkyl group. R⁷ is preferably H or a C₁₋₁₀ organic group, more preferably H or a C₁₋₄ organic group, further preferably H or a C₁₋₄ alkyl group.

Examples of the metal atom include alkali metals of group 1 and alkaline earth metals of group 2, with Na, K, or Li being preferable.

M is preferably H, a metal atom, or NR⁷₄, more preferably H, an alkali metal of group 1, an alkaline earth metal of group 2, or NR⁷₄, further preferably H, Na, K, Li, or NH₄, still more preferably Na, K, or NH₄, particularly preferably Na or NH₄, most preferably NH₄.

In the formula, Y is the same or different at each occurrence and represents a divalent linking group selected from the group consisting of —S(═O)₂—, —O—, —COO—, —OCO—, —CONR⁸—, and —NR⁸CO—, or a bond, and R⁸ represents H or an organic group.

Y is preferably a bond or a divalent linking group selected from the group consisting of —O—, —COO—, —OCO—, —CONR⁸—, and —NR⁸CO—, more preferably a bond or a divalent linking group selected from the group consisting of —COO— and —OCO—.

The organic group for R⁸ is preferably an alkyl group. R⁸ is preferably H or a C₁₋₁₀ organic group, more preferably H or a C₁₋₄ organic group, further preferably H or a C₁₋₄ alkyl group, still more preferably H.

In the formula, R⁶ is the same or different at each occurrence and represents an alkyl group having 1 or more carbon atoms and optionally containing at least one member selected from the group consisting of a carbonyl group, an ester group, an amide group, and a sulfonyl group between carbon-carbon atoms. The number of carbon atoms in the organic group for R⁶ is preferably 2 or more, and preferably 20 or less, more preferably 2 to 20, further preferably 2 to 10.

The alkyl group for R⁶, when the number of carbon atoms is 2 or more, can contain 1 or 2 or more of at least one type selected from the group consisting of a carbonyl group, an ester group, an amide group, and a sulfonyl group between carbon-carbon atoms, though these groups are not contained at both ends of the alkyl group. In the alkyl group for R⁶, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

R⁶ is preferably
a group represented by the general formula: —R¹⁰—CO—R¹¹,
a group represented by the general formula: —R¹⁰—COO—R¹¹,
a group represented by the general formula: —R¹¹,
a group represented by the general formula: —R¹⁰—NR⁸CO—R¹¹, or
a group represented by the general formula: —R¹⁰—CONR⁸—R¹¹,
wherein R⁸ represents H or an organic group; R¹⁰ is an alkylene group; and R¹¹ is an alkyl group optionally having a substituent.
R⁶ is more preferably a group represented by the general formula: —R¹⁰—CO—R¹¹.

The organic group for R⁸ is preferably an alkyl group. R⁸ is preferably H or a C₁₋₁₀ organic group, more preferably H or a C₁₋₄ organic group, further preferably H or a C₁₋₄ alkyl group, still more preferably H.

The number of carbon atoms in the alkylene group for R¹⁰ is preferably 1 or more, more preferably 3 or more, and preferably 20 or less, more preferably 12 or less, further preferably 10 or less, particularly preferably 8 or less. The number of carbon atoms in the alkylene group for R¹⁰ is preferably 1 to 20, more preferably 1 to 10, further preferably 3 to 10.

The number of carbon atoms in the alkyl group for R¹¹ can be 1 to 20, and is preferably 1 to 15, more preferably 1 to 12, further preferably 1 to 10, still more preferably 1 to 8, even more preferably 1 to 6, yet more preferably 1 to 3, particularly preferably 1 or 2, most preferably 1. The alkyl group for R¹¹ is preferably composed only of primary carbon, secondary carbon, or tertiary carbon, and particularly preferably composed only of primary carbon or secondary carbon. In short, R¹¹ is preferably a methyl group, an ethyl group, an n-propyl group, or an isopropyl group, most preferably a methyl group, in particular.

In the general formula (1), at least one of R² and R⁵ is a group represented by the general formula: —X-A wherein A is —COOM, in another preferred embodiment.

Examples of the hydrocarbon surfactant also include a surfactant (1-0A) represented by the following formula (1-0A):

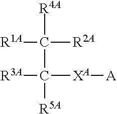

wherein R^{1A} to R^{5A} each represent H, a monovalent hydrocarbon group optionally containing an ester group between carbon-carbon atoms, or a group represented by the general formula: —X^{A}-A, on the proviso that at least one of R^{2A} and R^{5A} represents a group represented by the general formula: —X^{A}-A;
X^{A} is the same or different at each occurrence and represents a divalent hydrocarbon group, a group represented by the formula: —N(R^{6A})—R^{7A}— wherein R^{6A} is H or —CH₂COOM (wherein M is as defined later), and R^{7A} is a divalent hydrocarbon group, or a bond;
A is the same or different at each occurrence and represents —COOM wherein M is H, a metal atom, NR⁷₄, imidazolium optionally having a substituent, pyridinium optionally having a substituent, or phosphonium optionally having a substituent, wherein R⁷ is H or an organic group; and
any two of R^{1A} to R^{5A} may be bonded to each other to form a ring.

In the general formula (1-0A), the number of carbon atoms in the monovalent hydrocarbon group optionally containing an ester group between carbon-carbon atoms for R^{1A} to R^{5A} is preferably 1 to 50, more preferably 5 to 20. Any two of R^{1A} to R^{5A} may be bonded to each other to form a ring. The monovalent hydrocarbon group optionally containing an ester group between carbon-carbon atoms is preferably an alkyl group.

In the formula, the number of carbon atoms in the divalent hydrocarbon group for X^{A} is preferably 1 to 50, more preferably 5 to 20. Examples of the divalent hydrocarbon group include an alkylene group and an alkanediyl group, with an alkylene group being preferable.

In the general formula (1-0A), any one of R^{2A} and R^{5A} is preferably a group represented by the general formula: —X^{A}-A, and R^{2A} is more preferably a group represented by the general formula: —X^{A}-A.

In the general formula (1-0A), a preferred embodiment is an embodiment in which R^{2A} is a group represented by the general formula: —X^{A}-A, and each of R^{1A}, R^{3A}, R^{4A}, and R^{5A} is H. In this case, X^{A} is preferably a bond or an alkylene group having 1 to 5 carbon atoms.

In the general formula (1-0A), a preferred embodiment is an embodiment in which R^{2A} is a group represented by the general formula: —X^{A}-A, each of R^{1A} and R^{3A} is a group represented by —Y^{A}—R⁶, Y^{A} is the same or different at each occurrence and represents —COO—, —OCO—, or a bond, and R⁶ is the same or different at each occurrence and represents an alkyl group having 1 or more carbon atoms. In this case, each of R^{4A} and R^{5A} is preferably H.

Examples of the hydrocarbon surfactant represented by the general formula (1-0A) include glutaric acid or a salt thereof, adipic acid or a salt thereof, pimelic acid or a salt thereof, suberic acid or a salt thereof, azelaic acid or a salt thereof, and sebacic acid or a salt thereof.

The aliphatic carboxylic acid-type hydrocarbon surfactant represented by the general formula (1-0A) may be, for example, a two-chain two-hydrophilic group synthetic surfactant. Examples of Gemini-type surfactants include Gemsurf (Chukyo Yushi Co., Ltd.), Gemsurf α142 (having 12 carbon atoms; lauryl group), Gemsurf α102 (having 10 carbon atoms), and Gemsurf α182 (having 14 carbon atoms).

In the general formula (1-0A), a preferred embodiment is also an embodiment in which R^{1A} is a group represented by —Y^{A}—R⁶, Y^{A} is a bond, R⁶ is an alkyl group having 1 or more carbon atoms (preferably an alkylene group having 6 to 20 carbon atoms), each of R^{2A}, R^{3A}, R^{4A}, and R^{5A} is H, and X^{A} is a group represented by the formula: —N(R^{6A})—R^{7A}— wherein R^{6A} is H or —CH₂COOM (wherein M is as defined above), and R^{7A} is an alkylene group having 1 to 5 carbon atoms (preferably a methylene group).

Examples of the surfactant of this embodiment include lauryl imine dicarboxylate.

Examples of the hydrocarbon surfactant also include a hydrocarbon surfactant having at least one carbonyl group which is not in a carboxyl group.

Alternatively, a hydrocarbon surfactant obtained by radical treatment or oxidation treatment of the hydrocarbon surfactant having at least one carbonyl group which is not in a carboxyl group may be used.

The radical treatment can be any treatment that generates a radical in the hydrocarbon surfactant having at least one carbonyl group which is not in a carboxyl group, and is, for example, a treatment involving adding deionized water and the hydrocarbon surfactant to a reactor, hermetically sealing the reactor, purging the system with nitrogen, elevating the temperature and the pressure of the reactor, then charging the reactor with a polymerization initiator, stirring the mixture for a given time, and then depressurizing the reactor until reaching barometric pressure, followed by cooling. The oxidation treatment is a treatment involving adding an oxidizing agent to the hydrocarbon surfactant having at least one carbonyl group which is not in a carboxyl group. Examples of the oxidizing agent include oxygen, ozone, hydrogen peroxide water, manganese(IV) oxide, potassium permanganate, potassium dichromate, nitric acid, and sulfur dioxide. The radical treatment or the oxidation treatment may be performed in a pH-adjusted aqueous solution in order to promote the radical treatment or the oxidation treatment. The pH of the aqueous solution for performing the radical treatment or the oxidation treatment is preferably lower than 7, and the pH of the aqueous solution can be adjusted using sulfuric acid, nitric acid, hydrochloric acid, or the like.

The hydrocarbon surfactant having at least one carbonyl group which is not in a carboxyl group is preferably a surfactant represented by the formula: R^{X}—X^{X} wherein R^{X} is a non-fluorine-containing organic group having 1 to 2,000 carbon atoms and having at least one carbonyl group which is not in a carboxyl group, and X^{X} is —OSO₃X^{X1}, —COOX^{X1}— or —SO₃X^{X1}, wherein X^{X1} is H, a metal atom, NR^{X1}₄, imidazolium optionally having a substituent, pyridinium optionally having a substituent, or phosphonium optionally having a substituent, wherein R^{X1} is H or an organic group, and the R^{X1} moieties may be the same or different. The number of carbon atoms in R^{X} is preferably 500 or less, more preferably 100 or less, further preferably 50 or less, still more preferably 30 or less. The organic group for R^{X1} is preferably an alkyl group. R^{X1} is preferably H or an organic group having 1 to 10 carbon atoms, more preferably H or an organic group having 1 to 4 carbon atoms, further preferably H or an alkyl group having 1 to 4 carbon atoms.

The hydrocarbon surfactant is more preferably at least one member selected from the group consisting of a surfactant (a) represented by the following formula (α):

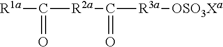

wherein R^{1a} is a linear or branched alkyl group having 1 or more carbon atoms or a cyclic alkyl group having 3 or more carbon atoms, wherein a hydrogen atom bonded to a carbon atom may be replaced with a hydroxy group or a monovalent organic group containing an ester bond, and R^{1a} may contain a carbonyl group when the number of carbon atoms is 2 or more, or may contain a monovalent or divalent heterocyclic ring or may form a ring when the number of carbon atoms is 3 or more; R^{2a} and R^{3a} are each independently a single bond or a divalent linking group; the total number of carbon atoms in Ria, R^{2a}, and R^{3a} is 6 or more; X^{a} is H, a metal atom, NR^{4a}₄, imidazolium optionally having a substituent, pyridinium optionally having a substituent or phosphonium optionally having a substituent, wherein R^{4a} is H or an organic group, and the R^{4a} moieties may be the same or different; and any two of Ria, R^{2a}, and R^{3a} may be bonded to each other to form a ring,
a surfactant (b) represented by the following formula (b):

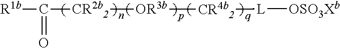

wherein R^{1b} is a linear or branched alkyl group having 1 or more carbon atoms and optionally having a substituent, or a cyclic alkyl group having 3 or more carbon atoms and optionally having a substituent, and may contain a monovalent or divalent heterocyclic ring or may form a ring when the number of carbon atoms is 3 or more; R^{2b} and R^{4b} are each independently H or a substituent; R^{3b} is an alkylene group having 1 to 10 carbon atoms and optionally having a substituent; n is an integer of 1 or larger; p and q are each independently an integer of 0 or larger; X^{b} is H, a metal atom, NR^{5b}₄, imidazolium optionally having a substituent, pyridinium optionally having a substituent, or phosphonium optionally having a substituent, wherein R^{5b} is H or an organic group, and the R^{b} moieties may be the same or different; any two of R^{1b}, R^{2b}, R^{3b}, and R^{4b} may be bonded to each other to form a ring; L is a single bond, —CO₂—B—*, —OCO—B—*, —CONR^{b}—B—*, —NR^{6b}CO—B—*, or —CO— (except for a carbonyl group contained in —CO₂—B—, —OCO—B—, —CONR^{6b}—B—, or —NR⁶CO—B—), wherein B is a single bond or an alkylene group having 1 to 10 carbon atoms and optionally having a substituent, and R^{6b} is H or an alkyl group having 1 to 4 carbon atoms and optionally having a substituent; and * refers to the side bonded to —OSO₃X^{b} in the formula,
a surfactant (c) represented by the following formula (c):

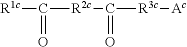

wherein R^{1c} is a linear or branched alkyl group having 1 or more carbon atoms or a cyclic alkyl group having 3 or more carbon atoms, wherein a hydrogen atom bonded to a carbon atom may be replaced with a hydroxy group or a monovalent organic group containing an ester bond, and R^{1c} may contain a carbonyl group when the number of carbon atoms is 2 or more, or may contain a monovalent or divalent heterocyclic ring or may form a ring when the number of carbon atoms is 3 or more; R^{2c} and R^{3c} are each independently a single bond or a divalent linking group; the total number of carbon atoms in R^{1c}, R^{2c}, and R^{3c} is 5 or more; A^{c} is —COOX^{c} or —SO₃X^{c}, wherein X^{c} is H, a metal atom, NR^{4c}₄, imidazolium optionally having a substituent, pyridinium optionally having a substituent, or phosphonium optionally having a substituent, wherein R^{4c} is H or an organic group, and the moieties may be the same or different; and any two of R^{1c}, R^{2c}, and R^{3c} may be bonded to each other to form a ring, and a surfactant (d) represented by the following formula (d):

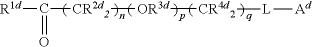

wherein R^{1d} is a linear or branched alkyl group having 1 or more carbon atoms and optionally having a substituent, or a cyclic alkyl group having 3 or more carbon atoms and optionally having a substituent, and may contain a monovalent or divalent heterocyclic ring or may form a ring when the number of carbon atoms is 3 or more; R^{2d} and R^{4d} are each independently H or substituent; R^{3d} is an alkylene group having 1 to 10 carbon atoms and optionally having a substituent; n is an integer of 1 or larger; p and q are each independently an integer of 0 or larger; A^{d} is —SO₃X^{d}, or —COOX^{d}, wherein X^{d} is H, a metal atom, NR^{5d}₄, imidazolium optionally having a substituent, pyridinium optionally having a substituent, or phosphonium optionally having a substituent, wherein R^{5d} is H or an organic group, and the moieties may be the same or different; any two of R^{1d}, R^{2d}, R^{3d}, and R^{4d} may be bonded to each other to form a ring; L is a single bond, —CO₂—B—*, —OCO—B—*, —CONR^{6d}—B—*, —NR^{6d}CO—B—*, or —CO— (except for a carbonyl group contained in —CO₂—B—, —OCO—B—, —CONR^{6d}—B—, or —NR^{6d}CO—B—), wherein B is a single bond or an alkylene group having 1 to 10 carbon atoms and optionally having a substituent, and R^{6d} is H or an alkyl group having 1 to 4 carbon atoms and optionally having a substituent; and * refers to the side bonded to A^{d} in the formula.

The surfactant (a) will be described.

In the formula (a), R^{1a} is a linear or branched alkyl group having 1 or more carbon atoms or a cyclic alkyl group having 3 or more carbon atoms.

The alkyl group, when the number of carbon atoms is 3 or more, may contain a carbonyl group (—C(═O)—) between two carbon atoms. Alternatively, the alkyl group, when the number of carbon atoms is 2 or more, may also contain the carbonyl group at an end of the alkyl group. In short, an acyl group such as an acetyl group represented by CH₃—C(═O)— is also included in the alkyl group.

The alkyl group, when the number of carbon atoms is 3 or more, may contain a monovalent or divalent heterocyclic ring or may form a ring. The heterocyclic ring is preferably an unsaturated heterocyclic ring, more preferably an oxygen-containing unsaturated heterocyclic ring. Examples thereof include a furan ring. In Ria, the divalent heterocyclic ring may be intercalated between two carbon atoms, the divalent heterocyclic ring may be positioned at an end and bonded to —C(═O)—, or the monovalent heterocyclic ring may be positioned at an end of the alkyl group.

In the present disclosure, the “number of carbon atoms” in the alkyl group also includes the number of carbon atoms constituting the carbonyl group and the number of carbon atoms constituting the heterocyclic ring. For example, a group represented by CH₃—C(═O)—CH₂— has 3 carbon atoms, a group represented by CH₃—C(═O)—C₂H₄—C(═O)—C₂H₄— has 7 carbon atoms, and a group represented by CH₃—C(═O)— has 2 carbon atoms.

In the alkyl group, a hydrogen atom bonded to a carbon atom may be replaced with a functional group, for example, with a hydroxy group (—OH) or a monovalent organic group containing an ester bond, and is preferably not replaced with any functional group.

Examples of the monovalent organic group containing an ester bond include a group represented by the formula: —O—C(═O)—R^{101a} wherein R^{101a} is an alkyl group.

In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

In the formula, R^{2a} and R^{3a} are each independently a single bond or a divalent linking group.

R^{2a} and R^{3a} are each independently preferably a single bond, a linear or branched alkylene group having 1 or more carbon atoms, or a cyclic alkylene group having 3 or more carbon atoms.

The alkylene group constituting any of R^{2a} and R^{3a} preferably contains no carbonyl group.

In the alkylene group, a hydrogen atom bonded to a carbon atom may be replaced with a functional group, for example, with a hydroxy group (—OH) or a monovalent organic group containing an ester bond, and is preferably not replaced with any functional group.

Examples of the monovalent organic group containing an ester bond include a group represented by the formula: —O—C(═O)—R^{102a} wherein R^{102a} is an alkyl group.

In the alkylene group, 75% or less of hydrogen atoms bonded to carbon atoms may be replaced with a halogen atom, 50% or less thereof may be replaced with a halogen atom, and 25% or less thereof may be replaced with a halogen atom. The alkylene group is preferably a non-halogenated alkylene group free of a halogen atoms such as a fluorine atom or a chlorine atom.

The total number of carbon atoms in R^{1a}, R^{2a}, and R^{3a} is 6 or more. The total number of carbon atoms is preferably 8 or more, more preferably 9 or more, further preferably 10 or more, and preferably 20 or less, more preferably 18 or less, further preferably 15 or less.

Any two of R^{1a}, R^{2a}, and R^{3a} may be bonded to each other to form a ring.

In the formula (a), X^{a} is H, a metal atom, NR^{4a}₄, imidazolium optionally having a substituent, pyridinium optionally having a substituent, or phosphonium optionally having a substituent, wherein R^{4a} is H or an organic group. Four R^{4a} moieties may be the same or different. The organic group for R^{4a} is preferably an alkyl group. R^{4a} is preferably H or an organic group having 1 to 10 carbon atoms, more preferably H or an organic group having 1 to 4 carbon atoms, further preferably H or an alkyl group having 1 to 4 carbon atoms. Examples of the metal atom include monovalent and divalent metal atoms and include alkali metals of group 1 and alkaline earth metals of group 2, with Na, K, or Li being preferable.

X^{a} is preferably H, an alkali metal of group 1, an alkaline earth metal of group 2, or NR^{4a}₄, more preferably H, Na, K, Li, or NH₄ because of being easily dissolved in water, further preferably Na, K, or NH₄ because of being further easily dissolved in water, particularly preferably Na or NH₄, most preferably NH₄ because of being easily removed. When X^{a} is NH₄, the surfactant is excellent in solubility in the aqueous medium while a metal component is unlikely to remain in PTFE or in a final product.

Examples of the surfactant (a) can include surfactants given below. In each formula, X^{a} is as mentioned above.

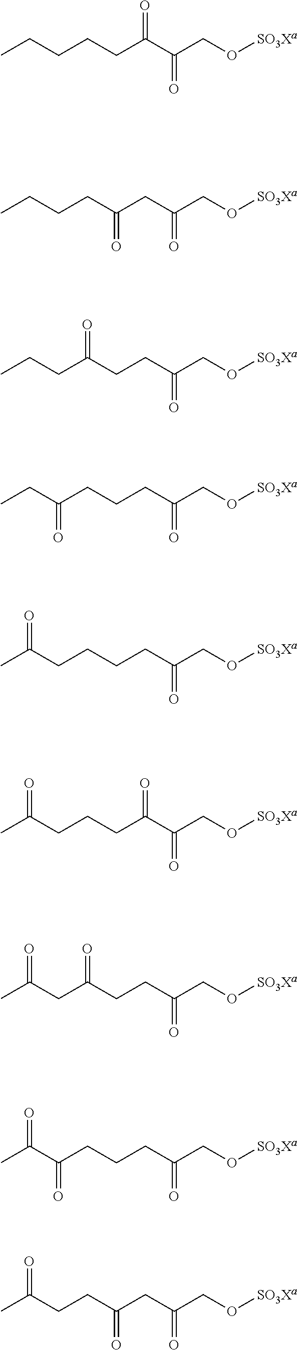

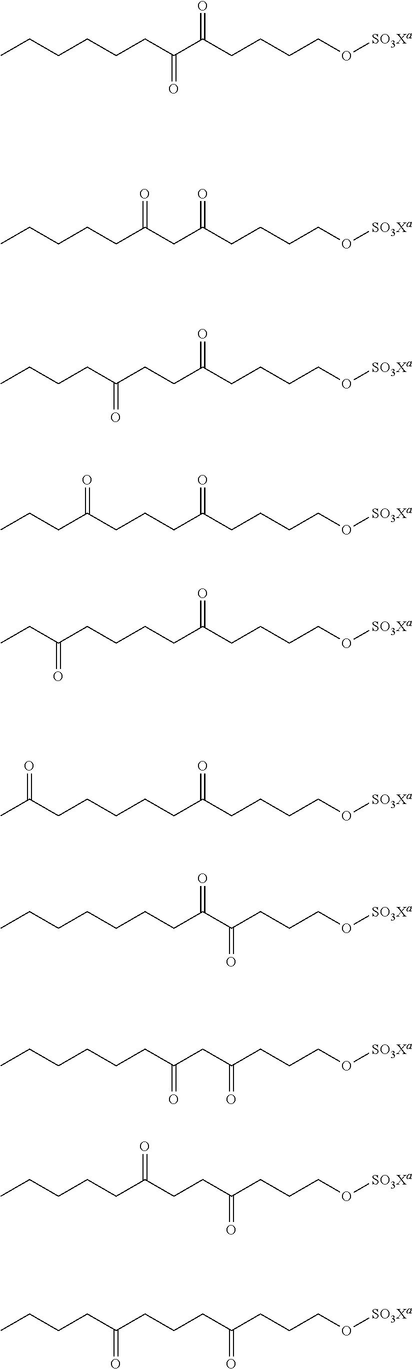

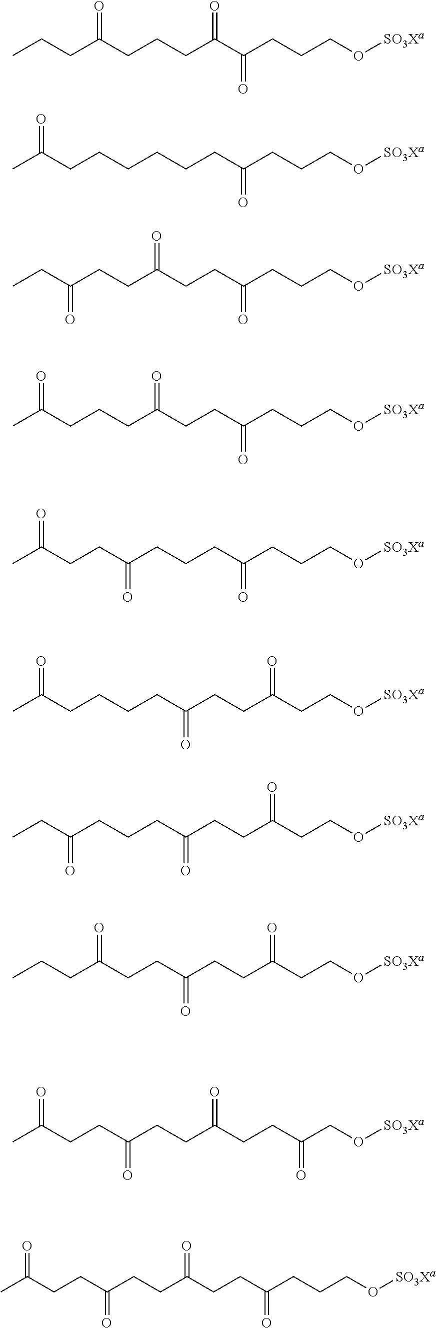

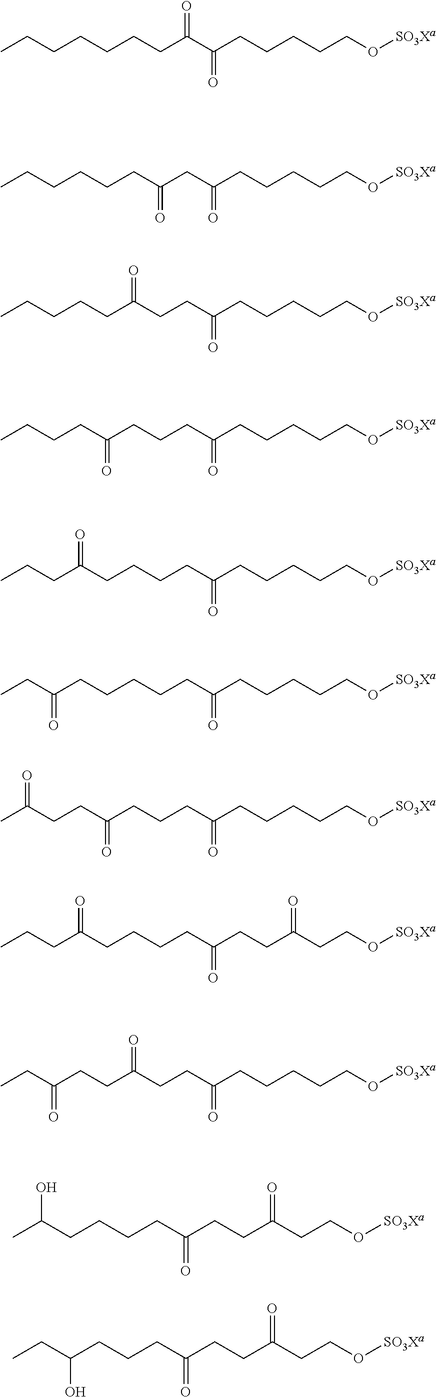

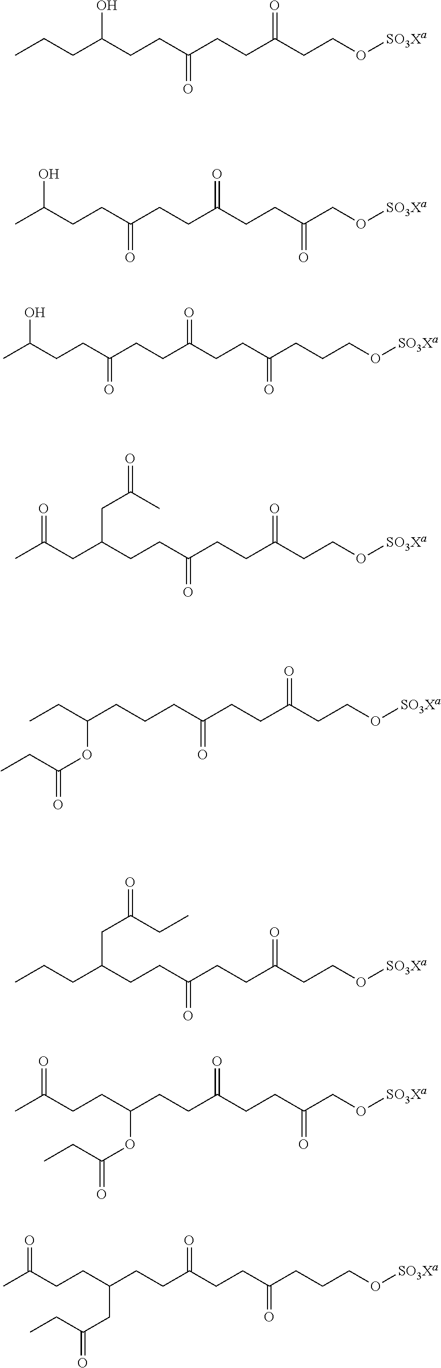

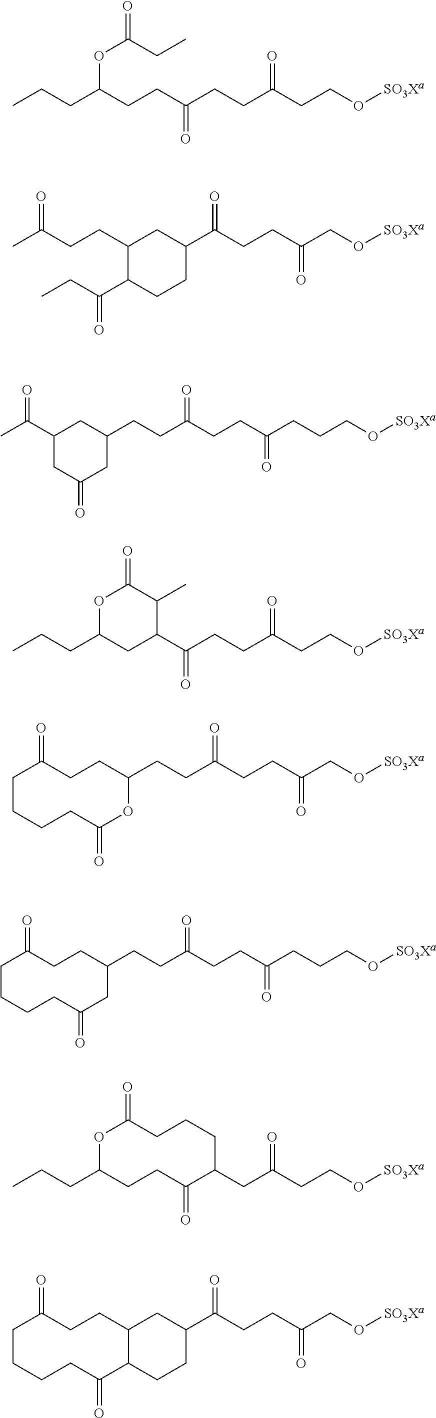

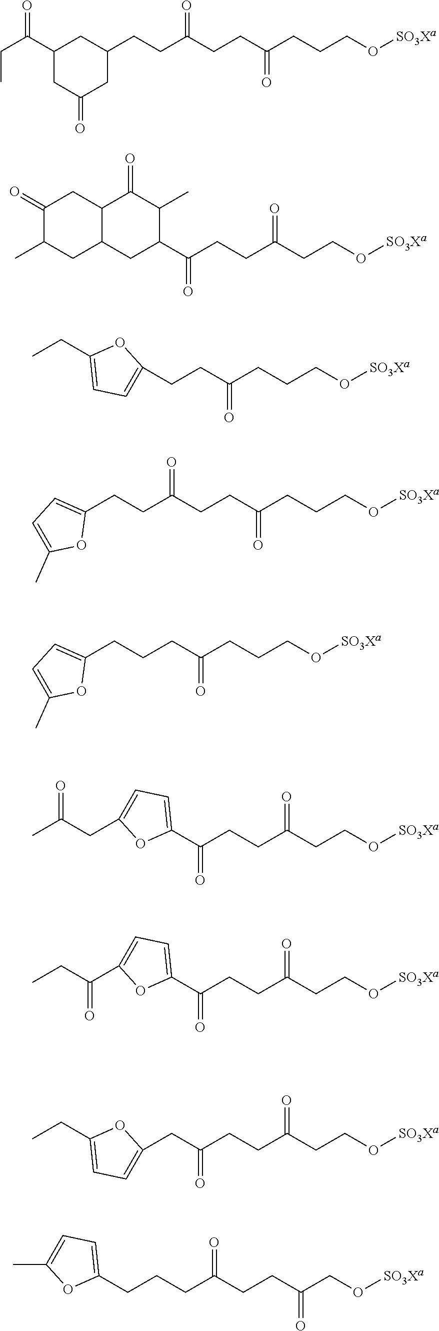

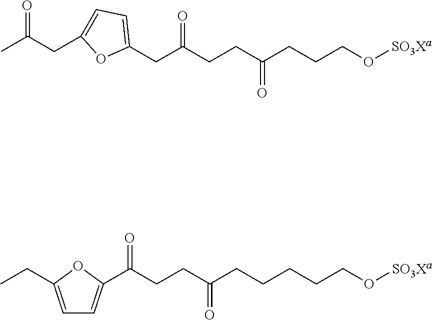

Next, the surfactant (b) will be described.

In the formula (b), R^{1b} is a linear or branched alkyl group having 1 or more carbon atoms and optionally having a substituent, or a cyclic alkyl group having 3 or more carbon atoms and optionally having a substituent.

The alkyl group, when the number of carbon atoms is 3 or more, may contain a monovalent or divalent heterocyclic ring or may form a ring. The heterocyclic ring is preferably an unsaturated heterocyclic ring, more preferably an oxygen-containing unsaturated heterocyclic ring. Examples thereof include a furan ring. In R^{1b}, the divalent heterocyclic ring may be intercalated between two carbon atoms, the divalent heterocyclic ring may be positioned at an end and bonded to —C(═O)—, or the monovalent heterocyclic ring may be positioned at an end of the alkyl group.

In the present disclosure, the “number of carbon atoms” in the alkyl group also includes the number of carbon atoms constituting the heterocyclic ring.

The substituent that may be carried by the alkyl group as R^{1b} is preferably a halogen atom, a linear or branched alkyl group having 1 to 10 carbon atoms, a cyclic alkyl group having 3 to 10 carbon atoms, or a hydroxy group, particularly preferably a methyl group or an ethyl group.

The alkyl group as R^{1b} preferably contains no carbonyl group.

In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

The alkyl group preferably does not have any substituent.

R^{1b} is preferably a linear or branched alkyl group having 1 to 10 carbon atoms and optionally having a substituent, or a cyclic alkyl group having 3 to 10 carbon atoms and optionally having a substituent, more preferably a linear or branched alkyl group having 1 to 10 carbon atoms and containing no carbonyl group, or a cyclic alkyl group having 3 to 10 carbon atoms and containing no carbonyl group, further preferably a linear or branched alkyl group having 1 to 10 carbon atoms and having no substituent, still more preferably a linear or branched alkyl group having 1 to 3 carbon atoms and having no substituent, particularly preferably a methyl group (—CH₃) or an ethyl group (—C₂H₅), most preferably a methyl group (—CH₃).

In the formula (b), R^{2b} and R^{4b} are each independently H or a substituent. A plurality of moieties of each of R^{2b} and R^{4b} may be the same or different.

The substituent as any of R^{2b} and R^{4b} is preferably a halogen atom, a linear or branched alkyl group having 1 to 10 carbon atoms, a cyclic alkyl group having 3 to 10 carbon atoms, or a hydroxy group, particularly preferably a methyl group or an ethyl group.

The alkyl group as any of R^{2b} and R^{4b} preferably contains no carbonyl group. In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

The alkyl group preferably does not have any substituent.

The alkyl group as any of R^{2b} and R^{4b} is preferably a linear or branched alkyl group having 1 to 10 carbon atoms and containing no carbonyl group, or a cyclic alkyl group having 3 to 10 carbon atoms and containing no carbonyl group, more preferably a linear or branched alkyl group having 1 to 10 carbon atoms and containing no carbonyl group, further preferably a linear or branched alkyl group having 1 to 3 carbon atoms and having no substituent, particularly preferably a methyl group (—CH₃) or an ethyl group (—C₂H₅).

R^{2b} and R^{4b} are each independently preferably H or a linear or branched alkyl group having 1 to 10 carbon atoms and containing no carbonyl group, more preferably H or a linear or branched alkyl group having 1 to 3 carbon atoms and having no substituent, still more preferably H, a methyl group (—CH₃), or an ethyl group (—C₂H₅), particularly preferably H.

In the formula (b), R^{3b} is an alkylene group having 1 to 10 carbon atoms and optionally having a substituent. A plurality of R^{3b} moieties, if present, may be the same or different.

The alkylene group preferably contains no carbonyl group. In the alkylene group, 75% or less of hydrogen atoms bonded to carbon atoms may be replaced with a halogen atom, 50% or less thereof may be replaced with a halogen atom, and 25% or less thereof may be replaced with a halogen atom. The alkylene group is preferably a non-halogenated alkyl group free of a halogen atoms such as a fluorine atom or a chlorine atom.

The alkylene group preferably does not have any substituent.

The alkylene group is preferably a linear or branched alkylene group having 1 to 10 carbon atoms and optionally having a substituent, or a cyclic alkylene group having 3 to 10 carbon atoms and optionally having a substituent, preferably a linear or branched alkylene group having 1 to 10 carbon atoms and containing no carbonyl group, or a cyclic alkylene group having 3 to 10 carbon atoms and containing no carbonyl group, more preferably a linear or branched alkylene group having 1 to 10 carbon atoms and having no substituent, further preferably a methylene group (—CH₂—), an ethylene group (—C₂H₄—), an isopropylene group (—CH(CH₃)CH₂—), or a propylene group (—C₃H₆—).

Any two of R^{1b}, R^{2b}, R^{3b}, and R^{4b} may be bonded to each other to form a ring, and preferably do not form the ring.

In the formula (b), n is an integer of 1 or larger. n is preferably an integer of 1 to 40, more preferably an integer of 1 to 30, further preferably an integer of 5 to 25, particularly preferably an integer of 5 to 9 or 11 to 25.

In the formula (b), p and q are each independently an integer of 0 or larger. p is preferably an integer of 0 to 10, more preferably 0 or 1. q is preferably an integer of 0 to 10, more preferably an integer of 0 to 5.

n, p, and q are preferably an integer of 5 or larger in total. n, p, and q are more preferably an integer of 8 or larger in total. Also, n, p, and q are preferably an integer of 60 or smaller, more preferably an integer of 50 or smaller, further preferably an integer of 40 or smaller, in total.

In the formula (b), X^{b} is H, a metal atom, NR^{5b}₄, imidazolium optionally having a substituent, pyridinium optionally having a substituent, or phosphonium optionally having a substituent, wherein R^{5b} is H or an organic group. Four R^{5b} moieties may be the same or different. The organic group for R^{5b} is preferably an alkyl group. R^{5b} is preferably H or an organic group having 1 to 10 carbon atoms, more preferably H or an organic group having 1 to 4 carbon atoms, further preferably H or an alkyl group having 1 to 4 carbon atoms. Examples of the metal atom include monovalent and divalent metal atoms and include alkali metals of group 1 and alkaline earth metals of group 2, with Na, K, or Li being preferable. X^{b} is a metal atom or NR^{5b}₄ wherein R^{5b} is as defined above.

X^{b} is preferably H, an alkali metal of group 1, an alkaline earth metal of group 2, or NR^{5b}₄, more preferably H, Na, K, Li, or NH₄ because of being easily dissolved in water, further preferably Na, K, or NH₄ because of being further easily dissolved in water, particularly preferably Na or NH₄, most preferably NH₄ because of being easily removed. When X^{b} is NH₄, the surfactant is excellent in solubility in the aqueous medium while a metal component is unlikely to remain in PTFE or in a final product.

In the formula (b), L is a single bond, —CO₂—B—*, —OCO—B—*, —CONR^{6b}—B—*, —NR^{6b}CO—B—*, or —CO— (except for a carbonyl group contained in —CO₂—B—, —OCO—B—, —CONR^{6b}—B—, or —NR⁶CO—B—), wherein B is a single bond or an alkylene group having 1 to 10 carbon atoms and optionally having a substituent, and R^{6b} is H or an alkyl group having 1 to 4 carbon atoms and optionally having a substituent. The alkylene group more preferably has 1 to 5 carbon atoms. R⁶ described above is more preferably H or a methyl group. * refers to the side bonded to —OSO₃X^{b} in the formula.

L is preferably a single bond.

Examples of the surfactant (b) include
CH₃C(O)CH₂CH₂CH₂CH₂CH₂CH₂CH₂CH₂CH₂OSO₃Na,
CH₃C(O)CH₂CH₂CH₂CH₂CH₂CH₂CH₂CH₂OSO₃Na,
CH₃C(O)CH₂CH₂CH₂CH₂CH₂CH₂CH₂OSO₃Na,
CH₃C(O)CH₂CH₂CH₂CH₂CH₂CH₂OSO₃Na,
CH₃C(O)CH₂CH₂CH₂CH₂CH₂OSO₃Na,
CH₃C(O)CH₂CH₂CH₂CH₂OSO₃Na,
(CH₃) 3CC(O)CH₂CH₂CH₂CH₂CH₂CH₂CH₂CH₂CH₂OSO₃Na,
(CH₃)₂CHC(O)CH₂CH₂CH₂CH₂CH₂CH₂CH₂CH₂CH₂OSO₃Na,
(CH₂)₅CHC(O)CH₂CH₂CH₂CH₂CH₂CH₂CH₂CH₂CH₂OSO₃Na,
CH₃CH₂C(O)CH₂CH₂CH₂CH₂CH₂CH₂CH₂CH₂OSO₃Na,
CH₃CH₂CH₂C(O)CH₂CH₂CH₂CH₂CH₂CH₂CH₂OSO₃Na,
CH₃CH₂CH₂CH₂C(O)CH₂CH₂CH₂CH₂CH₂CH₂OSO₃Na,
CH₃CH₂CH₂CH₂CH₂C(O)CH₂CH₂CH₂CH₂CH₂OSO₃Na,
CH₃CH₂CH₂CH₂CH₂CH₂C(O)CH₂CH₂CH₂CH₂OSO₃Na,
CH₃CH₂CH₂CH₂CH₂CH₂CH₂C(O)CH₂CH₂CH₂OSO₃Na,
CH₃CH₂CH₂CH₂CH₂CH₂CH₂CH₂C(O)CH₂CH₂OSO₃Na,
CH₃CH₂CH₂CH₂CH₂CH₂CH₂CH₂CH₂C(O)CH₂OSO₃Na,
CH₃C(O)CH₂CH₂CH₂CH₂CH₂CH₂CH₂CH₂CH₂OCH₂CH₂OSO₃Na,
CH₃C(O)CH₂CH₂CH₂CH₂CH₂CH₂CH₂CH₂CH₂C(O) NHCH₂OSO₃Na,
CH₃C(O)CH₂CH₂CH₂CH₂CH₂CH₂CH₂CH₂CH₂NHC(O)CH₂OSO₃Na,
CH₃C(O)CH₂CH₂CH₂CH₂CH₂CH₂CH₂CH₂CH₂C(O)OSO₃Na,
CH₃C(O)CH₂CH₂CH₂CH₂CH₂CH₂CH₂CH₂CH₂C(O)OCH₂OSO₃Na,
CH₃C(O)CH₂CH₂CH₂CH₂CH₂CH₂CH₂CH₂CH₂OC(O)CH₂OSO₃Na,
CH₃C(O)CH₂CH₂CH₂CH₂CH₂CH₂CH₂CH₂CH₂OSO₃H,
CH₃C(O)CH₂CH₂CH₂CH₂CH₂CH₂CH₂CH₂CH₂OSO₃Li,
CH₃C(O)CH₂CH₂CH₂CH₂CH₂CH₂CH₂CH₂CH₂OSO₃K,
CH₃C(O)CH₂CH₂CH₂CH₂CH₂CH₂CH₂CH₂CH₂OSO₃NH₄,
CH₃C(O)CH₂CH₂CH₂CH₂CH₂CH₂CH₂CH₂CH(CH₃)₂OSO₃Na,
CH₃C(O)CH₂CH₂CH₂CH₂CH₂CH₂CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂CH₂OSO₃Na,
CH₃C(O)CH₂CH₂CH₂CH₂CH₂CH₂CH₂CH₂CH₂CH₂OSO₃Na,
(CH₃) 3CC(O)CH₂CH₂CH₂CH₂CH₂CH₂CH₂CH₂CH₂CH₂CH₂CH₂CH₂CH₂CH₂CH₂CH₂OSO₃Na,
(CH₃) 2CHC(O)CH₂CH₂CH₂CH₂CH₂CH₂CH₂CH₂CH₂CH₂CH₂CH₂CH₂CH₂CH₂CH₂CH₂OSO₃N a,
(CH₂) CHC(O)CH₂CH₂CH₂CH₂CH₂CH₂CH₂CH₂CH₂CH₂CH₂CH₂CH₂CH₂CH₂CH₂CH₂OSO₃N a,
CH₃CH₂C(O)CH₂CH₂CH₂CH₂CH₂CH₂CH₂CH₂CH₂CH₂CH₂CH₂CH₂CH₂CH₂CH₂OSO₃Na,
CH₃CH₂CH₂CH₂CH₂C(O)CH₂CH₂CH₂CH₂CH₂CH₂CH₂CH₂CH₂CH₂CH₂CH₂CH₂OSO₃Na,
CH₃CH₂CH₂CH₂CH₂CH₂CH₂CH₂C(O)CH₂CH₂CH₂CH₂CH₂CH₂CH₂CH₂CH₂CH₂OSO₃Na,
CH₃CH₂CH₂CH₂CH₂CH₂CH₂CH₂CH₂CH₂CH₂C(O)CH₂CH₂CH₂CH₂CH₂CH₂CH₂OSO₃Na,
CH₃CH₂CH₂CH₂CH₂CH₂CH₂CH₂CH₂CH₂CH₂CH₂CH₂CH₂C(O)CH₂CH₂CH₂CH₂OSO₃Na,
CH₃CH₂C(O)CH₂CH₂CH₂CH₂CH₂CH₂CH₂CH₂CH₂CH₂CH₂CH₂CH₂CH₂CH₂CH₂OCH₂CH₂OSO₃Na,
CH₃CH₂C(O)CH₂CH₂CH₂CH₂CH₂CH₂CH₂CH₂CH₂CH₂CH₂CH₂CH₂CH₂CH₂CH₂C(O) NHCH₂CH₂OSO₃Na,
CH₃CH₂C(O)CH₂CH₂CH₂CH₂CH₂CH₂CH₂CH₂CH₂CH₂CH₂CH₂CH₂CH₂CH₂CH₂NHC(O)CH₂CH₂OSO₃Na,
CH₃CH₂C(O)CH₂CH₂CH₂CH₂CH₂CH₂CH₂CH₂CH₂CH₂CH₂CH₂CH₂CH₂CH₂CH₂C(O)OCH₂C H₂OSO₃Na,
CH₃CH₂C(O)CH₂CH₂CH₂CH₂CH₂CH₂CH₂CH₂CH₂CH₂CH₂CH₂CH₂CH₂CH₂CH₂OC(O)CH₂C H₂OSO₃Na,
CH₃CH₂C(O)CH₂CH₂CH₂CH₂CH₂CH₂CH₂CH₂CH₂CH₂CH₂CH₂CH₂CH₂CH₂CH₂C(O)OSO₃Na,
CH₃CH₂C(O)CH₂CH₂CH₂CH₂CH₂CH₂CH₂CH₂CH₂CH₂CH₂CH₂CH₂CH₂CH₂CH₂OSO₃H,
CH₃CH₂C(O)CH₂CH₂CH₂CH₂CH₂CH₂CH₂CH₂CH₂CH₂CH₂CH₂CH₂CH₂CH₂CH₂OSO₃Li,
CH₃CH₂C(O)CH₂CH₂CH₂CH₂CH₂CH₂CH₂CH₂CH₂CH₂CH₂CH₂CH₂CH₂CH₂CH₂OSO₃K,
CH₃CH₂C(O)CH₂CH₂CH₂CH₂CH₂CH₂CH₂CH₂CH₂CH₂CH₂CH₂CH₂CH₂CH₂CH₂OSO₃NH₄, and
CH₃C(O)CH₂CH₂CH₂CH₂CH₂CH₂CH₂CH₂CH₂CH₂CH₂CH₂CH₂CH₂CH₂CH₂CH₂CH₂CH₂CH₂CH_{0.0} Na.

The surfactant (c) will be described.

In the formula (c), Ric is a linear or branched alkyl group having 1 or more carbon atoms or a cyclic alkyl group having 3 or more carbon atoms.

The alkyl group, when the number of carbon atoms is 3 or more, may contain a carbonyl group (—C(═O)—) between two carbon atoms. Alternatively, the alkyl group, when the number of carbon atoms is 2 or more, may also contain the carbonyl group at an end of the alkyl group. In short, an acyl group such as an acetyl group represented by CH₃—C(═O)— is also included in the alkyl group.

The alkyl group, when the number of carbon atoms is 3 or more, may contain a monovalent or divalent heterocyclic ring or may form a ring. The heterocyclic ring is preferably an unsaturated heterocyclic ring, more preferably an oxygen-containing unsaturated heterocyclic ring. Examples thereof include a furan ring. In R^{1c}, the divalent heterocyclic ring may be intercalated between two carbon atoms, the divalent heterocyclic ring may be positioned at an end and bonded to —C(═O)—, or the monovalent heterocyclic ring may be positioned at an end of the alkyl group.

In the present disclosure, the “number of carbon atoms” in the alkyl group also includes the number of carbon atoms constituting the carbonyl group and the number of carbon atoms constituting the heterocyclic ring. For example, a group represented by CH₃—C(═O)—CH₂— has 3 carbon atoms, a group represented by CH₃—C(═O)—C₂H₄—C(═O)—C₂H₄— has 7 carbon atoms, and a group represented by CH₃—C(═O)— has 2 carbon atoms.

In the alkyl group, a hydrogen atom bonded to a carbon atom may be replaced with a functional group, for example, with a hydroxy group (—OH) or a monovalent organic group containing an ester bond, and is preferably not replaced with any functional group.

Examples of the monovalent organic group containing an ester bond include a group represented by the formula: —O—C(═O)—R^{101c} wherein R^{101c} is an alkyl group.

In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom. In the formula (c), R^{2c} and R^{3c} are each independently a single bond or a divalent linking group.

R^{2c} and R^{3c} are each independently preferably a single bond, a linear or branched alkylene group having 1 or more carbon atoms, or a cyclic alkylene group having 3 or more carbon atoms.

The alkylene group constituting any of R^{2c} and R^{3c} preferably contains no carbonyl group.

In the alkylene group, a hydrogen atom bonded to a carbon atom may be replaced with a functional group, for example, with a hydroxy group (—OH) or a monovalent organic group containing an ester bond, and is preferably not replaced with any functional group.

Examples of the monovalent organic group containing an ester bond include a group represented by the formula: —O—C(═O)—R^{102c} wherein R^{102c} is an alkyl group.

In the alkylene group, 75% or less of hydrogen atoms bonded to carbon atoms may be replaced with a halogen atom, 50% or less thereof may be replaced with a halogen atom, and 25% or less thereof may be replaced with a halogen atom. The alkylene group is preferably a non-halogenated alkylene group free of a halogen atoms such as a fluorine atom or a chlorine atom.

The total number of carbon atoms in R^{1c}, R^{2c}, and R^{3c} is 5 or more. The total number of carbon atoms is preferably 7 or more, more preferably 9 or more, and preferably 20 or less, more preferably 18 or less, further preferably 15 or less.

Any two of R^{1c}, R^{2c}, and R^{3c} may be bonded to each other to form a ring.

In the formula (c), A^{c} is —COOX^{c} or —SO₃X^{c}, wherein X^{c} is H, a metal atom, NR^{4c}₄, imidazolium optionally having a substituent, pyridinium optionally having a substituent, or phosphonium optionally having a substituent, wherein R^{4c} is H or an organic group, and the moieties may be the same or different. The organic group for R^{4c} is preferably an alkyl group. R^{4c} is preferably H or an organic group having 1 to 10 carbon atoms, more preferably H or an organic group having 1 to 4 carbon atoms, further preferably H or an alkyl group having 1 to 4 carbon atoms. Examples of the metal atom include monovalent and divalent metal atoms and include alkali metals of group 1 and alkaline earth metals of group 2, with Na, K, or Li being preferable.

X^{c} is preferably H, an alkali metal of group 1, an alkaline earth metal of group 2, or NR^{4c}₄, more preferably H, Na, K, Li, or NH₄ because of being easily dissolved in water, further preferably Na, K, or NH₄ because of being further easily dissolved in water, particularly preferably Na or NH₄, most preferably NH₄ because of being easily removed. When X^{c} is NH₄, the surfactant is excellent in solubility in the aqueous medium while a metal component is unlikely to remain in PTFE or in a final product.

Examples of the surfactant (c) can include surfactants given below. In each formula, A^{c} is as mentioned above.

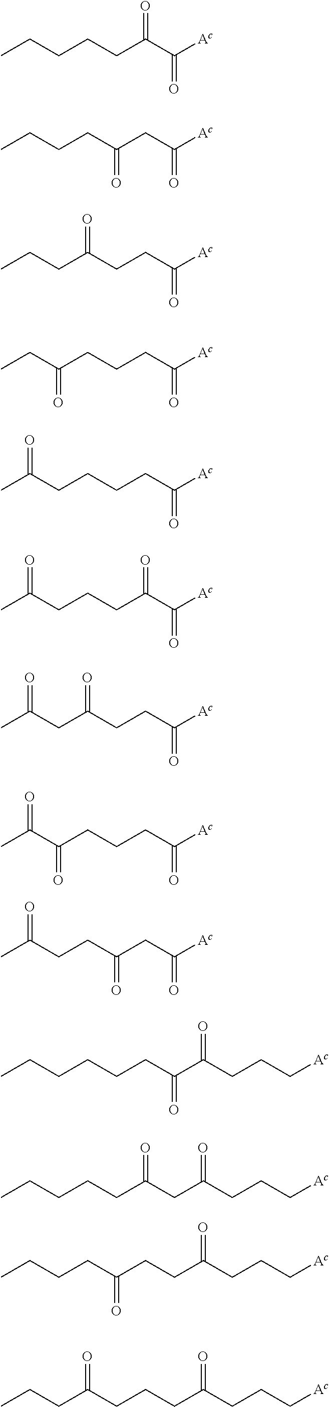

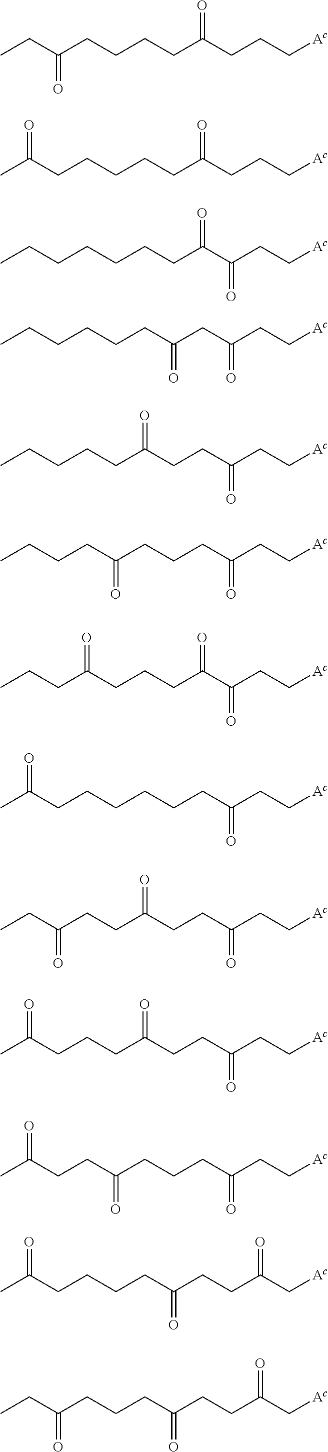

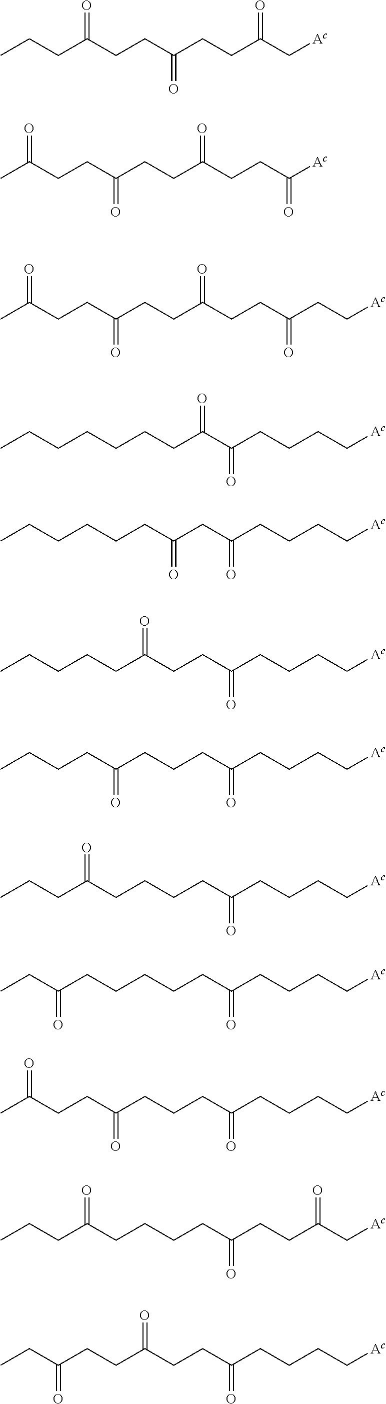

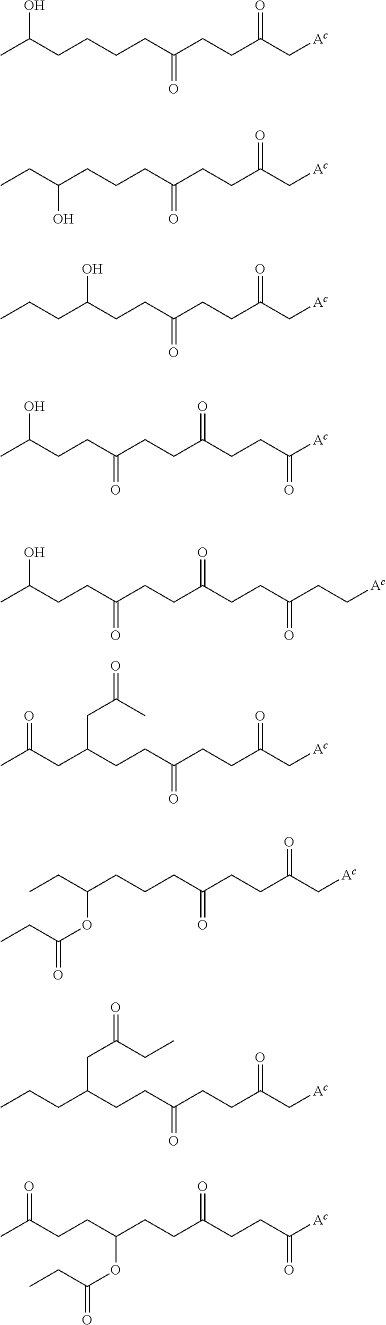

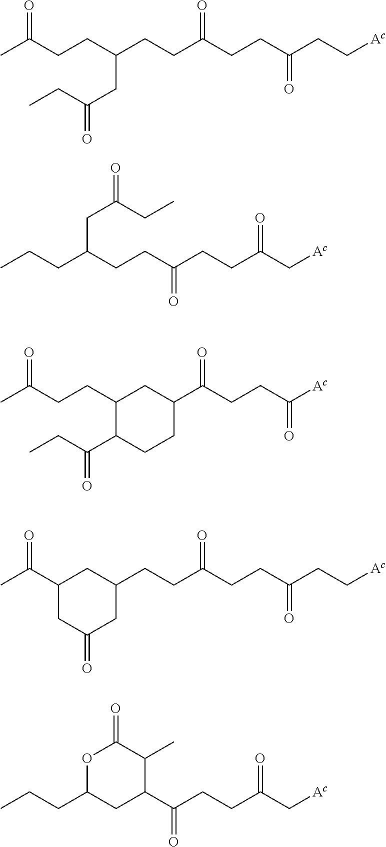

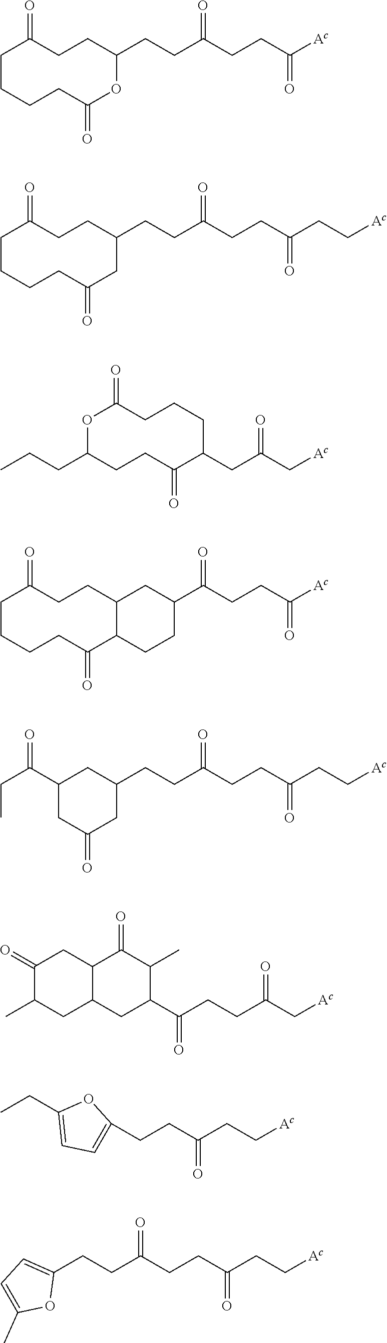

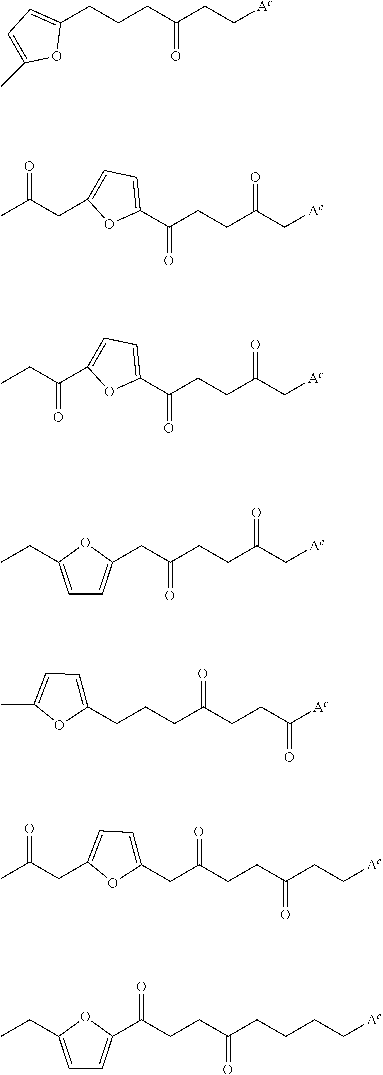

The surfactant (d) will be described.

In the formula (d), R^{1d} is a linear or branched alkyl group having 1 or more carbon atoms and optionally having a substituent, or a cyclic alkyl group having 3 or more carbon atoms and optionally having a substituent.

The alkyl group, when the number of carbon atoms is 3 or more, may contain a monovalent or divalent heterocyclic ring or may form a ring. The heterocyclic ring is preferably an unsaturated heterocyclic ring, more preferably an oxygen-containing unsaturated heterocyclic ring. Examples thereof include a furan ring. In R^{1d}, the divalent heterocyclic ring may be intercalated between two carbon atoms, the divalent heterocyclic ring may be positioned at an end and bonded to —C(═O)—, or the monovalent heterocyclic ring may be positioned at an end of the alkyl group.

In the present disclosure, the “number of carbon atoms” in the alkyl group also includes the number of carbon atoms constituting the heterocyclic ring.

The substituent that may be carried by the alkyl group as R^{1d} is preferably a halogen atom, a linear or branched alkyl group having 1 to 10 carbon atoms, a cyclic alkyl group having 3 to 10 carbon atoms, or a hydroxy group, particularly preferably a methyl group or an ethyl group.

The alkyl group as R^{1d} preferably contains no carbonyl group.

In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

The alkyl group preferably does not have any substituent.

R^{1d} is preferably a linear or branched alkyl group having 1 to 10 carbon atoms and optionally having a substituent, or a cyclic alkyl group having 3 to 10 carbon atoms and optionally having a substituent, more preferably a linear or branched alkyl group having 1 to 10 carbon atoms and containing no carbonyl group, or a cyclic alkyl group having 3 to 10 carbon atoms and containing no carbonyl group, further preferably a linear or branched alkyl group having 1 to 10 carbon atoms and having no substituent, still more preferably a linear or branched alkyl group having 1 to 3 carbon atoms and having no substituent, particularly preferably a methyl group (—CH₃) or an ethyl group (—C₂H₅), most preferably a methyl group (—CH₃).

In the formula (d), R^{2d} and R^{4d} are each independently H or a substituent. A plurality of moieties of each of R^{2d} and R^{4d} may be the same or different.

The substituent as any of R^{2d} and R^{4d} is preferably a halogen atom, a linear or branched alkyl group having 1 to 10 carbon atoms, a cyclic alkyl group having 3 to 10 carbon atoms, or a hydroxy group, particularly preferably a methyl group or an ethyl group.

The alkyl group as any of R^{2d} and R^{4d} preferably contains no carbonyl group. In the alkyl group, 75% or less of hydrogen atoms bonded to carbon atoms may be replaced with a halogen atom, 50% or less thereof may be replaced with a halogen atom, and 25% or less thereof may be replaced with a halogen atom. The alkyl group is preferably a non-halogenated alkyl group free of a halogen atoms such as a fluorine atom or a chlorine atom.

The alkyl group preferably does not have any substituent.

The alkyl group as any of R^{2d} and R^{4d} is preferably a linear or branched alkyl group having 1 to 10 carbon atoms and containing no carbonyl group, or a cyclic alkyl group having 3 to 10 carbon atoms and containing no carbonyl group, more preferably a linear or branched alkyl group having 1 to 10 carbon atoms and containing no carbonyl group, further preferably a linear or branched alkyl group having 1 to 3 carbon atoms and having no substituent, particularly preferably a methyl group (—CH₃) or an ethyl group (—C₂H₅).

R^{2d} and R^{4d} are each independently preferably H or a linear or branched alkyl group having 1 to 10 carbon atoms and containing no carbonyl group, more preferably H or a linear or branched alkyl group having 1 to 3 carbon atoms and having no substituent, still more preferably H, a methyl group (—CH₃), or an ethyl group (—C₂H₅), particularly preferably H.

In the formula (d), R^{3d} is an alkylene group having 1 to 10 carbon atoms and optionally having a substituent. A plurality of R^{3d} moieties, if present, may be the same or different.

The alkylene group preferably contains no carbonyl group.

In the alkylene group, 75% or less of hydrogen atoms bonded to carbon atoms may be replaced with a halogen atom, 50% or less thereof may be replaced with a halogen atom, and 25% or less thereof may be replaced with a halogen atom. The alkylene group is preferably a non-halogenated alkyl group free of a halogen atoms such as a fluorine atom or a chlorine atom.

The alkylene group preferably does not have any substituent.

The alkylene group is preferably a linear or branched alkylene group having 1 to 10 carbon atoms and optionally having a substituent, or a cyclic alkylene group having 3 to 10 carbon atoms and optionally having a substituent, preferably a linear or branched alkylene group having 1 to 10 carbon atoms and containing no carbonyl group, or a cyclic alkylene group having 3 to 10 carbon atoms and containing no carbonyl group, more preferably a linear or branched alkylene group having 1 to 10 carbon atoms and having no substituent, further preferably a methylene group (—CH₂—), an ethylene group (—C₂H₄—), an isopropylene group (—CH(CH₃)CH₂—), or a propylene group (—C₃H₆—).

Any two of R^{1d}, R^{2d}, R^{3d}, and R^{4d} may be bonded to each other to form a ring.

In the formula (d), n is an integer of 1 or larger. n is preferably an integer of 1 to 40, more preferably an integer of 1 to 30, further preferably an integer of 5 to 25.

In the formula (d), p and q are each independently an integer of 0 or larger. p is preferably an integer of 0 to 10, more preferably 0 or 1. q is preferably an integer of 0 to 10, more preferably an integer of 0 to 5.

n, p, and q are preferably an integer of 6 or larger in total. n, p, and q are more preferably an integer of 8 or larger in total. Also, n, p, and q are preferably an integer of 60 or smaller, more preferably an integer of 50 or smaller, further preferably an integer of 40 or smaller, in total.

In the formula (d), A^{d} is —SO₃X^{d} or —COOX^{d}, wherein X^{d} is H, a metal atom, NR^{5d}₄, imidazolium optionally having a substituent, pyridinium optionally having a substituent, or phosphonium optionally having a substituent, wherein R^{5d} is H or an organic group, and the moieties may be the same or different. The organic group for R^{5d} is preferably an alkyl group. R^{5d} is preferably H or an organic group having 1 to 10 carbon atoms, more preferably H or an organic group having 1 to 4 carbon atoms, further preferably H or an alkyl group having 1 to 4 carbon atoms. Examples of the metal atom include monovalent and divalent metal atoms and include alkali metals of group 1 and alkaline earth metals of group 2, with Na, K, or Li being preferable. X^{d} is a metal atom or NR^{5d}₄ wherein R^{5d} is as defined above.

X^{d} is preferably H, an alkali metal of group 1, an alkaline earth metal of group 2, or NR^{5d}₄, more preferably H, Na, K, Li, or NH₄ because of being easily dissolved in water, further preferably Na, K, or NH₄ because of being further easily dissolved in water, particularly preferably Na or NH₄, most preferably NH₄ because of being easily removed. When X^{d} is NH₄, the surfactant is excellent in solubility in the aqueous medium while a metal component is unlikely to remain in PTFE or in a final product.

In the formula (d), L is a single bond, —CO₂—B—*, —OCO—B—*, —CONR^{6d}—B—*, —NR^{6d}CO—B—*, or —CO— (except for a carbonyl group contained in —CO₂—B—, —OCO—B—, —CONR^{6d}—B—, or —NR^{6d}CO—B—), wherein B is a single bond or an alkylene group having 1 to 10 carbon atoms and optionally having a substituent, and R^{6d} is H or an alkyl group having 1 to 4 carbon atoms and optionally having a substituent. The alkylene group more preferably has 1 to 5 carbon atoms. R^{6d} described above is more preferably H or a methyl group. * refers to the side bonded to A^{d} in the formula.

L is preferably a single bond.

Examples of the surfactant (d) include
CH₃C(O)CH₂CH₂CH₂CH₂CH₂CH₂CH₂CH₂COOK,
CH₃C(O)CH₂CH₂CH₂CH₂CH₂CH₂CH₂COONa,
CH₃C(O)CH₂CH₂CH₂CH₂CH₂CH₂COONa,
CH₃C(O)CH₂CH₂CH₂CH₂CH₂COONa,
CH₃C(O)CH₂CH₂CH₂CH₂COONa,
CH₃C(O)CH₂CH₂CH₂COONa,
CH₃C(O)CH₂CH₂CH₂CH₂CH₂CH₂CH₂CH₂CH₂CH₂CH₂CH₂CH₂COONa,
CH₃C(O)CH₂CH₂CH₂CH₂CH₂CH₂CH₂CH₂CH₂CH₂CH₂CH₂CH₂CH₂CH₂CH₂CH₂CH₂COONa,
(CH₃)₃CC(O)CH₂CH₂CH₂CH₂CH₂CH₂CH₂CH₂COONa,
(CH₃)₂CHC(O)CH₂CH₂CH₂CH₂CH₂CH₂CH₂CH₂COONa,
(CH₂)₅CHC(O)CH₂CH₂CH₂CH₂CH₂CH₂CH₂CH₂COONa,
CH₃CH₂C(O)CH₂CH₂CH₂CH₂CH₂CH₂CH₂COONa,
CH₃CH₂CH₂C(O)CH₂CH₂CH₂CH₂CH₂CH₂COONa,
CH₃CH₂CH₂CH₂C(O)CH₂CH₂CH₂CH₂CH₂COONa,
CH₃CH₂CH₂CH₂CH₂C(O)CH₂CH₂CH₂CH₂COONa,
CH₃CH₂CH₂CH₂CH₂CH₂C(O)CH₂CH₂CH₂COONa,
CH₃CH₂CH₂CH₂CH₂CH₂CH₂C(O)CH₂CH₂COONa,
CH₃CH₂CH₂CH₂CH₂CH₂CH₂CH₂C(O)CH₂COONa,
CH₃C(O)CH₂CH₂CH₂CH₂CH₂CH₂CH₂CH₂OCH₂CH₂COONa,
CH₃C(O)CH₂CH₂CH₂CH₂CH₂CH₂CH₂CH₂C(O) NHCH₂COOK,
CH₃C(O)CH₂CH₂CH₂CH₂CH₂CH₂CH₂CH₂NHC(O)CH₂COOK,
CH₃C(O)CH₂CH₂CH₂CH₂CH₂CH₂CH₂CH₂C(O) OCH₂COONa,
CH₃C(O)CH₂CH₂CH₂CH₂CH₂CH₂CH₂CH₂OC(O)CH₂COONa,
CH₃C(O)CH₂CH₂CH₂CH₂CH₂CH₂CH₂CH₂C(O)COONa,
CH₃C(O)CH₂CH₂CH₂CH₂CH₂CH₂CH₂CH₂C(O)COOH,
CH₃C(O)CH₂CH₂CH₂CH₂CH₂CH₂CH₂CH₂C(O)COOLi,
CH₃C(O)CH₂CH₂CH₂CH₂CH₂CH₂CH₂CH₂C(O)COONH₄,
CH₃C(O)CH₂CH₂CH₂CH₂CH₂CH₂CH₂CH(O)₂COONa,
CH₃C(O)CH₂CH₂CH₂CH₂CH₂CH₂CH₂C(CH₂)₂COOK,
CH₃C(O)CH₂CH₂CH₂CH₂CH₂CH₂CH₂CH₂CH₂SO₃Na,
CH₃C(O)CH₂CH₂CH₂CH₂CH₂CH₂CH₂CH₂SO₃Na,
CH₃C(O)CH₂CH₂CH₂CH₂CH₂CH₂CH₂SO₃Na,
CH₃C(O)CH₂CH₂CH₂CH₂CH₂CH₂SO₃Na,
CH₃C(O)CH₂CH₂CH₂CH₂CH₂SO₃Na,
CH₃C(O)CH₂CH₂CH₂CH₂SO₂Na,
CH₃C(O)CH₂CH₂CH₂CH₂CH₂CH₂CH₂CH₂CH₂CH₂CH₂CH₂CH₂SO₂Na,
CH₃C(O)CH₂CH₂CH₂CH₂CH₂CH₂CH₂CH₂CH₂CH₂CH₂CH₂CH₂CH₂CH₂CH₂CH₂CH₂SO₃Na,
CH₃C(O)CH₂CH₂CH₂CH₂CH₂CH₂CH₂CH₂CH₂CH₂SO₃Na,
(CH₃)₃CC(O)CH₂CH₂CH₂CH₂CH₂CH₂CH₂CH₂CH₂SO₃Na,
(CH₂)₂CHC(O)CH₂CH₂CH₂CH₂CH₂CH₂CH₂CH₂CH₂SO₃Na,
(CH₂)₅CHC(O)CH₂CH₂CH₂CH₂CH₂CH₂CH₂CH₂CH₂SO₃Na,
CH₃C(O)CH₂CH₂CH₂CH₂CH₂CH₂CH₂CH₂SO₃Na,
CH₃C(O)CH₂CH₂CH₂CH₂CH₂CH₂CH₂SO₃Na,
CH₃C(O)CH₂CH₂CH₂CH₂CH₂CH₂SO₃Na,
CH₃C(O)CH₂CH₂CH₂CH₂CH₂SO₃Na,
CH₃C(O)CH₂CH₂CH₂CH₂SO₃Na,
CH₃C(O)CH₂CH₂CH₂SO₃Na,
CH₃C(O)CH₂CH₂SO₃Na,
CH₃C(O)CH₂SO₃Na,
CH₃C(O)CH₂CH₂CH₂CH₂CH₂CH₂CH₂CH₂CH₂OCH₂CH₂CH₂SO₃Na,
CH₃C(O)CH₂CH₂CH₂CH₂CH₂CH₂CH₂CH₂CH₂C(O) NHCH₂SO₃Na,
CH₃C(O)CH₂CH₂CH₂CH₂CH₂CH₂CH₂CH₂CH₂NHC(O)CH₂SO₃Na,
CH₃C(O)CH₂CH₂CH₂CH₂CH₂CH₂CH₂CH₂CH₂C(O) SO₃Na,
CH₃C(O)CH₂CH₂CH₂CH₂CH₂CH₂CH₂CH₂CH₂C(O) OCH₂SO₃Na,
CH₃C(O)CH₂CH₂CH₂CH₂CH₂CH₂CH₂CH₂CH₂OC(O)CH₂SO₃Na,
CH₃C(O)CH₂CH₂CH₂CH₂CH₂CH₂CH₂CH₂CH₂SO₃H,
CH₃C(O)CH₂CH₂CH₂CH₂CH₂CH₂CH₂CH₂CH₂SO₃K,
CH₃C(O)CH₂CH₂CH₂CH₂CH₂CH₂CH₂CH₂CH₂SO₃Li,
CH₃C(O)CH₂CH₂CH₂CH₂CH₂CH₂CH₂CH₂CH₂SO₃NH₄, and
CH₃C(O)CH₂CH₂CH₂CH₂CH₂CH₂CH₂CH₂C(CH₃)₂SO₃Na.

Examples of the hydrocarbon surfactant include a compound I represented by the following formula I:

R—(XZ)ₙ (I)

wherein R is a hydrophobic hydrocarbon moiety containing one or more saturated or unsaturated noncyclic or cyclic aliphatic groups, wherein the percentage of the total of CH₃ groups based on the total of CH₃, CH₂, and CH groups in the one or more aliphatic groups is at least approximately 70%, and the hydrophobic moiety contains no siloxane unit; X may be the same or different and each represents an ionic hydrophilic moiety; Z may be the same or different and each represents one or more counterions for the ionic hydrophilic moiety; and n is 1 to 3.

The compound I exhibits low reactivity with a polymerization initiator and/or a growing fluoropolymer radical in the polymerization of TFE.

The compound I preferably contains a substitution moiety represented by the following formula:

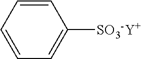

wherein Y⁺ is hydrogen, ammonium, quaternary ammonium, a nitrogen heterocyclic ring, an alkali metal, or an alkaline earth.

The compound I is preferably a compound II represented by the following formula II:

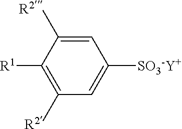

wherein R^{2′} and R^{2″} are the same or different and each represent a saturated or unsaturated noncyclic or cyclic aliphatic group having 4 to 16 carbon atoms, wherein the percentage of the total of CH₃ groups based on the total of CH₃, CH₂, and CH groups in the R^{2′} and R^{2″} groups is at least approximately 70%, or R^{2′} and R^{2″} may be bonded together to form a saturated or unsaturated aliphatic ring optionally containing an ether or ester bond on the proviso that the percentage of the total of CH₃ groups based on the total of CH₃, CH₂, and CH groups in the ring is at least approximately 70%; R¹ is hydrogen, methoxy, ethoxy, or phenoxy; and Y⁺ is hydrogen, ammonium, quaternary ammonium, a nitrogen heterocyclic ring, an alkali metal, or an alkaline earth.

The compound II is preferably, for example, any of the following compounds:

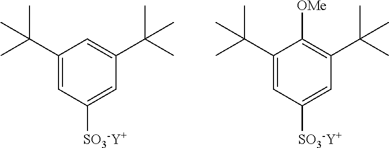

In the formulas, Y⁺ can be hydrogen, ammonium, or an alkali metal.

The compound I is also preferably a compound III represented by the following formula III:

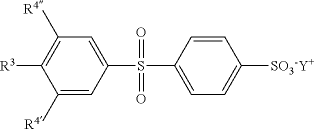

wherein R³, R^{4′}, and R^{4″} are the same or different and each represent hydrogen or a saturated or unsaturated noncyclic or cyclic aliphatic group having 4 to 16 carbon atoms, wherein the percentage of the total of CH₃ groups based on the total of CH₃, CH₂, and CH groups in the R³, R^{4′}, and R^{4″} groups is at least approximately 70% on the proviso that at least one of R³, R^{4′}, and R^{4″} is not hydrogen, R³ is not hydrogen when each of R^{4′} and R^{4″} is hydrogen, and neither R^{4′} nor R^{4″} is hydrogen when R³ is hydrogen; and Y⁺ is hydrogen, ammonium, quaternary ammonium, a nitrogen heterocyclic ring, an alkali metal, or an alkaline earth.

The compound III is preferably, for example, the following compound:

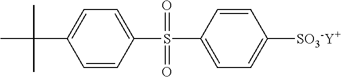

In the formula, Y⁺ can be hydrogen, ammonium, or an alkali metal.

In the production method of the present disclosure, two or more of the hydrocarbon surfactants described above may be used at the same time.

The hydrocarbon surfactant may be, for example, a specific hydrocarbon surfactant which is the aforementioned surfactant (1), the aforementioned hydrocarbon surfactant having at least one carbonyl group which is not in a carboxyl group, or a hydrocarbon surfactant obtained by radical treatment or oxidation treatment of the hydrocarbon surfactant having at least one carbonyl group which is not in a carboxyl group.

The specific hydrocarbon surfactant is also preferably the aforementioned hydrocarbon surfactant having at least one carbonyl group which is not in a carboxyl group, or a hydrocarbon surfactant obtained by radical treatment or oxidation treatment of the hydrocarbon surfactant having at least one carbonyl group which is not in a carboxyl group.

Use of the specific hydrocarbon surfactant obtained by radical treatment or oxidation treatment easily produces primary particles having a small average primary particle size and aspect ratio, whereby the polymerization of TFE progresses smoothly in the aqueous medium so that PTFE can be easily produced.

The radical treatment can be any treatment that allows a radical to act on the hydrocarbon surfactant, and is, for example, a treatment involving adding deionized water and the hydrocarbon surfactant to a reactor, hermetically sealing the reactor, purging the system with nitrogen, elevating the temperature and the pressure of the reactor, then charging the reactor with a polymerization initiator, stirring the mixture for a given time, and then depressurizing the reactor until reaching barometric pressure, followed by cooling. The oxidation treatment is a treatment involving allowing an oxidizing agent to act on the carboxylic acid-type hydrocarbon surfactant. Examples of the oxidizing agent include oxygen, ozone, hydrogen peroxide water, manganese(IV) oxide, potassium permanganate, potassium dichromate, nitric acid, and sulfur dioxide.

The specific hydrocarbon surfactant is preferably at least one member selected from the group consisting of the surfactant (1) represented by the general formula (1), the surfactant (a) represented by the formula (a), the surfactant (b) represented by the formula (b), the surfactant (c) represented by the formula (c), the surfactant (d) represented by the formula (d), and surfactants obtained by radical treatment or oxidation treatment of these surfactants (a) to (d), more preferably at least one member selected from the group consisting of the surfactant (a) represented by the formula (a), the surfactant (b) represented by the formula (b), the surfactant (c) represented by the formula (c), the surfactant (d) represented by the formula (d), and surfactants obtained by radical treatment or oxidation treatment of these surfactants (a) to (d).

The hydrocarbon surfactant for use in the production method of the present disclosure is also preferably a carboxylic acid-type hydrocarbon surfactant. The carboxylic acid-type hydrocarbon surfactant compared with a sulfuric acid ester surfactant tends to have a shorter coagulation completion time. However, the production method of the present disclosure can produce an aqueous dispersion having a long coagulation completion time even when the carboxylic acid-type hydrocarbon surfactant is used.

In short, the production method of the present disclosure is particularly suitable when the hydrocarbon surfactant is a carboxylic acid-type hydrocarbon surfactant.

The carboxylic acid-type hydrocarbon surfactant is usually an anionic hydrocarbon surfactant having a hydrophilic moiety of carboxylate, and a hydrophobic moiety which is a long-chain hydrocarbon moiety such as alkyl. Specifically, the carboxylic acid-type hydrocarbon surfactant is not limited as long as the surfactant has a carboxyl group (—COOH) or a group in which a hydrogen atom of the carboxyl group is replaced with an inorganic cation (e.g., a metal atom or ammonium). For example, a hydrocarbon surfactant having a carboxyl group or a group in which a hydrogen atom of the carboxyl group is replaced with an inorganic cation can be used among the hydrocarbon surfactants mentioned above.

The carboxylic acid-type hydrocarbon surfactant may be, for example, an aliphatic carboxylic acid-type hydrocarbon surfactant, or may be, for example, a non-aliphatic carboxylic acid-type hydrocarbon surfactant.

In the present disclosure, the “aliphatic carboxylic acid-type hydrocarbon surfactant” means a carboxylic acid-type hydrocarbon surfactant free of a carbonyl group which is in neither a carboxyl group nor an ester group.

The ester group means a group represented by —COO— or —OCO—.

The carboxylic acid-type hydrocarbon surfactant may be, for example, a hydrocarbon surfactant having a carboxyl group or a group in which a hydrogen atom of the carboxyl group is replaced with an inorganic cation among the hydrocarbon surfactants mentioned above.

The carboxylic acid-type hydrocarbon surfactant is preferably at least one member selected from the group consisting of the surfactant (1), the aforementioned anionic surfactant represented by the formula: R^{6z}(-L-M)₂, and the aforementioned anionic surfactant represented by the formula: R^{7z}(-L-M)₃, each of which has a carboxyl group (—COOH) or a group in which a hydrogen atom of the carboxyl group is replaced with an inorganic cation (e.g., a metal atom or ammonium); the compound (α): the surfactant (1-0A); and surfactants obtained by radical treatment or oxidation treatment of these surfactants. One of these carboxylic acid-type hydrocarbon surfactants may be used, or a mixture of two or more thereof may be used.

The compound (α) includes not only the aforementioned anionic hydrocarbon surfactant represented by the formula: R¹⁰⁰—COOM wherein R¹⁰⁰ and M are as defined above (preferably a compound represented by the formula (A)), but the aforementioned anionic surfactant represented by the formula: R^{z}-L-M wherein R^{z}, L, and M are as defined above, and the surfactant (c) and the surfactant (d), each of which has a carboxyl group (—COOH) or a group in which a hydrogen atom of the carboxyl group is replaced with an inorganic cation (e.g., a metal atom or ammonium).

The carboxylic acid-type hydrocarbon surfactant is preferably the compound (α), more preferably at least one member selected from the group consisting of a compound represented by the formula (A), a compound of the formula (c) wherein A^{c} is —COOX^{c}, a compound of the formula (d) wherein A^{d} is —COOX^{d}, a compound of the formula (1) wherein A is —COOM, a compound of the formula (1-0A) wherein A is —COOM, and compounds obtained by radical treatment or oxidation treatment of these compounds, further preferably at least one member selected from the group consisting of a compound represented by the formula (A) and a compound obtained by radical treatment or oxidation treatment of the compound.

The carboxylic acid-type hydrocarbon surfactant is preferably at least one member selected from the group consisting of lauric acid, capric acid, myristic acid, pentadecylic acid, palmitic acid, and their salts, and compounds obtained by radical treatment or oxidation treatment of these compounds, more preferably at least one member selected from the group consisting of lauric acid and a salt thereof, and compounds obtained by radical treatment or oxidation treatment of these compounds, further preferably at least one member selected from the group consisting of a salt of lauric acid and a compound obtained by radical treatment or oxidation treatment thereof, further preferably at least one member selected from the group consisting of sodium laurate and a compound obtained by radical treatment or oxidation treatment thereof. Examples of the salt include, but are not limited to, salts in which hydrogen of a carboxyl group is a metal atom, NR¹⁰¹₄, imidazolium optionally having a substituent, pyridinium optionally having a substituent, or phosphonium optionally having a substituent for the above formula M.

The carboxylic acid-type hydrocarbon surfactant is preferably at least one member selected from the group consisting of the surfactant (1-0A) represented by the general formula (1-0A), the compound (α), the surfactant (c) represented by the formula (c), and the surfactant (d) represented by the formula (d).

### (Aqueous Medium)

The aqueous medium for use in the production method of the present disclosure means a liquid containing water. The aqueous medium is not limited as long as the aqueous medium contains water. The aqueous medium may contain water and, for example, a non-fluorine-containing organic solvent such as an alcohol, ether, or ketone, and/or a fluorine-containing organic solvent having a boiling point of 40 °C or lower.

The aqueous medium is preferably an aqueous medium containing only water, or an aqueous medium containing only water and a non-fluorine-containing organic solvent, more preferably an aqueous medium containing only water.

The content of water in the aqueous medium is preferably 90% or more, more preferably 95% or more, further preferably 99.0% or more, still further preferably 99.5% or more, particularly preferably 99.9% or more, and can be 100%, based on the mass of the aqueous medium.

### (Monomer)

In the production method of the present disclosure, it is also preferred to polymerize TFE and a modifying monomer. In short, PTFE may be, for example, homo PTFE containing only TFE unit, or may be, for example, modified PTFE containing TFE unit and a modifying monomer unit based on a modifying monomer copolymerizable with TFE.

The amount of the modifying monomer added in polymerizing TFE is preferably 0.001% by mass or more, more preferably 0.01% by mass or more, further preferably 0.03% by mass or more, particularly preferably 0.05% by mass or more, and preferably 1.0% by mass or less, more preferably 0.8% by mass or less, further preferably 0.5% by mass or less, particularly preferably 0.3% by mass or less, based on the resulting PTFE.

The modifying monomer is not limited as long as the modifying monomer is copolymerizable with TFE. Examples thereof include fluoromonomers and non-fluoro monomers. The modifying monomer used may be, for example, one type or may be, for example, a plurality of types.

Examples of the fluoromonomer include perfluoroolefin such as hexafluoropropylene [HFP]; hydrogen-containing fluoroolefin such as trifluoroethylene and vinylidene fluoride [VDF]; perhaloolefin such as chlorotrifluoroethylene; perfluorovinyl ether; (perfluoroalkyl)ethylene; and perfluoroallyl ether.

The modifying monomer is preferably at least one member selected from the group consisting of hexafluoropropylene, perfluoro(alkyl vinyl ether), and (perfluoroalkyl)ethylene, more preferably at least one member selected from the group consisting of hexafluoropropylene, perfluoro(methyl vinyl ether), perfluoro(propyl vinyl ether), (perfluorobutyl)ethylene, (perfluorohexyl)ethylene, and (perfluorooctyl)ethylene.

### (Polymerization)

In the production method of the present disclosure, TFE is usually polymerized at a polymerization temperature of 10 to 150 °C and a polymerization pressure of 0.05 to 5 MPaG. The polymerization temperature is more preferably, for example, 30 °C or higher, further preferably 50 °C or higher. The polymerization temperature is more preferably 120 °C or lower, further preferably 100 °C or lower. The polymerization pressure is more preferably 0.3 MPaG or higher, further preferably 0.5 MPaG or higher, and more preferably 5.0 MPaG or lower, further preferably 3.0 MPaG or lower. The polymerization pressure is preferably 1.0 MPaG or higher, more preferably 1.2 MPaG or higher, further preferably 1.5 MPaG or higher, more preferably 2.0 MPaG or higher, particularly, from the viewpoint of improving the amount of PTFE obtained.

In one embodiment, the polymerization involves charging a pressure-proof reaction container equipped with a stirrer with a pure water, deoxidizing the container, then charging the container with TFE, setting the temperature to a predetermined one, and adding a polymerization initiator thereto to start reaction. If the pressure decreases as the reaction progresses, additional TFE is supplied continuously or intermittently so as to maintain the initial pressure. After the completion of supply of TFE in a predetermined amount, the supply is terminated, and TFE in the reaction container is purged. The temperature is brought back to room temperature to complete the reaction. Additional TFE may be supplied continuously or intermittently such that the pressure does not decrease.

The polymerization initiator may be persulfate (e.g., ammonium persulfate) and organic peroxide such as disuccinic acid peroxide or diglutaric acid peroxide, which can be used singly or in the form of a mixture thereof. Alternatively, a redox system may be used by combined use with a reducing agent such as sodium sulfite. Furthermore, a radical concentration in the system may be adjusted during the polymerization by the addition of a radical scavenger such as hydroquinone or catechol or by the addition of a peroxide decomposer such as ammonium sulfite.

The polymerization initiator for the redox system is preferably redox initiators of an oxidizing agent and a reducing agent in combination. Examples of the oxidizing agent include persulfate, organic peroxide, potassium permanganate, manganese triacetate, and ceric ammonium nitrate. Examples of the reducing agent include sulfite, bisulfite, bromate, diimine, and oxalic acid. Examples of the persulfate include ammonium persulfate and potassium persulfate. Examples of the sulfite include sodium sulfite and ammonium sulfite. The combination of the redox initiators is also preferably supplemented with copper salt or iron salt in order to increase the decomposition rate of the initiators. Examples of the copper salt include copper(II) sulfate. Examples of the iron salt include iron(II) sulfate.

Examples of the redox initiators include potassium permanganate/oxalic acid, potassium permanganate/ammonium oxalic acid, ammonium persulfate/bisulfite/iron sulfate, manganese triacetate/oxalic acid, ceric ammonium nitrate/oxalic acid, and bromate/bisulfite, with potassium permanganate/oxalic acid being preferable. In the case of using the redox initiators, a polymerization tank may be charged with one of the oxidizing agent and the reducing agent in advance, and subsequently, the polymerization can be started by continuous or intermittent addition of the other agent. In the case of using, for example, potassium permanganate/oxalic acid, it is preferred to charge a polymerization tank with oxalic acid and continuously add potassium permanganate thereto.

A known chain transfer agent can be used. Examples thereof include saturated hydrocarbons such as methane, ethane, propane, and butane, halogenated hydrocarbons such as chloromethane, dichloromethane, and difluoroethane, alcohols such as methanol, ethanol, and isopropanol, and hydrogen. The chain transfer agent is preferably in a gas state at ordinary temperature and ordinary pressure.

The amount of the chain transfer agent used is usually 1 to 10,000 ppm by mass, preferably 1 to 5,000 ppm by mass, based on the total amount of TFE supplied.

In the polymerization of TFE, a saturated hydrocarbon having 12 or more carbon atoms that is substantially inert to the reaction and is in a liquid state under the reaction conditions described above may be further used as a dispersion stabilizer of the reaction system at 2 to 10 parts by mass per 100 parts by mass of the aqueous medium. Also, ammonium carbonate, ammonium phosphate, or the like may be added as a buffer for adjusting pH during the reaction.

### (Aqueous Dispersion Obtained by Polymerization)

An aqueous dispersion having a solid concentration of 1.0 to 50% by mass and an average primary particle size of 50 to 500 nm can be obtained at the completion of polymerization of TFE.

The lower limit of the solid concentration is preferably 5% by mass, more preferably 8% by mass. The upper limit thereof is not limited and may be, for example, 40% by mass, or may be, for example, 35% by mass.

The lower limit of the average primary particle size is preferably 100 nm, more preferably 150 nm. The upper limit thereof is preferably 400 nm, more preferably 350 nm. The average primary particle size can be measured by dynamic light scattering.

### (Coagulation)

In the production method of the present disclosure, after the aqueous dispersion containing non melt-processible PTFE is obtained, the non melt-processible PTFE in the obtained aqueous dispersion is coagulated to obtain a wet powder.

The coagulation method is preferably at least one coagulation method selected from the group consisting of a coagulation method by stirring, an ultrasonic coagulation method, a coagulation method using ultrafine bubble, a coagulation method using an alkali, a coagulation method using an acid, a coagulation method using an oxidizing agent, a coagulation method using an organic solvent, and a coagulation method using a radical generator. In the production method of the present disclosure, the non melt-processible PTFE is also preferably coagulated using at least one coagulation method selected from the group consisting of an ultrasonic coagulation method, a coagulation method using ultrafine bubble, a coagulation method using an alkali, a coagulation method using an acid, a coagulation method using an oxidizing agent, a coagulation method using an organic solvent, and a coagulation method using a radical generator while the aqueous dispersion is stirred.

As mentioned later, if heat treatment is performed at a relatively low temperature, the content of a fluorine-containing compound having a hydrophilic group cannot be sufficiently reduced in the wet powder, whereby non melt-processible PTFE that can be subjected to extrusion forming at a stable extrusion pressure may not be obtained. On the other hand, too high a heat treatment temperature results in too high an extrusion pressure of the resulting non melt-processible PTFE, though the temperature can reduce the content of the fluorine-containing compound having a hydrophilic group in the wet powder. Heat treatment performed at a relatively low temperature and furthermore, coagulation performed by the method described above can excellently achieve both of sufficient removal of the fluorine-containing compound having a hydrophilic group and stabilization of a low extrusion pressure.

The temperature of the aqueous dispersion at which the non melt-processible PTFE is coagulated can be 3 to 95 °C, can be 5 °C or higher, can be 10 °C or higher, can be 85 °C or lower, can be 75 °C or lower, and can be 60 °C or lower.

In the coagulation method by stirring, the aqueous dispersion is stirred vigorously enough to coagulate non melt-processible PTFE particles. The stirring can be performed using, for example, a container with a stirrer. The coagulation by the coagulation method by stirring may be continuously performed using in-line mixers or the like.

In the ultrasonic coagulation method, ultrasonic waves strong enough to coagulate non melt-processible PTFE particles are applied to the aqueous dispersion.

The power of the ultrasonic waves is preferably 100 W or more, more preferably 200 W or more, further preferably 300 W or more, still further preferably 400 W or more, particularly preferably 500 W or more, and preferably 3,000 W or less, more preferably 1,000 W or less, further preferably 800 W or less.

The frequency of the ultrasonic waves is preferably 15 kHz or more, more preferably 20 kHz or more, further preferably 25 kHz or more, still further preferably 30 kHz or more, particularly preferably 40 kHz or more, and preferably 100 kHz or less, more preferably 80 kHz or less, further preferably 50 kHz or less.

The application time of the ultrasonic waves is preferably 60 seconds or longer, more preferably 300 seconds or longer, and preferably 20 minutes or shorter.

The application of the ultrasonic waves can be performed using a commercially available ultrasonic generator. Examples of the ultrasonic irradiator include commercially available ultrasonic transmitters (e.g., ultrasonic homogenizers), ultrasonic transducers, circulatory ultrasonic irradiators, ultrasonic oscillators, and ultrasonic cleaners.

Specific examples of the method for applying ultrasonic waves include an application method of dipping a nozzle part of an ultrasonic homogenizer in the aqueous dispersion, an application method of dipping a cast-type ultrasonic oscillator in a container fed with the PTFE aqueous dispersion, an application method of introducing a container containing the PTFE aqueous dispersion into an ultrasonic cleaner charged with an aqueous medium and the like in advance, an application method of introducing the PTFE dispersion to an ultrasonic cleaner or an ultrasonic transducer fabricated in a vessel shape, and a method of applying ultrasonic waves by introducing the PTFE aqueous dispersion into a vessel equipped with a rod-shaped ultrasonic applicator. It is also preferred to apply ultrasonic waves to the aqueous dispersion while stirring the aqueous dispersion.

In the coagulation method using ultrafine bubble, ultrafine bubble in an amount by which non melt-processible PTFE particles are coagulated is generated in the aqueous dispersion. The ultrafine bubble is cells having a diameter of 1 μm or smaller. The ultrafine bubble can be generated, for example, by applying ultrasonic waves to the aqueous dispersion to cause cavitation. It is also preferred to stir the ultrafine-bubbled aqueous dispersion.

The time of the treatment with ultrafine bubble is preferably 60 seconds or longer, more preferably 300 seconds or longer, and preferably 20 minutes or shorter.

In the coagulation method using an alkali, an alkali can be used such as sodium hydroxide, potassium hydroxide, lithium hydroxide, or ammonia. The ammonia is preferably ammonium bicarbonate or ammonium carbonate. The alkali is preferably at least one member selected from the group consisting of sodium hydroxide, potassium hydroxide, lithium hydroxide, and ammonia, more preferably sodium hydroxide. It is also preferred to stir the aqueous dispersion containing the alkali.

In the case of performing coagulation using the alkali for an aqueous dispersion containing a fluorine-containing compound having an anionic group as the fluorine-containing compound having a hydrophilic group, the fluorine-containing compound is rendered highly water-soluble through the conversion of the anionic group of the fluorine-containing compound to a salt form. Therefore, this approach has the advantage that the fluorine-containing compound is easily removed from the wet powder by cleaning the wet powder obtained by the coagulation. The fluorine-containing compound having the anionic group in a salt form that remains in the wet powder thus cleaned is unlikely to volatilize and therefore tends to be difficult to remove even by the heat treatment of the wet powder. However, the content of the fluorine-containing compound can be further smoothly reduced by cleaning the wet powder using an acid before heat treatment. Thus, in another preferred embodiment, after coagulation is performed using the alkali, the obtained wet powder is cleaned using an acid, and the cleaned wet powder is heat-treated.

In the coagulation method using an acid, an organic acid or an inorganic acid can be used. The acid is preferably an inorganic acid from the viewpoint that the inorganic acid is unlikely to remain during heat treatment, in particular, preferably at least one member selected from the group consisting of nitric acid, sulfuric acid, fuming sulfuric acid, perchloric acid, and hydrochloric acid, more preferably at least one member selected from the group consisting of nitric acid, sulfuric acid, and hydrochloric acid. Examples of the organic acid include succinic acid, oxalic acid, citric acid, and trifluoroacetic acid. The amount of the acid added is not limited and can be appropriately set depending on the pH of the aqueous dispersion, or the like. It is also preferred to stir the aqueous dispersion containing the acid.

In the coagulation method using an oxidizing agent, at least one member selected from the group consisting of an inorganic acid and a salt thereof can be used. Examples of the inorganic acid include nitrous acid, nitric acid, sulfurous acid, sulfuric acid, persulfuric acid, hydrochloric acid, hypochlorous acid, chlorous acid, chloric acid, perchloric acid, hydrofluoric acid, bromic acid, iodic acid, phosphoric acid, boric acid, chromic acid, dichromic acid, and permanganic acid. Examples of the salt of the inorganic acid include sodium salt, potassium salt, ammonium salt, magnesium salt, calcium salt, aluminum salt, and silver salt. The oxidizing agent is more preferably at least one member selected from the group consisting of nitric acid and a salt thereof, and perchloric acid and a salt thereof, further preferably at least one member selected from the group consisting of nitrate and perchlorate, particularly preferably at least one member selected from the group consisting of sodium nitrate, potassium nitrate, ammonium nitrate, and ammonium perchlorate. Two or more oxidizing agents may be used in combination. For example, an inorganic acid and an inorganic acid salt may be used in combination, and nitric acid and nitrate (e.g., sodium nitrate or ammonium nitrate) may be used in combination. It is also preferred to stir the aqueous dispersion containing the oxidizing agent.

The amount of the oxidizing agent added is preferably 0.01 to 20% by mass, more preferably 0.1% by mass or more, further preferably 0.3% by mass or more, and more preferably 10% by mass or less, further preferably 5% by mass or less, based on the non melt-processible PTFE in the aqueous dispersion. In one embodiment, the non melt-processible PTFE is coagulated by adding the oxidizing agent to the aqueous dispersion and stirring the mixture.

In the coagulation method using an organic solvent, for example, any of the following organic solvents can be used. alcohols;
carboxylic acid such as acetic acid, propionic acid, ethoxyacetic acid, and valeric acid;
ester such as methyl acetate, ethyl acetate, propyl acetate, butyl acetate, methyl propionate, ethyl propionate, propyl propionate, and dimethyl carbonate;
ketone such as methyl ethyl ketone, methyl isobutyl ketone, cyclohexanone, diacetone alcohol, and 3-methyl-2-cyclopentenone;
aromatic hydrocarbon such as benzene, toluene, and xylene; and ether such as diethyl ether, tetrahydrofuran, dioxane, diethylene glycol diethyl ether, and 1,2-dimethoxyethane.

Among them, the organic solvent is preferably an alcohol. The alcohol may be any of a monohydric alcohol, a dihydric alcohol, and a trihydric alcohol. The alcohol is preferably a monohydric alcohol. The number of carbon atoms in the alcohol is preferably 2 to 7, more preferably 3 or more, and more preferably 5 or less, further preferably 4 or less. The organic solvent is preferably at least one member selected from the group consisting of methanol, 1-propanol, 2-propanol, 2-butanol, and 1-pentanol, more preferably at least one member selected from the group consisting of 1-propanol, 2-propanol, 2-butanol, and 1-pentanol, further preferably at least one member selected from the group consisting of 1-propanol, 2-butanol, and 1-pentanol.

The amount of the organic solvent added is preferably a weight that corresponds to 1.0% by mass or more based on the non melt-processible PTFE in the aqueous dispersion. The amount of the organic solvent used in the coagulation is more preferably 5.0% by mass or more, further preferably 10% by mass or more, particularly preferably 20% by mass or more, and an amount equal to or less than a weight that corresponds to 50 times, more preferably an amount equal to or less than a weight that corresponds to 10 times, further preferably an amount equal to or less than a weight that corresponds to 5 times. It is also preferred to stir the aqueous dispersion containing the organic solvent.

In the coagulation method using a radical generator, a water-soluble radical generator can be suitably used. Examples of the radical generator include organic peroxide, inorganic peroxide, organic azo compounds, and combinations of an oxidizing agent and a reducing agent. The radical generator is preferably at least one member selected from the group consisting of inorganic peroxide, organic peroxide, and a combination of an oxidizing agent and a reducing agent. In one embodiment, the non melt-processible PTFE is coagulated by adding the radical generator to the aqueous dispersion and heating the aqueous dispersion to a temperature equal to or higher than the decomposition temperature of the radical generator. It is also preferred to stir the aqueous dispersion containing the radical generator.

The inorganic peroxide is preferably water-soluble inorganic peroxide. Examples of the inorganic peroxide include hydrogen peroxide, perchlorate, perborate, perphosphate, percarbonate, and persulfate, with persulfate being preferable. The persulfate is preferably at least one member selected from the group consisting of ammonium persulfate, sodium persulfate, and potassium persulfate, more preferably ammonium persulfate.

The organic peroxide is preferably water-soluble organic peroxide. Examples of the organic peroxide include peroxydicarbonate such as disuccinic acid peroxide and diglutaric acid peroxide.

The radical generator may be an oxidizing agent and a reducing agent used in combination. The oxidizing agent and the reducing agent used in combination can generate a radical from the radical generator through the redox reaction between the oxidizing agent and the reducing agent, and can therefore lower the temperature of heat treatment.

Examples of the oxidizing agent include persulfate, organic peroxide, potassium permanganate, manganese triacetate, and ceric ammonium nitrate. Examples of the reducing agent include sulfite, bisulfite, bromate, diimine, and oxalic acid. Examples of the persulfate include ammonium persulfate and potassium persulfate. Examples of the sulfite include sodium sulfite and ammonium sulfite. It is also preferred to add copper salt or iron salt in order to increase the decomposition rate of the oxidizing agent. Examples of the copper salt include copper(II) sulfate. Examples of the iron salt include iron(II) sulfate.

The heating temperature of the aqueous dispersion containing the radical generator is not limited as long as the temperature is equal to or higher than a temperature at which the radical generator is decomposed to generate a radical (decomposition temperature). The temperature is preferably 35 °C or higher, more preferably 40 °C or higher, further preferably 45 °C or higher, particularly preferably 50 °C or higher, and preferably 120 °C or lower, more preferably 110 °C or lower, further preferably 100 °C or lower, particularly preferably 90 °C or lower.

### (Cleaning)

In the production method of the present disclosure, a coagulate resulting from the coagulation of the non melt-processible PTFE is recovered to obtain a wet powder, and then, the wet powder is cleaned. The number of cleaning operations can be 1 or can be 2 or more.

The cleaning method is preferably at least one cleaning method selected from the group consisting of a cleaning method by stirring, an ultrasonic cleaning method, a cleaning method using ultrafine bubble, a cleaning method using an alkali, a cleaning method using an acid, and a cleaning method using a radical generator.

As mentioned later, if heat treatment is performed at a relatively low temperature, the content of a fluorine-containing compound having a hydrophilic group cannot be sufficiently reduced in the wet powder, whereby non melt-processible PTFE that can be subjected to extrusion forming at a stable extrusion pressure may not be obtained. On the other hand, too high a heat treatment temperature results in too high an extrusion pressure of the resulting non melt-processible PTFE, though the temperature can reduce the content of the fluorine-containing compound having a hydrophilic group in the wet powder. Heat treatment performed at a relatively low temperature and furthermore, cleaning performed by the method described above can excellently achieve both of sufficient removal of the fluorine-containing compound having a hydrophilic group and stabilization of a low extrusion pressure. Further, heat treatment performed at a relatively low temperature, coagulation performed by the method described above, and furthermore, cleaning performed by the method described above can further easily and excellently achieve both of sufficient removal of the fluorine-containing compound having a hydrophilic group and stabilization of a low extrusion pressure.

The temperature at which the wet powder is cleaned can be 3 to 95 °C. The temperature at which the wet powder is cleaned can be 5 °C or higher or 10 °C or higher. The temperature at which the wet powder is cleaned can be 85 °C or lower, 75 °C or lower, or 60 °C or lower.

In the cleaning method by stirring, the wet powder is fed into water, and the water is stirred. The stirring can be performed using, for example, a container with a stirrer. The cleaning is preferably performed a plurality of times. In the case of performing the cleaning a plurality of times, the final cleaning is more preferably performed at 30 °C or lower.

In the ultrasonic cleaning method, the wet powder is fed into a liquid, and ultrasonic waves are applied to the liquid. The liquid is, for example, water or an alcohol. The alcohol is preferably at least one member selected from the group consisting of methanol, 1-propanol, 2-propanol, 2-butanol, and 1-pentanol, more preferably methanol.

The power of the ultrasonic waves is preferably 100 W or more, more preferably 200 W or more, further preferably 300 W or more, still further preferably 400 W or more, particularly preferably 500 W or more, and preferably 3,000 W or less, more preferably 1,000 W or less, further preferably 800 W or less.

The frequency of the ultrasonic waves is preferably 15 kHz or more, more preferably 20 kHz or more, further preferably 25 kHz or more, still further preferably 30 kHz or more, particularly preferably 40 kHz or more, and preferably 100 kHz or less, more preferably 80 kHz or less, further preferably 50 kHz or less.

The application time of the ultrasonic waves is preferably 60 seconds or longer, more preferably 300 seconds or longer, and preferably 180 minutes or shorter, more preferably 150 minutes or shorter, further preferably 120 minutes or shorter, particularly preferably 20 minutes or shorter.

The application of the ultrasonic waves can be performed using a commercially available ultrasonic generator. Examples of the ultrasonic irradiator include commercially available ultrasonic transmitters (e.g., ultrasonic homogenizers), ultrasonic transducers, circulatory ultrasonic irradiators, ultrasonic oscillators, and ultrasonic cleaners.

Specific examples of the method for applying ultrasonic waves to the powder and the liquid include an application method of dipping a nozzle part of an ultrasonic homogenizer in the liquid, an application method of dipping a cast-type ultrasonic oscillator in a container fed with the liquid, an application method of introducing a container containing the liquid into an ultrasonic cleaner charged with an aqueous medium and the like in advance, an application method of introducing the liquid to an ultrasonic cleaner or an ultrasonic transducer fabricated in a vessel shape, and a method of applying ultrasonic waves by introducing the liquid into a vessel equipped with a rod-shaped ultrasonic applicator.

In the cleaning method using ultrafine bubble, the wet powder is fed into water, and ultrafine bubble is generated in the water. The ultrafine bubble is cells having a diameter of 1 μm or smaller. The ultrafine bubble can be generated, for example, by applying ultrasonic waves to water to cause cavitation.

The time of the cleaning with ultrafine bubble is preferably 60 seconds or longer, more preferably 300 seconds or longer, and preferably 20 minutes or shorter.

In the cleaning method using an alkali, an alkali can be used such as sodium hydroxide, potassium hydroxide, lithium hydroxide, or ammonia. The ammonia is preferably ammonium bicarbonate or ammonium carbonate. The alkali is preferably at least one member selected from the group consisting of sodium hydroxide, potassium hydroxide, lithium hydroxide, and ammonia, more preferably sodium hydroxide.

In the case of performing cleaning using the alkali for a wet powder containing a fluorine-containing compound having an anionic group as the fluorine-containing compound having a hydrophilic group, the fluorine-containing compound is rendered highly water-soluble through the conversion of the anionic group of the fluorine-containing compound to a salt form. Therefore, this approach has the advantage that the fluorine-containing compound is easily removed from the wet powder by cleaning the resulting wet powder. The fluorine-containing compound having the anionic group in a salt form that remains in the wet powder thus cleaned is unlikely to volatilize and therefore tends to be difficult to remove even by the heat treatment of the wet powder. However, the content of the fluorine-containing compound can be further smoothly reduced by cleaning the wet powder using an acid before heat treatment. Thus, in another preferred embodiment, the wet powder is cleaned using the alkali and subsequently cleaned using an acid, and the cleaned wet powder is heat-treated.

In the cleaning method using an acid, an organic acid or an inorganic acid can be used. The acid is preferably an inorganic acid from the viewpoint that the inorganic acid is unlikely to remain during heat treatment, in particular, preferably at least one member selected from the group consisting of nitric acid, sulfuric acid, fuming sulfuric acid, perchloric acid, and hydrochloric acid, more preferably at least one member selected from the group consisting of nitric acid, sulfuric acid, and hydrochloric acid. Examples of the organic acid include succinic acid, oxalic acid, citric acid, and trifluoroacetic acid. The amount of the acid added is not limited and can be appropriately set depending on the pH of water containing the powder, or the like. In one embodiment, the wet powder is cleaned by feeding the wet powder and the acid into water and stirring the water.

In the cleaning method using a radical generator, a water-soluble radical generator can be suitably used. Examples of the radical generator include organic peroxide, inorganic peroxide, organic azo compounds, and combinations of an oxidizing agent and a reducing agent. The radical generator is preferably at least one member selected from the group consisting of inorganic peroxide, organic peroxide, and a combination of an oxidizing agent and a reducing agent. In one embodiment, the wet powder is cleaned by feeding the wet powder and the radical generator into water and heating the water to a temperature equal to or higher than the decomposition temperature of the radical generator, followed by stirring.

The radical generator for use in the cleaning may be the radical generator that can be used in the coagulation method using a radical generator.

The heating temperature of water is not limited as long as the temperature is equal to or higher than a temperature at which the radical generator is decomposed to generate a radical (decomposition temperature). The temperature is preferably 35 °C or higher, more preferably 40 °C or higher, further preferably 45 °C or higher, particularly preferably 50 °C or higher, and preferably 120 °C or lower, more preferably 110 °C or lower, further preferably 100 °C or lower, particularly preferably 90 °C or lower.

### (Heat Treatment)

In the production method of the present disclosure, after the wet powder is cleaned, the cleaned wet powder is heat-treated.

The content of moisture in the heat-treated wet powder is preferably 10% by mass or more, more preferably 20% by mass or more, further preferably 30% by mass or more, and preferably 150% by mass or less, more preferably 100% by mass or less, based on the wet powder.

The temperature of the heat treatment is preferably 10 to 280 °C. The temperature of the heat treatment can be 100 °C or higher, 120 °C or higher, 130 °C or higher, 140 °C or higher, 150 °C or higher, or 160 °C or higher. The temperature of the heat treatment can be 230 °C or lower, 210 °C or lower, 200 °C or lower, 190 °C or lower, 185 °C or lower, or 180 °C or lower. In the production method of the present disclosure, the heat treatment is preferably performed at such a relatively low temperature. The heat treatment performed at a relatively low temperature can produce non melt-processible PTFE that has a reduced content of a fluorine-containing compound having a hydrophilic group and can be subjected to extrusion forming at a low extrusion pressure and a stable extrusion pressure.

The temperature of the heat treatment can be 170 °C or higher, 175 °C or higher, 180 °C or higher, 185 °C or higher, 190 °C or higher, 195 °C or higher, 200 °C or higher, 205 °C or higher, 210 °C or higher, or 220 °C or higher. The temperature of the heat treatment can be 300 °C or lower, 290 °C or lower, 280 °C or lower, 270 °C or lower, 260 °C or lower, or 250 °C or lower.

The time of the heat treatment is preferably 5 to 3,000 minutes. The time of the heat treatment can be 10 minutes or longer, 15 minutes or longer, 20 minutes or longer, 30 minutes or longer, 40 minutes or longer, 50 minutes or longer, 100 minutes or longer, 150 minutes or longer, or 200 minutes or longer. The time of the heat treatment can be 2,500 minutes or shorter or 2,000 minutes or shorter, or 1,500 minutes or shorter. In the production method of the present disclosure, the heat treatment is preferably performed at a relatively low temperature for a relatively long time.

The time of the heat treatment can be 5 minutes or longer, 10 minutes or longer, 15 minutes or longer, 20 minutes or longer, 30 minutes or longer, 40 minutes or longer, 50 minutes or longer, 60 minutes or longer, or 80 minutes or longer, and can be 300 minutes or shorter, 200 minutes or shorter, 170 minutes or shorter, 140 minutes or shorter, 110 minutes or shorter, or 80 minutes or shorter. In the production method of the present disclosure, it is preferred to shorten the time of the heat treatment if the heat treatment is performed at a relatively high temperature.

The heat treatment can be performed in air. Alternatively, the heat treatment can be performed in an oxygen-rich gas or an ozone-containing gas so that reduction in the content of the fluorine-containing compound having a hydrophilic group can be further promoted.

The heat treatment method is preferably a method of bringing hot air into contact with the wet powder, or a method of heating the wet powder in the presence of steam. If heat treatment is performed at a relatively low temperature, the content of a fluorine-containing compound having a hydrophilic group cannot be sufficiently reduced in the wet powder, whereby non melt-processible PTFE that can be subjected to extrusion forming at a stable extrusion pressure may not be obtained. On the other hand, too high a heat treatment temperature for a longer time of the heat treatment tends to result in too high an extrusion pressure of the resulting non melt-processible PTFE, though the temperature can reduce the content of the fluorine-containing compound having a hydrophilic group in the wet powder. Heat treatment of the wet powder performed within the above temperature range as well as the heat treatment performed using hot air or steam for a properly adjusted time of the heat treatment can excellently achieve both of sufficient removal of the fluorine-containing compound having a hydrophilic group and stabilization of a low extrusion pressure.

The heat treatment using hot air can be performed by blowing hot air to the wet powder. In one embodiment, the wet powder is placed in a container that opens at the top and is air-permeable at the bottom and/or the side, and hot air is blown to the placed wet powder. In another embodiment, the wet powder is placed in a heating furnace, and hot air is blown to the placed wet powder by circulating the hot air in the heating furnace. In an alternative embodiment, the wet powder is placed in a heating furnace, and hot air is blown to the placed wet powder by circulating the hot air in the heating furnace while discharging the hot air from the heating furnace.

The wind velocity of the hot air to be blown to the wet powder can be 0.01 m/s or more, 0.03 m/s or more, 0.05 m/s or more, 0.10 m/s or more, 0.20 m/s or more, 0.30 m/s or more, 0.40 m/s or more, 0.50 m/s or more, or 0.60 m/s or more. The wind velocity of the hot air to be blown to the wet powder can be 10 m/s or less, 5.0 m/s or less, 3.0 m/s or less, 2.0 m/s or less, or 1.0 m/s or less.

In one embodiment, the wet powder is heat-treated by placing the wet powder such that, when hot air goes through a hot air-blown surface into a surface facing the hot air-blown surface, an atmospheric pressure of the hot air-blown surface is higher than that of the surface facing the hot air-blown surface, to form a wet powder layer, and subsequently blowing hot air to the wet powder layer so that the hot air is introduced into the wet powder layer from the hot air-blown surface and discharged from the surface facing the hot air-blown surface (in the present disclosure, this approach is also referred to as “through-flow drying treatment”).

According to this method, hot air goes through voids in the wet powder layer over a given time. Therefore, individual particles in the wet powder layer come in sufficient contact with the hot air, and the wet powder is uniformly heated. Thus, non melt-processible polytetrafluoroethylene that has a reduced content of a fluorine-containing compound having a hydrophilic group and can be subjected to extrusion forming at a lower extrusion pressure and a more stable extrusion pressure can be produced because a homogeneous fluoropolymer powder can be obtained.

In the through-flow drying treatment, the particle size of the wet powder, the thickness of the wet powder layer, and the wind velocity of the hot air are properly adjusted such that the hot air goes through a hot air-blown surface into a surface facing the hot air-blown surface. For example, when hot air is blown to the upper face of the wet powder layer, the hot air may be discharged from the lateral side of the wet powder layer. However, the lateral side of the wet powder layer does not face the hot air-blown surface (upper face of the wet powder layer) and therefore does not correspond to the surface facing the hot air-blown surface.

The through-flow drying treatment can be performed, for example, by placing the wet powder in a container that opens at the top and is air-permeable at the bottom, to form a wet powder layer, and blowing hot air to the upper face of the wet powder layer while discharging the hot air from the lower face thereof, or blowing hot air to the lower face of the wet powder layer while discharging the hot air from the upper face thereof. In this respect, the atmospheric pressure of the hot air-blown surface and the atmospheric pressure of the surface (surface from which the hot air escapes) facing the hot air-blown surface can be adjusted by properly adjusting the particle size of the wet powder, the thickness of the wet powder layer, and the wind velocity of the hot air. A smaller particle size of the wet powder tends to increase the difference between the atmospheric pressures. A larger thickness of the wet powder layer tends to increase the difference between the atmospheric pressures. The difference between the atmospheric pressure of the hot air-blown surface and the atmospheric pressure of the surface (surface from which the hot air escapes) facing the hot air-blown surface is preferably 10 Pa or more.

The treatment time of the through-flow drying treatment can be 5 minutes or longer, 10 minutes or longer, 15 minutes or longer, 20 minutes or longer, 30 minutes or longer, 40 minutes or longer, 50 minutes or longer, 60 minutes or longer, or 80 minutes or longer, and can be 300 minutes or shorter, 200 minutes or shorter, 170 minutes or shorter, 140 minutes or shorter, 110 minutes or shorter, or 80 minutes or shorter.

The temperature of the hot air to be blown to the wet powder is as described above as the temperature of the heat treatment. The treatment temperature (temperature of the hot air) in the through-flow drying treatment can be higher than 150 °C, 155 °C or higher, 160 °C or higher, 165 °C or higher, 170 °C or higher, 175 °C or higher, 180 °C or higher, 185 °C or higher, 190 °C or higher, 195 °C or higher, 200 °C or higher, 205 °C or higher, 210 °C or higher, or 220 °C or higher. The treatment temperature (temperature of the hot air) in the through-flow drying treatment can be 260 °C or lower, 235 °C or lower, 230 °C or lower, 225 °C or lower, 220 °C or lower, 215 °C or lower, or 210 °C or lower.

The treatment temperature (temperature of the hot air) in the through-flow drying treatment can be 170 °C or higher, 180 °C or higher, 190 °C or higher, 200 °C or higher, 210 °C or higher, or 220 °C or higher. The treatment temperature (temperature of the hot air) in the through-flow drying treatment can be 300 °C or lower, 290 °C or lower, 280 °C or lower, 270 °C or lower, 260 °C or lower, or 250 °C or lower.

In the through-flow drying treatment, for example, the treatment temperature (temperature of the hot air) can be set to higher than 250 °C and 280 °C or lower, and the treatment time can be set to 50 minutes or shorter. In the through-flow drying treatment, for example, the treatment temperature (temperature of the hot air) can be set to higher than 200 °C and 250 °C or lower, and the treatment time can be set to 100 minutes or shorter. In the through-flow drying treatment, for example, the treatment temperature (temperature of the hot air) can be set to higher than 150 °C and 200 °C or lower, and the treatment time can be set to 200 minutes or shorter.

The wind velocity of the hot air in the through-flow drying treatment can be 0.01 m/s or more, 0.03 m/s or more, 0.05 m/s or more, 0.10 m/s or more, 0.20 m/s or more, 0.30 m/s or more, 0.40 m/s or more, 0.50 m/s or more, or 0.60 m/s or more. The wind velocity of the hot air in the through-flow drying treatment can be 10 m/s or less, 5.0 m/s or less, 3.0 m/s or less, 2.0 m/s or less, or 1.0 m/s or less.

In the case of using a heating furnace such as an electric furnace in the heat treatment process, the amount of a gas, air, or steam supplied into the heating furnace, the amount of a gas, air, or steam circulated into the heating furnace, the amount of a gas, air, or steam discharged to the outside of the heating furnace, and the like can be adjusted. The gas and air are also collectively referred to as hot air.

The ratio of the amount of a gas, air, or steam discharged from the heating furnace to the amount of the gas, air, or steam circulated in the heating furnace can be 3% by volume or more, 5% by volume or more, 10% by volume or more, 20% by volume or more, 30% by volume or more, 40% by volume or more, or 50% by volume or more, and can be 95% by volume or less, 80% by volume or less, or 75% by volume or less.

The ratio of the amount of a gas, air, or steam discharged from the heating furnace to the amount of the gas, air, or steam circulated in the heating furnace in the through-flow drying treatment can be 3% by volume or more, 5% by volume or more, 10% by volume or more, 20% by volume or more, 30% by volume or more, 40% by volume or more, or 50% by volume or more, and can be 95% by volume or less, 80% by volume or less, 75% by volume or less, 50% by volume or less, 40% by volume or less, or 30% by volume or less. A higher proportion of the amount of a gas, air, or steam discharged tends to enhance the removal efficiency of the fluorine-containing compound having a hydrophilic group, and a lower proportion of the amount of a gas, air, or steam discharged tends to facilitate the management of the internal temperature of the heating furnace and reduce cost.

The ratio of the amount of a gas, air, or steam discharged from the heating furnace to the amount of the gas, air, or steam circulated in the heating furnace in hot air circulation-type drying treatment can be 10% by volume or more, 20% by volume or more, or 30% by volume or more, and can be 95% by volume or less, 80% by volume or less, or 75% by volume or less.

When the heat treatment temperature is higher than 200 °C, the ratio of the amount of a gas, air, or steam discharged from the heating furnace to the amount of the gas, air, or steam circulated in the heating furnace can be 3% by volume or more, 5% by volume or more, 10% by volume or more, 20% by volume or more, 30% by volume or more, 40% by volume or more, or 50% by volume or more, and can be 95% by volume or less, 80% by volume or less, 75% by volume or less, 50% by volume or less, 40% by volume or less, or 30% by volume or less.

When the heat treatment temperature is 200 °C or lower, the ratio of the amount of a gas, air, or steam discharged from the heating furnace to the amount of the gas, air, or steam circulated in the heating furnace can be 10% by volume or more, 20% by volume or more, or 30% by volume or more, and can be 95% by volume or less, 80% by volume or less, or 75% by volume or less.

In one embodiment, the wet powder is heat-treated by placing the wet powder such that, when hot air is blown to a surface, the hot air is not discharged from a surface facing the hot air-blown surface, or such that, when hot air goes through a hot air-blown surface into a surface facing the hot air-blown surface, an atmospheric pressure of the hot air-blown surface is the same as that of the surface facing the hot air-blown surface, to form a wet powder layer, and subsequently blowing hot air to the wet powder layer (in the present disclosure, this approach is also referred to as “hot air circulation-type drying treatment”).

In the hot air circulation-type drying treatment as well, hot air may go through the wet powder layer. However, the hot air circulation-type drying treatment differs from the through-flow drying treatment in that the atmospheric pressure of the hot air-blown surface is the same as that of the surface (surface from which the hot air escapes) facing the hot air-blown surface.

The hot air circulation-type drying treatment can be performed, for example, by placing the wet powder on a non-air-permeable tray to form a wet powder layer, and blowing hot air to the upper face of the wet powder layer, or by placing the wet powder in a container that opens at the top and is air-permeable at the bottom and/or the side, to form a wet powder layer, and blowing hot air to the wet powder layer such that the hot air does not go through the wet powder layer or such that the hot air easily goes through the wet powder layer. In the case of using a container that opens at the top and is air-permeable at the bottom and/or the side, the hot air can be prevented from being discharged from the surface facing the hot air-blown surface, or the hot air can be adjusted to easily go through the wet powder layer such that the atmospheric pressure of the hot air-blown surface is the same as that of the surface facing the hot air-blown surface, by properly adjusting the particle size of the wet powder, the thickness of the wet powder layer in the pass-through direction of the hot air, and the wind velocity of the hot air.

For example, the wet powder may be very thinly spread in a container that opens at the top and is air-permeable at the bottom, to form a wet powder layer, and hot air can be blown to the upper face of the wet powder layer. In this case, the hot air is easily discharged from the lower face thereof without causing a pressure loss ascribable to hot air passing through the wet powder layer. Therefore, the atmospheric pressure of the hot air-blown surface becomes the same as that of the surface (surface from which the hot air escapes) facing the hot air-blown surface. In this respect, the difference between the atmospheric pressures is less than 10 Pa.

The treatment time in the hot air circulation-type drying treatment can be 120 minutes or longer, 180 minutes or longer, 240 minutes or longer, 300 minutes or longer, 360 minutes or longer, or 420 minutes or longer, and can be 1,500 minutes or shorter or 1,200 minutes or shorter. In the hot air circulation-type drying treatment, the ratio of the amount of a gas, air, or steam discharged to the amount of the gas, air, or steam circulated in a heating furnace is usually 0% by volume.

The temperature of the hot air to be blown to the wet powder is as described above as the temperature of the heat treatment. The treatment temperature (temperature of the hot air) in the hot air circulation-type drying treatment can be higher than 150 °C, 155 °C or higher, 160 °C or higher, 165 °C or higher, 170 °C or higher, 175 °C or higher, or 180 °C or higher, and can be 250 °C or lower, 235 °C or lower, 230 °C or lower, 225 °C or lower, 220 °C or lower, 215 °C or lower, 210 °C or lower, 205 °C or lower, 200 °C or lower, 195 °C or lower, 190 °C or lower, or 185 °C or lower.

The wind velocity of the hot air in the hot air circulation-type drying treatment can be 0.10 m/s or more, 0.50 m/s or more, 1.0 m/s or more, 1.5 m/s or more, 2.0 m/s or more, 2.5 m/s or more, or 3.0 m/s or more, and can be 10 m/s or less or 5.0 m/s or less.

The heat treatment can be performed in a state in which the wet powder is placed in a container that opens at the top and is air-permeable at the bottom and/or the side. The container that is air-permeable at the bottom and/or the side can be any container capable of resisting the heat treatment temperature and is preferably made of a metal such as stainless.

The container that opens at the top and is air-permeable at the bottom and/or the side is preferably a tray having air permeability at the bottom and/or the side, further preferably a tray with the bottom and/or the side prepared with a mesh (mesh tray). The mesh is preferably any of a woven wire mesh and a perforated metal sheet. When the mesh is a woven wire mesh, examples of the weave include plain weave, twill, plain Dutch weave, and twilled Dutch weave. In an alternative method, the mesh may be combined with a fabric.

The fabric may be, for example, in the form of a perforated pan liner for use in tray drying in an oven, or a continuous belt that is operated in an oven. In the case of the continuous belt, process stages are continuously carried out. Specifically, the agglomerate is continuously placed at one end of a belt passage, and a purified PTFE fine powder is continuously collected from the opposite end of the belt passage. In this context, a shallow bed of the agglomerate is continuously exposed to heated air while moving from one end to the opposite end along the passage. In any of the forms, this fabric is a direct support for the agglomerate and may be recycled in the purification of additional polymers.

This fabric may have any structure, and the structure may be, for example, knit, spunbonded, or textile which confers dimensional integrity required depending on the form of the fabric used. This fabric is prepared from yarns in the case of the knit or textile structure, and generally prepared from fibers in the case of the spunbonded structure. Depending on a case, the yarns or the fibers constituting this fabric impart openings that allow heated air to pass therethrough during the purification stages while retaining the PTFE agglomerate/fine powder particles on the fabric (i.e., not allowing the PTFE fine powder to pass through the openings), to between the yarns or the fibers constituting the fabric. The openings in this fabric must be small for the purpose of retaining the PTFE fine powder, whereas the openings must be large enough to allow the heated air and evaporated contaminants to pass therethrough at a rate sufficient for performing purification for a moderate hot air contact time.

The opening size of the mesh is preferably 2,000 μm or smaller (No. 10 mesh or more of the ASTM standards), more preferably 595 μm or smaller (No. 30 mesh or more), further preferably 297 μm or smaller (No. 50 mesh or more), still more preferably 177 μm or smaller (No. 80 mesh or more), even further preferably 149 μm or smaller (No. 100 mesh or more), particularly preferably 74 μm or smaller (No. 200 mesh or more). The opening size is preferably 25 μm or larger (No. 500 mesh or less).

When the mesh is a perforated metal sheet, the opening ratio is preferably 10% or more, more preferably 20% or more, further preferably 30% or more. The opening ratio is preferably 95% or less.

The amount of the wet powder placed is preferably 10 g/cm² or less, more preferably 8 g/cm² or less, further preferably 5 g/cm² or less, particularly preferably 3 g/cm² or less, and preferably 0.01 g/cm² or more, more preferably 0.05 g/cm² or more, further preferably 0.1 g/cm² or more.

The heat treatment using steam can be performed by blowing a high temperature of steam to the wet powder. In one embodiment, the wet powder is placed in a container that opens at the top and is air-permeable at the bottom and/or the side, and a high temperature of steam is blown to the placed wet powder.

The heat treatment using steam can be performed under ordinary pressure or increased pressure. The pressure at which the heat treatment using steam is performed can be 0.10 to 4.0 MPa. The pressure of the heat treatment to be performed under increased pressure can be higher than 0.10 MPa, and can be 0.2 MPa or lower.

The heat treatment using steam may be performed under reduced pressure. The pressure of the heat treatment to be performed under reduced pressure can be lower than 0.10 MPa or 0.09 MPa or lower, and can be 0.01 MPa or higher.

The treatment time of the heat treatment using steam can be 5 minutes or longer, 10 minutes or longer, 15 minutes or longer, 30 minutes or longer, 40 minutes or longer, 1 hour or longer, 3 hours or longer, 5 hours or longer, or 7 hours or longer, and can be 10 hours or shorter, 8 hours or shorter, 6 hours or shorter or 4 hours or shorter.

The temperature of the steam to be blown to the wet powder is as described above as the temperature of the heat treatment. The treatment temperature (temperature of the steam) in the heat treatment using steam can be 100 °C or higher, 120 °C or higher, 140 °C or higher, 160 or more, or 170 °C or higher, and can be 350 °C or lower, 300 °C or lower, 250 °C or lower, 230 °C or lower, 210 °C or lower, 205 °C or lower, 200 °C or lower, 195 °C or lower, 190 °C or lower, or 185 °C or lower.

The amount of heated steam generated in the heat treatment using steam can be 1 kg/h or more, 3 kg/h or more, 5 kg/h or more, or 10 kg/h or more, and can be 500 kg/h or less, 300 kg/h or less, 100 kg/h or less, 50 kg/h or less, or 30 kg/h or less.

The heat treatment can be performed using an electric furnace or a steam furnace. The heat treatment can be performed using, for example, an electric furnace such as a parallel-flow box electric furnace, an airflow box electric furnace, an airflow conveyor electric furnace, a tunnel electric furnace, a band electric furnace, a turbo vertical electric furnace, a radiation-type conveyor electric furnace, a fluidized-bed electric furnace, a rotary airflow electric furnace, a paddle stirring electric furnace, a multi-plate electric furnace, a vacuum electric furnace, a cylindrical electric furnace, a vibrating electric furnace, a freezing electric furnace, a drum electric furnace, a paddle electric furnace, an inverted cone-shaped electric furnace, an extrusion electric furnace, a steam-heated tube bundle rotary electric furnace, an infrared electric furnace, a superheated steam electric furnace, a high-frequency electric furnace, a microwave electric furnace, a stirring-type electric furnace, an airflow electric furnace, or a hot air circulation-type electric furnace, or a steam furnace corresponding thereto (apparatus in which the electric furnace in the apparatus name of each of the electric furnaces reinterpreted as a steam furnace).

The wet powder is also preferably dried by heat treatment. For example, in the case of heating the wet powder in the presence of steam under ordinary pressure or increased pressure, the wet powder may usually not be sufficiently dried. Therefore, the heat-treated wet powder is preferably dried to obtain a non melt-processible PTFE powder.

The heat treatment, or the heat treatment and drying of the wet powder can usually produce a non melt-processible PTFE powder having a content of moisture of 0.01% by mass or less or 0.005% by mass or less based on the wet powder.

After the wet powder is heat-treated, the heat-treated non melt-processible PTFE powder may be cleaned again. Examples of the cleaning method include the same methods as the cleaning methods for the wet powder mentioned above.

### 2. Non Melt-Processible PTFE Powder

Non melt-processible PTFE that has a reduced content of a fluorine-containing compound having a hydrophilic group and can be subjected to extrusion forming at a low extrusion pressure and a stable extrusion pressure can be produced by using the production method of the present disclosure. The present disclosure also relates to a non melt-processible PTFE powder, wherein the melt-fabricable PTFE powder contains a fluorine-containing compound having a hydrophilic group at a reduced content and has a low extrusion pressure measured at a reduction ratio of 100.

### (Extrusion Pressure)

The extrusion pressure at a reduction ratio (RR) of 100 of the non melt-processible PTFE powder can be 5 MPa or higher, 10 MPa or higher, or 12 MPa or higher.

The extrusion pressure at RR of 100 can be 50 MPa or lower, 40 MPa or lower, 30 MPa or lower, 25 MPa or lower, 23 MPa or lower, 21 MPa or lower, or 20 MPa or lower, from the viewpoint of improving processability.

In the present disclosure, a non melt-processible PTFE powder, the extrusion pressure of which cannot be measured, for example, because the pressure does not reach equilibrium in measuring the extrusion pressure, is regarded as a non melt-processible PTFE powder having no extrusion pressure within the above range.

The extrusion pressure at RR of 1,600 of the non melt-processible PTFE powder can be 20 MPa or higher, 25 MPa or higher, or 30 MPa or higher.

The extrusion pressure at RR of 1,600 can be 80 MPa or lower, 70 MPa or lower, 60 MPa or lower, or 50 MPa or lower, from the viewpoint of improving processability.

The extrusion pressure at RR of 100 is measured by the following method.

50 g of the non melt-processible PTFE powder is mixed with 10.25 g of hydrocarbon oil (trade name: Isopar-G, manufactured by Exxon Mobil Corp.) as an extrusion aid for 3 minutes in a polyethylene container. A cylinder of an extruder is packed with the mixture at room temperature (25±2 °C), and a load of 0.47 MPa is applied to a piston inserted to the cylinder, and held for 1 minute. Next, the mixture is extruded from an orifice at a ram speed of 18 mm/min. The ratio of the cross-sectional area of the cylinder to the cross-sectional area of the orifice is 100. A load (N) at which the pressure reaches equilibrium in the latter half of the extrusion operation is divided by the cross-sectional area of the cylinder, and the resulting value is regarded as the extrusion pressure (MPa).

The extrusion pressure at RR of 1,600 is measured by the following method.

50 g of the non melt-processible PTFE powder is mixed with 10.25 g of hydrocarbon oil (trade name: Isopar-G, manufactured by Exxon Mobil Corp.) as an extrusion aid for 3 minutes in a polyethylene container. A cylinder of an extruder is packed with the mixture at room temperature (25±2 °C), and a load of 1.2 MPa is applied to a piston inserted to the cylinder, and held for 1 minute. Next, the mixture is extruded from an orifice at a ram speed of 18 mm/min. The ratio of the cross-sectional area of the cylinder to the cross-sectional area of the orifice is 1,600. A load (N) at which the pressure reaches equilibrium in the latter half of the extrusion operation is divided by the cross-sectional area of the cylinder, and the resulting value is regarded as the extrusion pressure (MPa).

In one embodiment, the extrusion pressure of the non melt-processible PTFE powder rarely increases or does not increase even if extrusion forming is repeated using the same extruder. For example, in the case of repeating forming to obtain a 5 m long bead a plurality of times by paste extrusion forming of the non melt-processible PTFE powder using a thoroughly cleaned extruder equipped with a die for extrusion forming, the rate of increase in paste extrusion pressure in the fourth run of forming based on the paste extrusion pressure in the first run of forming can fall within 3.0% or less. The rate of increase in paste extrusion pressure is preferably 2.5% or less, more preferably 2.0% or less.

The paste extrusion pressure is an extrusion pressure at a reduction ratio of 100 when a mixture is prepared by the addition of 20.5 g parts by mass of hydrocarbon oil (trade name: Isopar-G®, manufactured by Exxon Mobil Corp.) per 100 parts by mass of the non melt-processible PTFE powder and extruded at 25 °C using an extruder. The rate of increase in paste extrusion pressure can be determined as the ratio of the difference between the paste extrusion pressure in the fourth run of forming and the paste extrusion pressure in the first run of forming to the paste extrusion pressure in the first run of forming.

In one embodiment, the non melt-processible PTFE powder exhibits a small coefficient of extrusion pressure fluctuation. The coefficient of extrusion pressure fluctuation is an index that indicates the extrusion stability of the non melt-processible PTFE powder processed by paste extrusion. The coefficient of fluctuation can be indicated, in paste extrusion pressure measurement, by
the difference between the largest value and the smallest value of the paste extrusion pressure in the latter half of the extrusion operation,
the ratio of the difference between the largest value and the smallest value to an average paste extrusion pressure value in the latter half of the extrusion operation,
a variance or standard deviation of the paste extrusion pressure in the latter half of the extrusion operation, the ratio of the standard deviation to the average paste extrusion pressure value in the latter half of the extrusion operation,
the difference between the largest value and the smallest value of the extrusion pressure in equilibrium in the latter half of the extrusion operation,
the ratio of the difference between the largest value and the smallest value to an average paste extrusion pressure value in equilibrium in the latter half of the extrusion operation, a variance or standard deviation of the paste extrusion pressure in equilibrium in the latter half of the extrusion operation, or
the ratio of the standard deviation to the average paste extrusion pressure value in equilibrium in the latter half of the extrusion operation.

The coefficient of extrusion pressure fluctuation at RR of 100 of the non melt-processible PTFE powder can be 0.20 or less, 0.15 or less, 0.10 or less, 0.050 or less, or 0.030 or less.

The coefficient of paste extrusion pressure fluctuation is measured by the following method.

In the extrusion pressure measurement at RR of 100, the extrusion pressure of paste extrusion is measured in the latter half of the extrusion operation, and the coefficient of extrusion pressure fluctuation at RR of 100 is determined from an average extrusion pressure value and standard deviation.

(Coefficient of extrusion pressure fluctuation at RR of 100)=(Standard deviation of the extrusion pressure at RR of 100)/(Average extrusion pressure value at RR of 100)

The coefficient of extrusion pressure fluctuation at RR of 1,600 of the non melt-processible PTFE powder can be 0.10 or less, 0.050 or less, 0.030 or less, or 0.020 or less.

The coefficient of paste extrusion pressure fluctuation is measured by the following method.

In the extrusion pressure measurement at RR of 1,600, the extrusion pressure of paste extrusion is measured in the latter half of the extrusion operation, and the coefficient of extrusion pressure fluctuation at RR of 1,600 is determined from an average extrusion pressure value and standard deviation.

(Coefficient of extrusion pressure fluctuation at RR of 1,600)=(Standard deviation of the extrusion pressure at RR of 1,600)/(Average extrusion pressure value at RR of 1,600)

The non melt-processible PTFE powder can be suitably used as a molding material that is used for obtaining a formed article by extrusion forming, particularly, a molding material that is used for obtaining a formed article by paste extrusion forming.

### (Fluorine-Containing Compound Having Hydrophilic Group)

The content of the fluorine-containing compound having a hydrophilic group in the non melt-processible PTFE powder can be more than 0 ppb by mass and less than 100 ppb by mass based on the non melt-processible PTFE powder. The content of the fluorine-containing compound having a hydrophilic group in the non melt-processible PTFE powder can be 90 ppb by mass or less, 80 ppb by mass or less, 70 ppb by mass or less, 60 ppb by mass or less, 50 ppb by mass or less, 25 ppb by mass or less, 20 ppb by mass or less, 10 ppb by mass or less, 5 ppb by mass or less, 3 ppb by mass or less or 1 ppb by mass or less, and can be more than 0 ppb by mass. The content of the fluorine-containing compound having a hydrophilic group is most preferably less than the detection limit in measurement by liquid chromatography-mass spectrometry (LC/MS).

The hydrophilic group can be an anionic group and can be an acid group or an acid salt group. Examples of the hydrophilic group include —NH₂, —PO₃M, —OPO₃M, —SO₃M, —OSO₃M, —COOM, wherein M is H, a metal atom, NR^{7y}₄, imidazolium optionally having a substituent, pyridinium optionally having a substituent, or phosphonium optionally having a substituent, wherein R^{7y} is H or an organic group, and the moieties may be the same or different; and any two of the moieties may be bonded to each other to form a ring. Among them, the hydrophilic group is preferably —PO₃M, —OPO₃M, —SO₃M, —OSO₃M or —COOM, more preferably —SO₃M or —COOM, further preferably —COOM. The organic group for R^{7y} is preferably an alkyl group. R^{7y} is preferably H or a C₁₋₁₀ organic group, more preferably H or a C₁₋₄ organic group, further preferably H or a C₁₋₄ alkyl group.

Examples of the metal atom include monovalent and divalent metal atoms and include alkali metals of group 1 and alkaline earth metals of group 2, with Na, K, or Li being preferable.

Examples of the fluorine-containing compound having a hydrophilic group include those mentioned above as fluorine-containing surfactants. A typical compound as the fluorine-containing surfactant is a fluorine-containing surfactant having a molecular weight of 1,000 g/mol or less, preferably 800 g/mol or less.

In one embodiment, the non melt-processible PTFE powder is substantially free of a compound represented by the following general formula (1) as the fluorine-containing compound having a hydrophilic group:

[X—Rf-A⁻]ᵢMⁱ⁺ general formula (1):

wherein X represents H, Cl, Br, F, or I, Rf represents a linear or branched partially fluorinated or completely fluorinated aliphatic group, or a linear or branched partially fluorinated or completely fluorinated aliphatic group interrupted by at least one oxygen atom, A⁻ represents an acid group, Mⁱ⁺ represents a cation having valence i, and i represents an integer of 1 to 3.

In one embodiment, the non melt-processible PTFE powder is substantially free of a compound represented by the following general formula (2) as the fluorine-containing compound having a hydrophilic group:

[Cₙ₋₁F₂ₙ₋₁COO⁻]M⁺ general formula (2):

wherein n represents an integer of 9 to 14, and M⁺ represents a cation.

The compound represented by the general formula (2) (perfluoroalkanoic acid) is known to be formed during polymerization using a modifying monomer such as perfluoroalkyl vinyl ether (see International Publication No. WO 2019/161153).

In one embodiment, the non melt-processible PTFE powder is substantially free of a compound represented by the following general formula (3) as the fluorine-containing compound having a hydrophilic group:

[R¹—O-L-CO₂-]M⁺ general formula (3):

wherein R¹ represents a linear or branched partially fluorinated or completely fluorinated aliphatic group, or a linear or branched partially fluorinated or completely fluorinated aliphatic group interrupted by at least one oxygen atom, L represents a linear or branched non-fluorinated, partially fluorinated, or completely fluorinated alkylene group, and M⁺ represents a cation.

In one embodiment, the non melt-processible PTFE powder is substantially free of a compound represented by the following general formula (4) as the fluorine-containing compound having a hydrophilic group:

[H—(CF₂)ₘ₋₁CO₂⁻]M⁺ general formula (4):

wherein m represents an integer of 4 to 20, and M⁺ represents a cation.

In the present disclosure, the phrase “substantially free” of any of the compounds represented by the general formulas (1) to (4) means that the content of any of the compounds represented by the general formulas (1) to (4) in the non melt-processible PTFE powder is less than 100 ppb by mass. The content of any of the compounds represented by the general formulas (1) to (4) in the fluoropolymer can be 90 ppb by mass or less, 80 ppb by mass or less, 70 ppb by mass or less, 60 ppb by mass or less, 50 ppb by mass or less, 25 ppb by mass or less, 10 ppb by mass or less, 5 ppb by mass or less, or 1 ppb by mass or less, and can be more than 0 ppb by mass. The content described above is most preferably less than the detection limit in measurement by liquid chromatography-mass spectrometry (LC/MS).

In one embodiment, the non melt-processible PTFE powder comprises any of compounds represented by the following general formula (4), wherein a content of one or more of the compounds represented by the general formula (4) is less than 100 ppb by mass based on the non melt-processible PTFE powder:

[H—(CF₂)ₘ₋₁CO₂⁻]M⁺ general formula (4):

wherein m represents an integer of 4 to 20, and M⁺ represents a cation.

The content of one or more of the compounds represented by the general formula (4) can be 90 ppb by mass or less, 80 ppb by mass or less, 70 ppb by mass or less, 60 ppb by mass or less, 50 ppb by mass or less, 25 ppb by mass or less, 10 ppb by mass or less, 5 ppb by mass or less, or 1 ppb by mass or less, and can be more than 0 ppb by mass, based on the non melt-processible PTFE powder. The content described above is most preferably less than the detection limit in measurement by liquid chromatography-mass spectrometry (LC/MS).

In one embodiment, the non melt-processible PTFE powder comprises any of compounds represented by the following general formula (4), wherein a total content of the compounds represented by the general formula (4) is less than 100 ppb by mass based on the non melt-processible PTFE powder:

[H—(CF₂)ₘ₋₁CO₂⁻]M⁺ general formula (4):

wherein m represents an integer of 4 to 20, and M⁺ represents a cation.

The total content of the compounds represented by the general formula (4) can be 90 ppb by mass or less, 80 ppb by mass or less, 70 ppb by mass or less, 60 ppb by mass or less, 50 ppb by mass or less, 25 ppb by mass or less, 10 ppb by mass or less, 5 ppb by mass or less, or 1 ppb by mass or less, and can be more than 0 ppb by mass, based on the non melt-processible PTFE powder. The content described above is most preferably less than the detection limit in measurement by liquid chromatography-mass spectrometry (LC/MS).

In one embodiment, the non melt-processible PTFE powder comprises compounds represented by the following general formula (5), wherein a total content of the compounds represented by the general formula (5) is less than 100 ppb by mass based on the non melt-processible PTFE powder:

[H—(CF₂)ₘ₋₁CO₂⁻]M⁺ general formula (5):

wherein m represents 12 or 14, and M⁺ represents a cation.

The total content of the compounds represented by the general formula (5) can be 90 ppb by mass or less, 80 ppb by mass or less, 70 ppb by mass or less, 60 ppb by mass or less, 50 ppb by mass or less, 25 ppb by mass or less, 10 ppb by mass or less, 5 ppb by mass or less, or 1 ppb by mass or less, and can be more than 0 ppb by mass, based on the non melt-processible PTFE powder. The content described above is most preferably less than the detection limit in measurement by liquid chromatography-mass spectrometry (LC/MS).

The content of the fluorine-containing compound having a hydrophilic group in the non melt-processible PTFE powder can be quantified by a known method. The content can be quantified by, for example, LC/MS analysis.

First, methanol is added to the non melt-processible PTFE powder for extraction, and the obtained extract is analyzed by LC/MS. Treatment by Soxhlet extraction, ultrasonic treatment, or the like may be further performed in order to enhance extraction efficiency.

The obtained extract is appropriately concentrated by nitrogen purge, and the fluorine-containing compound having a hydrophilic group in the extract thus concentrated is measured by LC/MS.

Molecular weight information is distilled from the obtained LC/MS spectra and confirmed to be consistent with the structural formula of a candidate fluorine-containing compound having a hydrophilic group.

Then, aqueous solutions having five or more levels of contents of the confirmed fluorine-containing compound having a hydrophilic group are prepared, and the aqueous solution with each content is analyzed by LC/MS. The relationship between the contents and areas for the contents is plotted to draw a calibration curve.

Then, the area in the LC/MS chromatogram of the fluorine-containing compound having a hydrophilic group in the extract can be converted to the content of the fluorine-containing compound having a hydrophilic group using the calibration curve.

Since the obtained extract can be concentrated by nitrogen purge, the lower limit of quantification of the measurement method can be decreased.

### (Configuration of Polymer)

The non melt-processible PTFE powder can be a so-called “fine powder”.

The non melt-processability means properties in which a melt flow rate cannot be measured at a temperature higher than a crystal melting point in accordance with ASTM D 1238 and D 2116.

The non melt-processible PTFE powder is usually fibrillatable. The presence or absence of fibrillatability can be determined by “paste extrusion”, a typical forming method for a “high-molecular-weight PTFE powder” which is a powder prepared from a polymer of TFE. Usually, high-molecular-weight PTFE can be paste-extruded because of being fibrillatable. If unsintered formed matter obtained by paste extrusion has no substantial strength or elongation, for example, if the formed matter is broken by pulling at an elongation of 0%, this powder can be regarded as having no fibrillatability.

The standard specific gravity (SSG) of the non melt-processible PTFE powder is preferably 2.130 to 2.280. The standard specific gravity is measured by a water displacement method that abides by ASTM D 792 using a sample formed in accordance with ASTM D 4895-89.

The peak temperature of the non melt-processible PTFE powder is preferably 333 to 347 °C, more preferably 335 to 345 °C. The peak temperature can be identified as a temperature corresponding to a local maximum that appears in a differential thermal analysis (DTA) curve obtained by using TG/DTA (thermogravimetry/differential thermal analyzer) and heating PTFE having no history of heating to a temperature of 300 °C or higher under a condition of 10 °C/min.

The thermal instability index (TII) of the non melt-processible PTFE powder is preferably 10 or more, more preferably 20 or more, further preferably 30 or more, particularly preferably 35 or more, and preferably 60 or less. The thermal instability index (TII) of the non melt-processible PTFE powder can be adjusted to within the above range, for example, by producing PTFE using a hydrocarbon surfactant. The thermal instability index (TII) can be measured in accordance with ASTM D 4895-89.

The average particle size (average secondary particle size) of the non melt-processible PTFE powder is preferably 100 to 2,000 μm. The lower limit of the average secondary particle size is more preferably 200 μm or larger, further preferably 300 μm or larger. The upper limit of the average secondary particle size is preferably 1,000 μm or smaller, further preferably 800 μm or smaller, particularly preferably 700 μm or smaller. The average particle size is an average particle size (50% cumulative particle size) d50 based on a mass, and can be determined by measurement in accordance with JIS K6891.

The non melt-processible PTFE powder is preferred for forming. Examples of suitable applications include tubes of aircraft and automobile hydraulic systems and fuel systems and include chemical solutions, flexible hoses for steam, and electric wire coating applications. The non melt-processible PTFE powder may be used as binders for batteries or in dustproof applications. A stretched body can also be produced from the PTFE powder.

Although the embodiments are described above, it should be understood that various changes or modifications can be made in the mode or the details without departing from the gist or the scope of claims.

<1> The first aspect of the present disclosure provides
a method for producing a non melt-processible polytetrafluoroethylene powder, the production method comprising:
polymerizing tetrafluoroethylene in the presence of an aqueous medium and a hydrocarbon surfactant to obtain an aqueous dispersion containing non melt-processible polytetrafluoroethylene;
coagulating the non melt-processible polytetrafluoroethylene in the aqueous dispersion to obtain a wet powder;
cleaning the wet powder; and
heat-treating the wet powder to obtain a non melt-processible polytetrafluoroethylene powder.

<2> The second aspect of the present disclosure provides
the production method according to the first aspect, wherein the non melt-processible polytetrafluoroethylene is coagulated using at least one coagulation method selected from the group consisting of a coagulation method by stirring, a ultrasonic coagulation method, a coagulation method using ultrafine bubble, a coagulation method using an alkali, a coagulation method using an acid, a coagulation method using an oxidizing agent, a coagulation method using an organic solvent, and a coagulation method using a radical generator.

<3> The third aspect of the present disclosure provides
the production method according to the first or second aspect, wherein the wet powder is cleaned using at least one cleaning method selected from the group consisting of a cleaning method by stirring, an ultrasonic cleaning method, a cleaning method using ultrafine bubble, a cleaning method using an alkali, a cleaning method using an acid, and a cleaning method using a radical generator.

<4> The fourth aspect of the present disclosure provides
the production method according to any of the first to third aspects, wherein a temperature of the heat treatment is 10 to 280 °C.

<5> The fifth aspect of the present disclosure provides
the production method according to any of the first to fourth aspects, wherein the heat treatment is performed by bringing hot air into contact with the wet powder.

<6> The sixth aspect of the present disclosure provides
the production method according to the fifth aspect, wherein a wind velocity of the hot air is 0.01 to 10 m/s.

<7> The seventh aspect of the present disclosure provides
the production method according to any of the first to fourth aspects, wherein the heat treatment is performed by heating the wet powder in the presence of steam.

<8> The eighth aspect of the present disclosure provides
the production method according to the seventh aspect, wherein after the wet powder is heated in the presence of steam, the wet powder is dried.

<9> The nineth aspect of the present disclosure provides
the production method according to any of the first to fourth aspects, wherein
the wet powder is obtained by coagulating the non melt-processible polytetrafluoroethylene in the aqueous dispersion using at least one coagulation method selected from the group consisting of a coagulation method by stirring, an ultrasonic coagulation method, and a coagulation method using an acid;
the wet powder is cleaned using at least one cleaning method selected from the group consisting of a cleaning method by stirring and an ultrasonic cleaning method; and
the wet powder is heat-treated by bringing hot air of 160 °C or higher into contact with the wet powder at a wind velocity of 0.40 m/s or more for 30 minutes or longer, or by heating the wet powder in the presence of steam of 160 °C or higher for 200 minutes or longer
to obtain the non melt-processible polytetrafluoroethylene powder.

<10> The tenth aspect of the present disclosure provides
the production method according to any of the first to fourth and nineth aspects, wherein
the wet powder is heat-treated by placing the cleaned wet powder such that, when hot air goes through a hot air-blown surface into a surface facing the hot air-blown surface, an atmospheric pressure of the hot air-blown surface is higher than that of the surface facing the hot air-blown surface, to form a wet powder layer, and subsequently blowing hot air of 195 °C or higher to the wet powder layer at a wind velocity of 0.50 m/s or more so that the hot air is introduced into the wet powder layer from the hot air-blown surface and discharged from the surface facing the hot air-blown surface to bring the wet powder into contact with the hot air for 30 to 200 minutes.

<11> The eleventh aspect of the present disclosure provides
the production method according to any of the first to fourth and nineth aspects, wherein
the wet powder is heat-treated by placing the cleaned wet powder such that, when hot air is blown to a surface, the hot air is not discharged from a surface facing the hot air-blown surface, or such that, when hot air goes through a hot air-blown surface into a surface facing the hot air-blown surface, an atmospheric pressure of the hot air-blown surface is the same as that of the surface facing the hot air-blown surface, to form a wet powder layer, and subsequently blowing hot air of 170 to 190 °C to the wet powder layer at a wind velocity of 2.0 to 5.0 m/s to bring the wet powder into contact with the hot air for 420 to 1,500 minutes.

<12> The twelfth aspect of the present disclosure provides
a non melt-processible polytetrafluoroethylene powder comprising any of compounds represented by the following general formula (4), wherein a content of one or more of the compounds is less than 100 ppb by mass based on the non melt-processible polytetrafluoroethylene powder, and an extrusion pressure measured at a reduction ratio of 100 is 25 MPa or lower:

[H—(CF₂)ₘ₋₁CO₂⁻]M⁺ general formula (4):

wherein m represents an integer of 4 to 20, and M⁺ represents a cation.

### EXAMPLES

Next, the embodiments of the present disclosure will be described with reference to Examples. However, the present disclosure is not limited by these Examples.

Each numeric value in Examples was measured by the following method.

### <Polymer Solid Concentration>

1 g of a PTFE aqueous dispersion was dried under conditions of 150 °C for 60 minutes in an air dryer, and the value of the ratio of the mass of a heated residue to the mass (1 g) of the aqueous dispersion was expressed as a percentage and adopted.

### <Average Primary Particle Size>

A PTFE aqueous dispersion was diluted into a solid concentration of 0.15% by mass with water, and a calibration curve was prepared by measuring the transmission of projected light at 550 nm per unit length of the obtained diluted latex, and the number-based length-average primary particle size determined by particle size measurement in a fixed direction on a transmission electron photomicrogaph. The average primary particle size was determined from an actually measured transmission of projected light at 550 nm of each sample using this calibration curve.

### <Content of Moisture in PTFE Powder>

The content of moisture is calculated according to the expression given below by heating approximately 20 g of a PTFE powder at 150 °C for 2 hours and measuring its mass before and after the heating. The powder was sampled three times, and the content of moisture in each sample was calculated. Then, an average was determined, and this average value was adopted as the numeric value of the content of moisture in the PTFE powder.

Content of moisture (% by mass)=[(Mass (g) of the PTFE powder before the heating)−(Mass(g) of the PTFE powder after the heating)]/(Mass(g) of the PTFE powder before the heating)×100

<Content Measurement of Compound Represented by General formula (4): [H—(CF₂)ₘ₋₁CO₂⁻]M⁺>

The content was measured using liquid chromatography-mass spectrometry under the following conditions.

Extraction from PTFE Powder

10 g (12.6 mL) of methanol was added to 1 g of a PTFE powder, and the mixture was subjected to ultrasonic treatment for 60 minutes to extract a supernatant containing the compound represented by the general formula (4). The obtained extract was appropriately concentrated by nitrogen purge to obtain a concentrated extract.

### Content Measurement of Compound Represented by General Formula (4) Contained in Extract

The content of the compound represented by the general formula (4) contained in the extract was determined on the basis of perfluorooctanoic acid.

### Calibration Curve of Perfluorooctanoic Acid

Five levels of standard solutions of perfluorooctanoic acid in methanol were prepared with known concentrations from 1 ng/mL to 100 ng/mL and measured using a liquid chromatograph-mass spectrometer (Waters Inc., LC-MS ACQUITY UPLC/TQD). a and b were determined according to the following relational expression (1) using first-order approximation from each sample concentration and a peak integral.

A=a×X+b (1)
A: Peak area of perfluorooctanoic acid
X: Concentration (ng/mL) of perfluorooctanoic acid

### Measurement Equipment Configuration and LC-MS Measurement Conditions

TABLE 1
LC section

| Apparatus | Acquity UPLC manufactured by Waters Inc. | | |
|---|---|---|---|
| Column | Acquity UPLC BEH C18 1.7 μm (2.1 × 50 mm) | | |
| | manufactured by Waters Inc. | | |
| Mobile phase | A CH₃CN | | |
| | B 20 mM CH₃COONH₄/H₂O | | |
| | 0→1.5 | min | A:B = 10:90 |
| | 1.5→8.5 | min | A:B = 10:90 → A:B = 90:10 Linear gradient |
| | 8.5→10 | min | A:B = 90:10 |
| Flow rate | 0.4 | mL/min | |

| | |
|---|---|
| Column temperature | 40 °C |
| Sample injection volume | 5 μL |

MS section

| | |
|---|---|
| Apparatus | TQ Detecter |
| Measurement mode | MRM(Multiple Reaction Monitoring) |
| Ionization method | Electrospray ionization |
| | Negative mode |

### MRM Measurement Parameter

TABLE 2

| Compound | Precursor | Product |
|---|---|---|
| Perfluorooctanoic acid | 413 | 369 |

### Contents of Compounds of General Formula (4) Having 4 or More and 20 or Less Carbon Atoms

The compounds of the general formula (4) having 4 or more and 20 or less carbon atoms were measured using a liquid chromatograph-mass spectrometer. The peak area of the compound of the general formula (4) having each number of carbon atoms was determined using MRM as to an extracted liquid phase.

### MRM Measurement Parameter

TABLE 3

| Compound name | [symbol] ber of carb [symbol] | Precursor | Product |
|---|---|---|---|
| (H—(CF₂)₃—COO)M | 4 | 195 | 131 |
| (H—(CF₂)₄—COO)M | 5 | 245 | 181 |
| (H—(CF₂)₅—COO)M | 6 | 295 | 231 |
| (H—(CF₂)₆—COO)M | 7 | 345 | 281 |
| (H—(CF₂)₇—COO)M | 8 | 395 | 331 |
| (H—(CF₂)₈—COO)M | 9 | 445 | 381 |
| (H—(CF₂)₉—COO)M | 10 | 495 | 431 |
| (H—(CF₂)₁₀—COO)M | 11 | 545 | 481 |
| (H—(CF₂)₁₁—COO)M | 12 | 395 | 531 |
| (H—(CF₂)₁₂—COO)M | 13 | 645 | 581 |
| (H—(CF₂)₁₃—COO)M | 14 | 695 | 631 |
| (H—(CF₂)₁₄—COO)M | 15 | 745 | 681 |
| (H—(CF₂)₁₅—COO)M | 16 | 795 | 731 |
| (H—(CF₂)₁₆—COO)M | 17 | 845 | 781 |
| (H—(CF₂)₁₇—COO)M | 18 | 895 | 831 |
| (H—(CF₂)₁₈—COO)M | 19 | 945 | 881 |
| (H—(CF₂)₁₉—COO)M | 20 | 995 | 931 |

[symbol]

indicates data missing or illegible when filed

The content of the compound of the general formula (4) having number m of carbon atoms in the extract was calculated according to the expression (3) given below. a and b in the expression (3) were determined according to the expression (1)

XCm=((ACm−b)/a)×((50×(m−1)+45)/413) (3)
XCm: Content (ng/mL) of the compound of the general formula (4) having number m of carbon atoms in the extracted solution
ACm: Peak area of the compound of the general formula (4) having number m of carbon atoms in the extracted solution

The quantification limit in this measurement is 1 ng/mL.

### Content of Compound of General Formula (4) Having Number m of Carbon Atoms in PTFE Powder

The content of the compound of the general formula (4) having number m of carbon atoms in the PTFE powder was determined according to the following expression (4).

YCm=XCm×12.6 (4)
YCm: Content (ppb vs. PTFE) of the compound of the general formula (4) having number m of carbon atoms in the PTFE powder

The lower limit of quantification is 10 ppb by mass.

### <Paste Extrusion Forming Conditions>

An extruder (reduction ratio: 100) was thoroughly cleaned. 50 g of a non melt-processible PTFE powder was mixed with 10.25 g of hydrocarbon oil (trade name: Isopar-G, manufactured by Exxon Mobil Corp.) as an extrusion aid for 3 minutes in a polyethylene container. A cylinder of an extruder was packed with the mixture at room temperature (25±2 °C), and a load of 0.47 MPa was applied to a piston inserted to the cylinder, and held for 1 minute. Next, the mixture was extruded from an orifice at a ram speed of 18 mm/min. The ratio of the cross-sectional area of the cylinder to the cross-sectional area of the orifice was 100. A load (N) at which the pressure reached equilibrium in the latter half of the extrusion operation was divided by the cross-sectional area of the cylinder, and the resulting value was regarded as the extrusion pressure (MPa).

### <Coefficient of Extrusion Pressure Fluctuation at RR of 100>

In the extrusion pressure measurement at RR of 100, the extrusion pressure of paste extrusion was measured in the latter half of the extrusion operation, and the coefficient of extrusion pressure fluctuation at RR of 100 was determined from an average extrusion pressure value and standard deviation.

(Coefficient of extrusion pressure fluctuation at RR of 100)=(Standard deviation of the extrusion pressure at RR of 100)/(Average extrusion pressure value at RR of 100)

### Preparation Example 1

10 g of lauric acid was added to 100 g of deionized water and stirred, and 25 g of a 10% ammonia aqueous solution was gradually added thereto to obtain an aqueous solution B.

### Production Example 1

To an SUS reactor having an internal volume of 6 L, 3560 g of deionized degassed water, 180 g of paraffin wax, and 0.180 g of lauric acid were added. The reactor was hermetically sealed, and the system was purged with nitrogen to remove oxygen. The reactor was heated to 85 °C, and 3.9 g of HFP was added thereto. The reactor was further packed with TFE and adjusted to 0.78 MPa. The reactor was charged with an aqueous solution containing 0.61 g of ammonium persulfate (APS) dissolved in 20 g of water, as a polymerization initiator. TFE was added such that the reaction pressure was kept constant at 0.78 MPa.

Stirring was terminated when 145 g of TFE was added. The reactor was depressurized until reaching barometric pressure. Then, TFE was supplied until the pressure of the reactor became 0.78 MPaG. Stirring was restarted, and reaction was subsequently performed. At the same time therewith, the aqueous solution B was continuously added to the reactor.

When TFE consumed in the reaction reached approximately 650 g, the reaction was completed by stopping TFE supply and terminating stirring. Then, gases were discharged until the internal pressure of the reactor became ordinary pressure. An aqueous dispersion was taken out of the reactor and cooled, followed by the separation of the paraffin wax.

The obtained PTFE aqueous dispersion had a solid content of 15.2% by mass and an average primary particle size of 190 nm.

### Production Example 2

To an SUS reactor having an internal volume of 3 L, 1780 g of deionized degassed water, 90 g of paraffin wax, and 0.27 g of sodium laurate were added. The reactor was hermetically sealed, and the system was purged with nitrogen to remove oxygen. The reactor was heated to 85 °C, and 2.2 g of HFP was added thereto. The reactor was further packed with TFE and adjusted to 2.7 MPaG. The reactor was charged with an aqueous solution containing 0.31 g of ammonium persulfate (APS) dissolved in 20 g of water, as a polymerization initiator. TFE was added such that the reaction pressure was kept constant at 2.7 MPaG.

Stirring was terminated when 50 g of TFE was added. The reactor was depressurized until reaching barometric pressure. Then, TFE was supplied until the pressure of the reactor became 2.7 MPaG. Stirring was restarted, and reaction was subsequently performed. At the same time therewith, the aqueous solution B was continuously added to the reactor.

When TFE consumed in the reaction reached approximately 770 g, the reaction was completed by stopping TFE supply and terminating stirring. Then, gases were discharged until the internal pressure of the reactor became ordinary pressure. An aqueous dispersion was taken out of the reactor and cooled, followed by the separation of the paraffin wax. 25 g of the aqueous solution B was added up to the completion of the reaction.

The obtained PTFE aqueous dispersion had a solid content of 29.6% by mass and an average primary particle size of 214 nm.

### Reference Example 1

To the PTFE aqueous dispersion obtained in Production Example 1, deionized water was added to prepare 2.5 L of a PTFE dispersion with a specific gravity (25 °C) adjusted to 1.080. To a coagulation vessel (internal volume: 6 L) equipped with an anchor-type stirring blade and a baffle, 2.5 L of the PTFE aqueous dispersion was added, and the temperature was adjusted such that the internal temperature was 25 °C. 16 g of nitric acid (10%) was added thereto, and stirring was started at a stirring speed of 500 rpm. After the start of stirring, the aqueous dispersion was confirmed to form a wet PTFE powder through a slurry state, and the stirring was further continued for 1 minute.

Subsequently, the wet PTFE powder was collected by filtration, and a coagulation vessel was charged with the wet PTFE powder and 2.5 L of deionized water and adjusted to 25 °C. The operation of cleaning the polymer powder at a stirring speed of 500 rpm was repeated twice. The wet PTFE powder thus cleaned was collected by filtration to obtain a wet PTFE powder. The obtained wet PTFE powder was placed (amount of the powder placed: 2.0 g/cm²) in a plate tray (tray non-air-permeable at the bottom and the side), and left standing for drying for 18 hours in a hot air circulation-type dryer (wind velocity: 1.0 m/s) of 180 °C to obtain a PTFE powder. In this respect, the proportion of the amount of the hot air discharged from the dryer was set to 25% by volume.

In Reference Example 1, hot air was blown to the PTFE powder on the plate tray. Therefore, a hot air-blown surface was formed in a layer of the wet powder placed on the plate tray, whereas no surface from which the hot air escaped was formed. Thus, the heat treatment method according to Reference Example 1 is hot air circulation-type drying treatment.

The contents of compounds of the general formula (4) in the obtained PTFE powder were measured. The results are shown in Table 4.

### Reference Example 2

A wet PTFE powder was obtained in the same manner as in Reference Example 1 except that the PTFE aqueous dispersion obtained in Production Example 1 was changed to the PTFE aqueous dispersion obtained in Production Example 2. The obtained wet PTFE powder had a moisture content of approximately 60% by mass. The obtained wet PTFE powder was placed (amount of the powder placed: 0.5 g/cm²) in a metal mesh tray (No. 60 mesh; container that opened at the top and was air-permeable at the bottom without being air-permeable at the side), and heat-treated at 200 °C for 80 minutes in a hot air circulation-type dryer (wind velocity: 1.0 m/s) to obtain a PTFE powder. In this respect, the proportion of the amount of the hot air discharged from the dryer was set to 25% by volume. The obtained PTFE powder had a content of moisture of 0.2% by mass.

In Reference Example 2, hot air was laterally blown to the container that opened at the top and was air-permeable at the bottom. Therefore, the hot air flowed while divided to the upper and lower parts of the container (mesh tray). No difference in atmospheric pressure occurred between the upper and lower parts (atmospheric pressure difference: less than 10 Pa), and the hot air did not pass through the wet powder layer. Thus, the heat treatment method according to Reference Example 2 is hot air circulation-type drying treatment.

The contents of compounds of the general formula (4) in the obtained PTFE powder were measured. The results are shown in Table 5.

### Experimental Example 1

The wet PTFE powder obtained in Reference Example 1 was placed (amount of the powder placed: 1.2 g/cm²) in a metal mesh tray (No. 60 mesh). Superheated steam of 180 °C was introduced at a rate of 20 kg/hr into an electric furnace equipped with a high-temperature superheated steam generator, and the powder was heat-treated for 7 hours in the furnace of 180 °C to obtain a PTFE powder.

The contents of compounds of the general formula (4) in the obtained PTFE powder were measured. The results are shown in Table 4.

### Experimental Example 6

A PTFE powder was obtained in the same manner as in Experimental Example 1 except that the heat treatment temperature was changed to 240 °C. The obtained PTFE powder had a content of moisture of 0.004% by mass.

The contents of compounds of the general formula (4) in the obtained PTFE powder were measured. The results are shown in Table 6.

### Experimental Example 2

A PTFE powder was obtained by heat treatment in the same manner as in Reference Example 1 except that the amount of the powder placed was changed to 1.0 g/cm²; the plate tray was changed to a metal mesh tray ((No. 60 mesh; container that opened at the top and was air-permeable at the bottom without being air-permeable at the side); and the wind velocity was changed to 3.0 m/s. In this respect, the proportion of the amount of the hot air discharged from the dryer was set to 50% by volume.

In Experimental Example 2, hot air was laterally blown to the container that opened at the top and was air-permeable at the bottom without being air-permeable at the side. Therefore, the hot air flowed while divided to the upper and lower parts of the container (mesh tray). No difference in atmospheric pressure occurred between the upper and lower parts (atmospheric pressure difference: less than 10 Pa), and the hot air did not pass through the wet powder layer. Thus, the heat treatment method according to Experimental Example 2 is hot air circulation-type drying treatment.

In the obtained PTFE powder, the extrusion pressure at RR of 100 was 14 MPa, and the coefficient of extrusion pressure fluctuation at RR of 100 was 0.09.

The contents of compounds of the general formula (4) in the obtained PTFE powder were measured. The results are shown in Table 4.

### Experimental Example 7

The wet PTFE powder obtained in Reference Example 2 was placed (amount of the powder placed: 0.5 g/cm²) in a metal mesh tray (No. 60 mesh; container that opened at the top and was air-permeable at the bottom without being air-permeable at the side) in which a fiber sheet was disposed as a fabric on a wire mesh of No. 10 mesh, and heat-treated at 160 °C for 18 hours in a hot air circulation-type dryer (wind velocity: 1.0 m/s) to obtain a PTFE powder. In this respect, the proportion of the amount of the hot air discharged from the dryer was set to 25% by volume. The obtained PTFE powder had a content of moisture of 0.001% by mass.

In Experimental Example 7, hot air was laterally blown to the container that opened at the top and was air-permeable at the bottom without being air-permeable at the side. Therefore, the hot air flowed while divided to the upper and lower parts of the container (mesh tray). No difference in atmospheric pressure occurred between the upper and lower parts (atmospheric pressure difference: less than 10 Pa), and the hot air did not pass through the wet powder layer. Thus, the heat treatment method according to Experimental Example 7 is hot air circulation-type drying treatment.

The contents of compounds of the general formula (4) in the obtained PTFE powder were measured. The results are shown in Table 6.

In the obtained PTFE powder, the extrusion pressure at RR of 100 was 14.9 MPa, and the coefficient of extrusion pressure fluctuation at RR of 100 was 0.07.

### Experimental Example 8

The wet PTFE powder obtained in Reference Example 2 was placed (amount of the powder placed: 0.5 g/cm²) in a metal mesh tray (No. 60 mesh; container that opened at the top and was air-permeable at the bottom without being air-permeable at the side) in which a fiber sheet was disposed as a fabric on a wire mesh of No. 10 mesh, and heat-treated at 250 °C for 18 hours in a hot air circulation-type dryer (wind velocity: 1.0 m/s) to obtain a PTFE powder. In this respect, the proportion of the amount of the hot air discharged from the dryer was set to 25% by volume. The obtained PTFE powder had a content of moisture of 0.000% by mass.

In Experimental Example 8, hot air was laterally blown to the container that opened at the top and was air-permeable at the bottom without being air-permeable at the side. Therefore, the hot air flowed while divided to the upper and lower parts of the container (mesh tray). No difference in atmospheric pressure occurred between the upper and lower parts (atmospheric pressure difference: less than 10 Pa), and the hot air did not pass through the wet powder layer. Thus, the heat treatment method according to Experimental Example 8 is hot air circulation-type drying treatment.

The contents of compounds of the general formula (4) in the obtained PTFE powder were measured. The results are shown in Table 6.

### Experimental Example 10

A wet PTFE powder was obtained in the same manner as in Reference Example 1 except that the PTFE aqueous dispersion obtained in Production Example 1 was changed to the PTFE aqueous dispersion obtained in Production Example 2. The obtained wet PTFE powder had a moisture content of approximately 60% by mass. The obtained wet PTFE powder was placed (amount of the powder placed: 0.8 g/cm²) in a tray in which a fiber sheet was disposed as a fabric on a wire mesh of No. 10 mesh. Air with a wind velocity adjusted to 0.6 m/s was continuously supplied to the wet PTFE powder on the tray from above the tray. The powder was heat-treated at 200 °C for 40 minutes using an electric furnace (wind velocity: 0.6 m/s) adjusted such that the proportion of the amount of hot air discharged from the electric furnace was 80% by volume, to obtain a PTFE powder.

In Experimental Example 10, hot air was blown to the wet PTFE powder on the fiber sheet from above. Therefore, a hot air-blown surface was formed as the upper face of a layer of the wet powder placed on the fiber sheet. The hot air that invaded from the surface went through the lower face so that a surface from which the hot air escaped was formed as the lower face of the wet powder layer. The atmospheric pressure of the hot air-blown surface (upper face) and the atmospheric pressure of the surface from which the hot air escaped (lower face) differed by 10 Pa or more. Thus, the heat treatment method according to Experimental Example 10 is through-flow drying treatment.

The obtained PTFE powder had a content of moisture of 0.001% by mass.

The contents of compounds of the general formula (4) in the obtained PTFE powder were measured. The results are shown in Table 7.

In the obtained PTFE powder, the extrusion pressure at RR of 100 was 16.2 MPa.

### Experimental Example 11

The wet PTFE powder obtained in Experimental Example 10 was placed (amount of the powder placed: 0.8 g/cm²) in a tray in which a fiber sheet was disposed as a fabric on a wire mesh of No. 10 mesh. Air with a wind velocity adjusted to 0.6 m/s was continuously supplied to the wet PTFE powder on the tray from above the tray. The powder was heat-treated at 225 °C for 40 minutes using an electric furnace (wind velocity: 0.6 m/s) adjusted such that the proportion of the amount of hot air discharged from the electric furnace was 80% by volume, to obtain a PTFE powder.

In Experimental Example 11, hot air was blown to the wet PTFE powder on the fiber sheet from above. Therefore, a hot air-blown surface was formed as the upper face of a layer of the wet powder placed on the fiber sheet. The hot air that invaded from the surface went through the lower face so that a surface from which the hot air escaped was formed as the lower face of the wet powder layer. The atmospheric pressure of the hot air-blown surface (upper face) and the atmospheric pressure of the surface from which the hot air escaped (lower face) differed by 10 Pa or more. Thus, the heat treatment method according to Experimental Example 11 is through-flow drying treatment.

The obtained PTFE powder had a content of moisture of 0.001% by mass.

The contents of compounds of the general formula (4) in the obtained PTFE powder were measured. The results are shown in Table 7.

In the obtained PTFE powder, the extrusion pressure at RR of 100 was 17.7 MPa.

### Experimental Example 12

The wet PTFE powder obtained in Experimental Example 10 was placed (amount of the powder placed: 0.8 g/cm²) in a tray in which a fiber sheet was disposed as a fabric on a wire mesh of No. 10 mesh. Air with a wind velocity adjusted to 0.6 m/s was continuously supplied to the wet PTFE powder on the tray from above the tray. The powder was heat-treated at 250 °C for 40 minutes using an electric furnace (wind velocity: 0.6 m/s) adjusted such that the proportion of the amount of hot air discharged from the electric furnace was 80% by volume, to obtain a PTFE powder.

In Experimental Example 12, hot air was blown to the wet PTFE powder on the fiber sheet from above. Therefore, a hot air-blown surface was formed as the upper face of a layer of the wet powder placed on the fiber sheet. The hot air that invaded from the surface went through the lower face so that a surface from which the hot air escaped was formed as the lower face of the wet powder layer. The atmospheric pressure of the hot air-blown surface (upper face) and the atmospheric pressure of the surface from which the hot air escaped (lower face) differed by 10 Pa or more. Thus, the heat treatment method according to Experimental Example 12 is through-flow drying treatment.

The obtained PTFE powder had a content of moisture of 0.005% by mass.

The contents of compounds of the general formula (4) in the obtained PTFE powder were measured. The results are shown in Table 7.

In the obtained PTFE powder, the extrusion pressure at RR of 100 was 20.9 MPa, and the coefficient of extrusion pressure fluctuation at RR of 100 was 0.004.

### Experimental Example 13

The wet PTFE powder obtained in Experimental Example 10 was placed (amount of the powder placed: 0.8 g/cm²) in a tray in which a fiber sheet was disposed as a fabric on a wire mesh of No. 10 mesh. Air with a wind velocity adjusted to 0.6 m/s was continuously supplied to the wet PTFE powder on the tray from above the tray. The powder was heat-treated at 250 °C for 40 minutes using an electric furnace (wind velocity: 0.6 m/s) adjusted such that the proportion of the amount of hot air discharged from the electric furnace was 50% by volume, to obtain a PTFE powder.

In Experimental Example 13, hot air was blown to the wet PTFE powder on the fiber sheet from above. Therefore, a hot air-blown surface was formed as the upper face of a layer of the wet powder placed on the fiber sheet. The hot air that invaded from the surface went through the lower face so that a surface from which the hot air escaped was formed as the lower face of the wet powder layer. The atmospheric pressure of the hot air-blown surface (upper face) and the atmospheric pressure of the surface from which the hot air escaped (lower face) differed by 10 Pa or more. Thus, the heat treatment method according to Experimental Example 13 is through-flow drying treatment.

The obtained PTFE powder had a content of moisture of 0.000% by mass.

The contents of compounds of the general formula (4) in the obtained PTFE powder were measured. The results are shown in Table 7.

### Experimental Example 14

The wet PTFE powder obtained in Experimental Example 10 was placed (amount of the powder placed: 0.8 g/cm²) in a tray in which a fiber sheet was disposed as a fabric on a wire mesh of No. 10 mesh. Air with a wind velocity adjusted to 0.6 m/s was continuously supplied to the wet PTFE powder on the tray from above the tray. The powder was heat-treated at 250 °C for 40 minutes using an electric furnace (wind velocity: 0.6 m/s) adjusted such that the proportion of the amount of hot air discharged from the electric furnace was 10% by volume, to obtain a PTFE powder.

In Experimental Example 14, hot air was blown to the wet PTFE powder on the fiber sheet from above. Therefore, a hot air-blown surface was formed as the upper face of a layer of the wet powder placed on the fiber sheet. The hot air that invaded from the surface went through the lower face so that a surface from which the hot air escaped was formed as the lower face of the wet powder layer. The atmospheric pressure of the hot air-blown surface (upper face) and the atmospheric pressure of the surface from which the hot air escaped (lower face) differed by 10 Pa or more. Thus, the heat treatment method according to Experimental Example 14 is through-flow drying treatment.

The obtained PTFE powder had a content of moisture of 0.000% by mass.

The contents of compounds of the general formula (4) in the obtained PTFE powder were measured. The results are shown in Table 7.

### Experimental Example 15

The wet PTFE powder obtained in Experimental Example 10 was placed (amount of the powder placed: 0.5 g/cm²) in a tray in which a fiber sheet was disposed as a fabric on a wire mesh of No. 10 mesh. Air with a wind velocity adjusted to 0.6 m/s was continuously supplied to the wet PTFE powder on the tray from above the tray. The powder was heat-treated at 250 °C for 80 minutes using an electric furnace (wind velocity: 0.6 m/s) adjusted such that the proportion of the amount of hot air discharged from the electric furnace was 50% by volume, to obtain a PTFE powder.

In Experimental Example 15, hot air was blown to the wet PTFE powder on the fiber sheet from above. Therefore, a hot air-blown surface was formed as the upper face of a layer of the wet powder placed on the fiber sheet. The hot air that invaded from the surface went through the lower face so that a surface from which the hot air escaped was formed as the lower face of the wet powder layer. The atmospheric pressure of the hot air-blown surface (upper face) and the atmospheric pressure of the surface from which the hot air escaped (lower face) differed by 10 Pa or more. Thus, the heat treatment method according to Experimental Example 15 is through-flow drying treatment.

The obtained PTFE powder had a content of moisture of 0.004% by mass.

The contents of compounds of the general formula (4) in the obtained PTFE powder were measured. The results are shown in Table 7.

In the obtained PTFE powder, the extrusion pressure at RR of 100 was 13.7 MPa, and the coefficient of extrusion pressure fluctuation at RR of 100 was 0.003.

### Experimental Example 4

To the PTFE aqueous dispersion obtained in Production Example 1, deionized water was added, and further, deionized water containing 25 g of ammonium persulfate dissolved therein was added to prepare 2.5 L of a PTFE dispersion with a specific gravity (25 °C) adjusted to 1.080. The PTFE dispersion was treated for 7 hours in a constant-temperature vessel of 80 °C and then cooled to room temperature. To a coagulation vessel (internal volume: 6 L) equipped with an anchor-type stirring blade and a baffle, 2.5 L of the PTFE aqueous dispersion was added, and the temperature was adjusted such that the internal temperature was 25 °C. Stirring was started at a stirring speed of 500 rpm. After the start of stirring, the aqueous dispersion was confirmed to form a wet PTFE powder through a slurry state, and the stirring was further continued for 1 minute.

Subsequently, the wet PTFE powder was collected by filtration, and a coagulation vessel was charged with the wet PTFE powder and 2.5 L of deionized water and adjusted to 25 °C. The operation of cleaning the polymer powder at a stirring speed of 500 rpm was repeated twice. The wet PTFE powder thus cleaned was collected by filtration, and left standing for drying for 18 hours in a hot air circulation-type dryer of 120 °C to obtain a PTFE powder.

### Experimental Example 5

To the PTFE aqueous dispersion obtained in Production Example 1, deionized water was added to adjust a specific gravity (25 °C) to 1.080. To a coagulation vessel (internal volume: 6 L) equipped with an anchor-type stirring blade and a baffle, 4.5 L of the PTFE aqueous dispersion with the adjusted specific gravity was added, and the temperature was adjusted such that the internal temperature was 20 °C. After the adjustment, an ultrasonic generator (SRK-400 from Shinka Industry Co., Ltd.) was attached to the coagulation vessel. At the same time with addition of 41 g of nitric acid (10 wt %), stirring was started at a stirring speed of 500 rpm while ultrasonic waves were generated at a frequency of 45 kHz and a power of 600 W. After the start of stirring, the aqueous dispersion was confirmed to form a wet PTFE powder through a slurry state, and the stirring was further continued for 1 minute.

Subsequently, the wet PTFE powder was collected by filtration, and 2.5 L of deionized water was added thereto. After adjustment of the internal temperature to 25 °C, stirring was started at a stirring speed of 500 rpm while ultrasonic treatment was repeated twice at 45 kHz and 300 W to obtain a wet PTFE powder.

The obtained wet PTFE powder was heat-treated at 120 °C for 18 hours using a hot air circulation-type drying furnace to obtain a PTFE powder. Methanol was added in an amount of 10 times the mass of the obtained PTFE powder, and the PTFE powder was cleaned with ultrasonic waves at 60 °C for 2 hours and collected by filtration from methanol to obtain a PTFE powder.

TABLE 4

| | | Reference | Experimental | Experimental |
|---|---|---|---|---|
| Content of general formula (4) | | Example 1 | Example 1 | Example 2 |
| m = 12 | ppb/PTPE | 82 | <10 | <10 |
| m = 14 | ppb/PTFE | 96 | <10 | <10 |

TABLE 5

| | Reference |
|---|---|
| Content of general formula (4) | Example 2 |

| | | |
|---|---|---|
| m = 12 | ppb/PTFE | 9.7 × 10² |
| m = 14 | ppb/PTFE | 6.9 × 10³ |

TABLE 6

| | | Experimental | Experimental | Experimental |
|---|---|---|---|---|
| Content of general formula (4) | | Example 6 | Example 7 | Example 8 |
| m = 12 | ppb:PTFE | <10 | 1.8 × 10¹ | <10 |
| m = 14 | ppb:PTFE | <10 | 1.4 × 10² | 4.2 × 10¹ |

TABLE 7

| Content of general | | Experimental | Experimental | Experimental | Experimental | Experimental | Experimental |
|---|---|---|---|---|---|---|---|
| formula (4) | | Example 10 | Example 11 | Example 12 | Example 13 | Example 14 | Example 15 |
| m = 12 | ppb/PTFE | <10 | <10 | <10 | <10 | 1.8 × 10¹ | <10 |
| m = 14 | ppb/PTFE | 3.1 × 10 [symbol] | 1.9 × 10¹ | <10 | 2.5 × 10 [symbol] | 7.1 × 10¹ | <10 |

[symbol]

indicates data missing or illegible when filed

1. A method for producing a non melt-processible polytetrafluoroethylene powder, the production method comprising:
polymerizing tetrafluoroethylene in the presence of an aqueous medium and a hydrocarbon surfactant to obtain an aqueous dispersion containing non melt-processible polytetrafluoroethylene;
coagulating the non melt-processible polytetrafluoroethylene in the aqueous dispersion to obtain a wet powder;
cleaning the wet powder; and
heat-treating the wet powder to obtain a non melt-processible polytetrafluoroethylene powder.

2. The production method according to claim 1, wherein the non melt-processible polytetrafluoroethylene is coagulated using at least one coagulation method selected from the group consisting of a coagulation method by stirring, an ultrasonic coagulation method, a coagulation method using ultrafine bubble, a coagulation method using an alkali, a coagulation method using an acid, a coagulation method using an oxidizing agent, a coagulation method using an organic solvent, and a coagulation method using a radical generator.

3. The production method according to claim 1, wherein the wet powder is cleaned using at least one cleaning method selected from the group consisting of a cleaning method by stirring, an ultrasonic cleaning method, a cleaning method using ultrafine bubble, a cleaning method using an alkali, a cleaning method using an acid, and a cleaning method using a radical generator.

4. The production method according to claim 1, wherein a temperature of the heat treatment is 10 to 280 °C.

5. The production method according to claim 1, wherein the heat treatment is performed by bringing hot air into contact with the wet powder.

6. The production method according to claim 5, wherein a wind velocity of the hot air is 0.01 to 10 m/s.

7. The production method according to claim 1, wherein the heat treatment is performed by heating the wet powder in the presence of steam.

8. The production method according to claim 7, wherein after the wet powder is heated in the presence of steam, the wet powder is dried.

9. The production method according to claim 1, wherein
the wet powder is obtained by coagulating the non melt-processible polytetrafluoroethylene in the aqueous dispersion using at least one coagulation method selected from the group consisting of a coagulation method by stirring, an ultrasonic coagulation method, and a coagulation method using an acid;
the wet powder is cleaned using at least one cleaning method selected from the group consisting of a cleaning method by stirring and an ultrasonic cleaning method; and
the wet powder is heat-treated by bringing hot air of 160 °C or higher into contact with the wet powder at a wind velocity of 0.40 m/s or more for 30 minutes or longer, or by heating the wet powder in the presence of steam of 160 °C or higher for 200 minutes or longer
to obtain the non melt-processible polytetrafluoroethylene powder.

10. The production method according to claim 1, wherein
the wet powder is heat-treated by placing the cleaned wet powder such that, when hot air goes through a hot air-blown surface into a surface facing the hot air-blown surface, an atmospheric pressure of the hot air-blown surface is higher than that of the surface facing the hot air-blown surface, to form a wet powder layer, and subsequently blowing hot air of 195 °C or higher to the wet powder layer at a wind velocity of 0.50 m/s or more so that the hot air is introduced into the wet powder layer from the hot air-blown surface and discharged from the surface facing the hot air-blown surface to bring the wet powder into contact with the hot air for 30 to 200 minutes.

11. The production method according to claim 1, wherein
the wet powder is heat-treated by placing the cleaned wet powder such that, when hot air is blown to a surface, the hot air is not discharged from a surface facing the hot air-blown surface, or such that, when hot air goes through a hot air-blown surface into a surface facing the hot air-blown surface, an atmospheric pressure of the hot air-blown surface is the same as that of the surface facing the hot air-blown surface, to form a wet powder layer, and subsequently blowing hot air of 170 to 190 °C to the wet powder layer at a wind velocity of 2.0 to 5.0 m/s to bring the wet powder into contact with the hot air for 420 to 1,500 minutes.

12. A non melt-processible polytetrafluoroethylene powder comprising any of compounds represented by the following general formula (4), wherein a content of one or more of the compounds is less than 100 ppb by mass based on the non melt-processible polytetrafluoroethylene powder, and an extrusion pressure measured at a reduction ratio of 100 is 25 MPa or lower:
[H—(CF₂)ₘ₋₁CO₂⁻]M⁺ general formula (4):
wherein m represents an integer of 4 to 20, and M⁺ represents a cation.
